(19) United States
(12) Patent Application Publication
(10) Pub. No.: US 2026/0312297 A1
(43) Pub. Date: Oct. 8, 2026

(54) Scalable Digital Polarimetric Phased Array Radar and Methods of Use

(71) Applicant: The Board of Regents of the University of Oklahoma, Norman, OK (US)

(72) Inventors: Redmond C. Kelley, Norman, OK (US); John B. Meier, Norman, OK (US); Matthew S. McCord, Norman, OK (US); Jose D. Diaz, Hanover, MD (US)

(21) Appl. No.: 19/162,894

(22) PCT Filed: Feb. 21, 2024
(86) PCT No.: PCT/US2024/016695

§ 371 Date: Sep. 5, 2025

Related U.S. Application Data
(60) Provisional application No. 63/489,640, filed on Mar. 10, 2023.
(60) Provisional application No. 63/555,849, filed on Feb. 20, 2024.

(51) Int. Cl. H01Q 21/06; G01S 7/02; G01S 13/02; G01S 13/42; G01S 13/95; H01Q 21/00; H01Q 21/24

(52) U.S. Cl. CPC H01Q 21/061; G01S 7/027; G01S 13/42; G01S 13/951; H01Q 21/0025; H01Q 21/24; G01S 2013/0254

(57) ABSTRACT

A radar system comprising a mechanically and electronically scalable and fully digital phased array radar (PAR) system, and methods or use, for example, for use in making weather observations. The system may be mobile and enables rapid (volume scans in seconds) and adaptive scanning. The PAR system is highly modular and most of the components are easily replaceable even while the PAR is operational.

### CROSS-REFERENCE TO RELATED APPLICATIONS

The present PCT application claims priority to U.S. Provisional Patent Applications 63/489,640, filed Mar. 10, 2023, and 63/555,849, filed Feb. 20, 2024, the entire contents of which are hereby expressly incorporated by reference herein.

### STATEMENT REGARDING FEDERALLY SPONSORED RESEARCH OR DEVELOPMENT

This invention was made with government support under Contract Numbers NA16OAR4320115 and NA21OAR4320204 awarded by the US Department of Commerce and Contract Number N00014-19-1-2326 awarded by the Office of Naval Research. The government has certain rights in the invention.

### BACKGROUND

Weather radar is the most important tool for observation and warning of increasingly frequent severe weather events. Extreme weather can disrupt communities, negatively impact commerce, negatively impact civil operations, and cause billions of dollars in damage annually across the globe. Unfortunately, current operational weather dish-based radars are not designed to capture rapidly evolving processes that lead to extreme events. Significant improvements in the forecasting of high-impact weather require a new radar design that provides the needed spatial and temporal resolution along with the scanning capabilities afforded by PAR technology.

### BRIEF DESCRIPTION OF THE DRAWINGS

For a more complete understanding of this disclosure, reference is now made to the following brief description, taken in connection with the accompanying drawings and detailed description, wherein like reference numerals represent like parts. The patent or application file contains at least one drawing executed in color. Copies of this patent or patent application publication with color drawing(s) will be provided by the Office upon request and payment of the necessary fee.

FIG. 1 is a perspective view of a mobile radar system comprising a PAR system as embodied in the present disclosure.

FIG. 2A is an illustration showing dense vertical sampling using imaging in an RHI mode.

FIG. 2B is an illustration of adaptive nulling for interference mitigation, including non-stationary clutter.

FIG. 2C is a symbolic depiction of software reconfigurability for future requirements or missions.

FIG. 3 is a block diagram of a array panel assembly comprising an antenna panel, a transmission-receiver-processor assembly, a supervisory assembly, a power backplane, and a digital bridging assembly. The antenna panel comprises an antenna subpanel having a row of eight dual-polarization radiating elements. Each radiating element comprises a horizontal (H) pol component and a vertical (V) pol component.

FIG. 4A is a perspective view of an uncovered transmission-receiver-processor assembly (also referred to herein as “TRP assembly” or “OctoBlade”). The term “Octoblade” as used herein refers to a particular TRP assembly that is linked via antenna ports to 8 dual-polarization antenna elements.

FIG. 4B (right) is a perspective front-facing view of an antenna panel comprising 8 vertical antenna subpanels, each antenna panel with 8 radiating elements, supported on an array frame, and a rear-facing view (left) of the array frame showing a card cage with 9 card guides for 8 TRP assemblies and a supervisory assembly. In all, this antenna panel comprises 64 dual-polarization radiating elements in an 8×8 configuration.

FIG. 4C is a perspective view of the PAR system mounted on a truck, with the radome removed to expose the radar array.

FIG. 4D is a perspective view showing a superstructure of the PAR system with the ground plane exposed.

FIG. 5A is a schematic view of an experimental setup of an array panel assembly such as that in FIG. 4B set up for testing in a far-field anechoic chamber.

FIG. 5B shows graphs of antenna embedded S-parameters.

FIG. 5C shows graphs of measured active reflection coefficient as a function of scanning angle for H-polarization and V-polarization.

FIG. 5D shows an antenna stack-up.

FIG. 6 shows a schematic illustration demonstrating polarimetric far-field calibration and antenna pattern characterization of the PAR system in bird-bath mode using a UAS.

FIG. 7A shows schematics of a near-field scanner setup used to characterize H and V antenna patterns of a fully active array panel assembly.

FIG. 7B shows graphs of the normalized H co-polar and cross-polar far-field patterns derived from near-field measurements.

FIG. 7C shows graphs of the normalized V co-polar and cross-polar far-field patterns derived from near-field measurements.

FIG. 8 shows graphs of results from the experiments of FIGS. 7A-7B.

FIG. 9 shows graphs of data collected by the operational KTLX WSR-88D in Twin Lakes, Oklahoma, at 20:35:06 Z.

FIG. 10 shows graphs of polarimetric fields obtained in the field with a 5×1 radar array of the PAR system.

FIG. 11 is a graph showing Doppler spectra from a location with weather returns of high SNR.

FIG. 12 shows histograms quantifying the quality of polarimetric data from the PAR system.

FIG. 13 is a perspective view of the back of the PAR system showing the 25 array panel assemblies of the radar array.

FIG. 14 is a perspective view of the back of one array panel assembly in which the network shelf assembly has been lowered to reveal the electronics of the array panel assembly.

FIG. 15 is a perspective view the backend assembly of the PAR system of FIG. 1 with a cover or covers removed to enable interior visibility.

FIG. 16 is a rear perspective view of the PAR system of FIG. 13 in which the electronic components of the array panel assembly are not installed in the card cages thereby enabling visibility of the power backplanes.

FIG. 17 is an enlargement of one card cage of FIG. 16 showing the power backplane.

FIG. 18A (left) is a plan view the radar array of the PAR system showing placement of all 25 antenna panels in a 5×5 arrangement. At center is a top plan view of a single antenna panel with 8 vertical antenna subpanels to provide 64 radiating elements. A single radiating element with the H pol component and V pol component is shown at right.

FIG. 18B is a plan view of antenna port panel showing the 128 antenna ports which feed the 64 radiating elements of each antenna panel. A vertical set of 16 antenna ports comprises a single antenna support set which receives the 16 connectors of a single TRP assembly.

FIG. 18C is a cross-section taken along line 18C-18C which passes through a vertical subset of 8 antenna ports.

FIG. 18D shows a plan view of a radiating element circuitry panel which is used in association with the antenna port panel of FIG. 18B.

FIG. 18E shows a cross-section taken through an assembly of an antenna panel, a radiating element circuitry panel, and an antenna port panel which is mounted upon a ground plane module sized to support a single antenna panel.

FIG. 19A is a vertical rear perspective view of a TRP assembly of FIG. 14.

FIG. 19B is a vertical front perspective view of the TRP assembly of FIG. 14.

FIG. 20A is a horizontal rear perspective diagram of the TRP assembly of FIG. 14.

FIG. 20B is an exploded diagram of the TRP assembly of FIG. 20A.

FIG. 21 is top plan view of one of the RF board/digital boards of the RF board/digital board pair of the TRP assembly. The terms “Octo-Quad” and “Octo-FPGA” may be used herein in place of the terms RF board and digital board, respectively.

FIG. 22 is a perspective view of the digital board portion of the RF board/digital board pair in FIG. 21.

FIG. 23 is a perspective view of the RF board portion of the RF board/digital board pair in FIG. 21.

FIG. 24A is a top plan view of the heat transfer/support plate (also referred to herein as a cold plate) in FIGS. 20A and 20B.

FIG. 24B is a transparent view of the heat transfer/support plate in FIG. 24A wherein a serpentine conduit inside the heat transfer/support plate is shown in phantom.

FIG. 25A is a top perspective view of a digital bridging subassembly (also referred to herein as the “digital bridge”) in FIG. 14.

FIG. 25B is a bottom perspective view of the digital bridging subassembly in FIG. 25A.

FIG. 25C is an exploded diagram of the digital bridging subassembly in FIGS. 25A and 25B.

FIG. 26A is a perspective view of the supervisory assembly (also referred to herein as the “SuperBlade”) in FIG. 14.

FIG. 26B is an exploded view of the supervisory assembly in FIG. 26A.

FIG. 27 is a diagram of the power backplane (also referred to herein as the “analog bridge”) in FIG. 16.

FIG. 28 comprises plan views of the ground plane in FIG. 4D. At center the entire ground plane comprising 25 ground plane modules is shown. At left one entire ground plane module is shown surrounded by portions of 5 adjacent ground plane modules and seams therebetween. At right is shown a single ground plane module mounted upon an array frame.

FIG. 29 is a perspective view of the superstructure of the PAR system.

FIG. 30 is a top plan view of the synchronization board in FIG. 15.

FIG. 31 is rear perspective view of an array panel assembly comprising a pair of TRP assemblies, one supervisory assembly, a power backplane, and a digital bridging subassembly (also referred to an “OctoPod”).

FIG. 32 is a logical diagram of the array panel assembly of FIG. 31.

FIG. 33 is a perspective view of a testing system.

FIG. 34 is a logical diagram of the testing system in FIG. 33.

FIG. 35A is a front view of a simplified schematic diagram of a portion of the PAR system in FIG. 1.

FIG. 35B is a side cross-sectional view of the portion in FIG. 35A.

FIG. 36 is a schematic diagram of an RFE according to a first embodiment.

FIG. 37 is a schematic diagram of an RFE according to a second embodiment.

FIG. 38 is a flowchart illustrating a method of initializing and operating the PAR system in FIG. 1.

FIG. 39 is a flowchart illustrating a method of operating the PAR system in FIG. 1.

FIG. 40 is a flowchart illustrating a method of synchronizing the PAR system in FIG. 1.

FIG. 41 is a flowchart illustrating a method of testing a component for use in the PAR system in FIG. 1.

FIG. 42 is a flowchart illustrating a method of manufacturing the heat transfer/support plate in FIG. 20A. The term “cold plate” may be used in place of the term heat transfer/support plate.

FIG. 43 is a flowchart illustrating a method of installation, operation, and maintenance of the PAR system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. For example, the various apparatus and devices of the various embodiments described herein may be constructed using various off-the shelf components, such as PCBs, and other mechanical and electrical components which perform the same function as the particular components described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entireties to the same extent as if the contents of each individual patent or publication was specifically and individually incorporated herein. In particular, U.S. Provisional Patent Applications 63/489,640, filed Mar. 10, 2023, and 63/555,849, filed Feb. 20, 2024, are hereby expressly incorporated herein by reference in their entireties.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that a thing possesses or occurs in an amount, duration, degree or other measure or parameter value that is 90% to 99% of which the thing is being compared to.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

The following abbreviations and definitions apply:
AC: alternating current
ADC: analog-to-digital converter
AI: artificial intelligence
Analog Bridge: power backplane
ARC: active reflection coefficient
ARRC: Advanced Radar Research Center
ASIC: application-specific integrated circuit
ATD: Advanced Technology Demonstrator
ATSR: along track scanning radiometer
AWG: arbitrary waveform generator
az: azimuth
BEER: backend electronics rack
C: Celsius
CAPE: convective available potential energy
Cold plate: heat transfer plate
CPI: coherent processing interval
CPPAR: cylindrical polarimetric phased array radar
DAC: digital-to-analog converter
dB: decibel(s)
dBZ: decibel(s) relative to Z
DC: direct current
DDR4 RAM: double data rate 4 random-access memory
DGPS: differential GPS
Digital bridge: Digital bridging assembly
DO: disciplined oscillator
DPD: digital predistortion
DSP: digital signal processing
EarthCARE: Earth Clouds Aerosol Radiation Explorer
el: elevation
EMI: electromagnetic interference
F: Fahrenheit
FORJ: fiber optic rotary joint
FPGA: field-programmable gate array
GaN: gallium nitride
Gb/s: gigabit(s) per second
GHz: gigahertz
GPIO: general-purpose input/output
GPS: Global Positioning System
H: horizontal
HPA: high-powered amplifier
HTD: heat transport duct
I: in-phase
IC: integrated circuit
IF: intermediate frequency
INCUS: Investigation of Convective Updrafts
I2C: Inter-Integrated Circuit
J/kg: Joule(s) per kilogram
JPOLE: Joint Polarization Experiment
JTAG: Joint Test Action Group
K_{DP}: specific differential phase
km: kilometer(s)
kW: kilowatt(s)
LFM: linear frequency modulation
LHCP: left-hand circular polarization
LNA: low-noise amplifier
LO: local oscillator
LRU: line-replaceable unit
m: meter(s)
mb: millibar(s)
MC: mutual coupling
MHz: megahertz
ML: machine learning
ms: millisecond(s)
m/s: meter(s) per second
Msps: megasample(s) per second
MVDR: minimum variance distortionless response
m²: meter(s) square
NEXRAD: NEXt-generation RADar
NLEQ: nonlinear equalization
NLFM: non-linear frequency modulation
NOAA: National Oceanic and Atmospheric Administration
NSSL: NOAA National Severe Storms Laboratory
NWS: National Weather Service
Octoblade: Transmission-receiver-processor assembly
Octo-FPGA: OctoBlade Digital board
Octo-Quad: OctoBlade RF board
ODL: optical delay line
OEWP: open-ended rectangular waveguide probe
PAIR: Polarimetric Atmospheric Imaging Radar
PAR: phased array radar
PCB: printed circuit board
PCIe: Peripheral Component Interconnect Express
PPI: plan-position indicator
PRT: pulse-repetition time
PTO: power take-off
Q: quadrature
QPE: quantitative precipitation estimation
RAM: random-access memory
RBE: radar backend
RF: radio frequency
RFE: radio frontend
RHCP: right-handed circular polarization
RHI: range-height indicator
RPM: revolution(s) per minute
Rx: receive
s: second(s)
SMP-MAX: sub-miniature push-on maximum
SNR: signal-to-noise ratio
SoC: system on a chip
SOM: system on module
SPI: Serial Peripheral Interface
STAP: space-time adaptive processing
STSR: simultaneous-transmit, simultaneous-receive
Superblade: Supervisory assembly
synch: synchronization
TB/s: terabyte(s) per second
TR: transmit/receive
TRP assembly: transmission-receiver-processor assembly
Tx: transmit
UART: universal asynchronous receiver-transmitter
UAS: unmanned aircraft system
V: vertical
V: volt(s)
VDC: volt(s) DC
W: watt(s)
WSR-88D: Weather Surveillance Radar-1988 Doppler
XPC: cross-polar canceller
Z_{DR}: differential reflectivity
μs: microsecond(s)
ρₕᵥ: copolar correlation coefficient
Φ_{DP}: differential phase
3D: three-dimensional
4D: four-dimensional
°: degree(s)
%: percent.

### I. INTRODUCTION

Polarimetric PAR is emerging as a promising technology for the next generation of weather radars due to its superior capabilities for capturing the microphysics and dynamics of a wide variety of rapidly evolving atmospheric phenomena across scales. Planar PAR antennas with electronic scanning only in elevation (mechanical in azimuth) avoid the issue of tilting the intended polarization axes. In other words, modulation on only one axis of the Poincaré sphere is needed. Such strategies have seen widespread implementation in Japan, China, and the U.S., the latter with the nascent PAIR. The ATD is a planar PAR capable of two-dimensional scanning, which requires polarimetric calibration per beamsteering position. A unique CPPAR design has also been investigated. It is based on theoretical studies that showed the effectiveness of such designs for maintaining polarization orthogonality, which is needed for accurate polarimetric PAR observations.

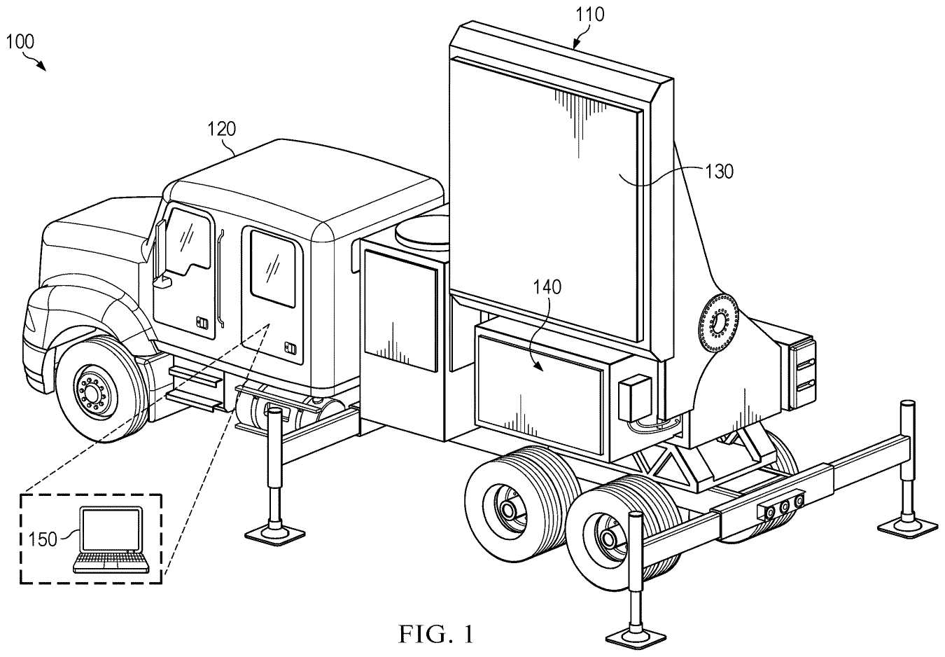

In a non-limiting embodiment of a radar system of the present disclosure, FIG. 1 depicts a perspective view of a mobile radar system 100 comprising a phased array radar (PAR) system 110 mounted upon a truck 120. The PAR system 110 comprises a plurality of array panel assemblies (see below) which are covered by a radome 130. The PAR system further comprises a backend assembly 140 (discussed in more detail below) and a controller 150. Though FIG. 1 shows the controller 150 as a notebook computer, the controller 150 may be any computer or other device that communicates, processes, and displays data. The controller 150 may be an integral component of the backend assembly 140 or may be a component separate from the backend assembly 140.

The mobile radar system 100 is referred to herein in certain embodiments as “Horus” after the Egyptian god with the all-seeing eye. In at least one embodiment, the PAR system 110 is an S-band PAR system for weather.

The fully-digital architecture of the PAR system enables rapid (volume scans in seconds) and adaptive scanning. By uniquely obtaining nearly continuous vertical sampling, the PAR system's observations accurately capture 4D microphysical and dynamic processes, including processes key to understanding and predicting the formation of severe hazards such as tornadoes, hail, and flooding. Pristine dual-polarization data, achieved by exploiting the all-digital architecture, improve operational quantitative precipitation estimation as well as understanding of microphysical processes. The PAR system, in one non-limiting embodiment, operates with minimal attenuation and excellent sensitivity in the S band of 2.7-3.1 GHZ, which is ideal for atmospheric observations as scattering physics at that band are well understood and the observational range is large.

### II. MOTIVATION FOR WEATHER OBSERVATIONS

### A. High Temporal Resolution and Spatial Sampling

Due to the scattering properties of hydrometeors, operational weather radars in the U.S. operate in the S-band, which minimizes attenuation and provides observations that typically hold to the Rayleigh scattering regime. The radar system currently used in this network is called the WSR-88D, sometimes informally referred to as “NEXRAD.” Approximately 160 WSR-88D units make up the operational network in the U.S. The radar was designed to provide quality observations for a variety of meteorological phenomena, from localized intense storms/tornadoes to precipitation events that can cause flooding. The radar also improved decision-making for activities such as transportation, aviation, hydrology, and hazardous weather forecasts and warnings.

Severe storms evolve rapidly on timescales of minutes or even seconds in the case of tornadoes. Given the infrequency of tornadoes and other similar phenomena, however, the WSR-88D network was justifiably not designed to provide the temporal resolution that could resolve these rapid-evolving storms. The PAR system disclosed herein has a much higher temporal resolution while preserving the required data quality (i.e., bias and standard deviation of radar variables). This potential is realized through a variety of novel advanced scanning tools described herein.

In order to achieve adequate angular resolution with a pencil beam, the WSR-88Ds use an 8.5 m parabolic-reflector antenna and continuously scan in azimuth 360° at successive elevation angles. Typically, the number of elevation angles is limited in order to provide reasonable volume coverage every few minutes. WSR-88Ds attempt to cover full volumes by repositioning the dish to a limited set of elevation angles, typically 5-15 elevation angles. This imposes an inherent trade-off between temporal resolution, spatial coverage, and data quality. In particular, this limited elevation sampling can leave large unobserved gaps in the measurements, especially at farther ranges.

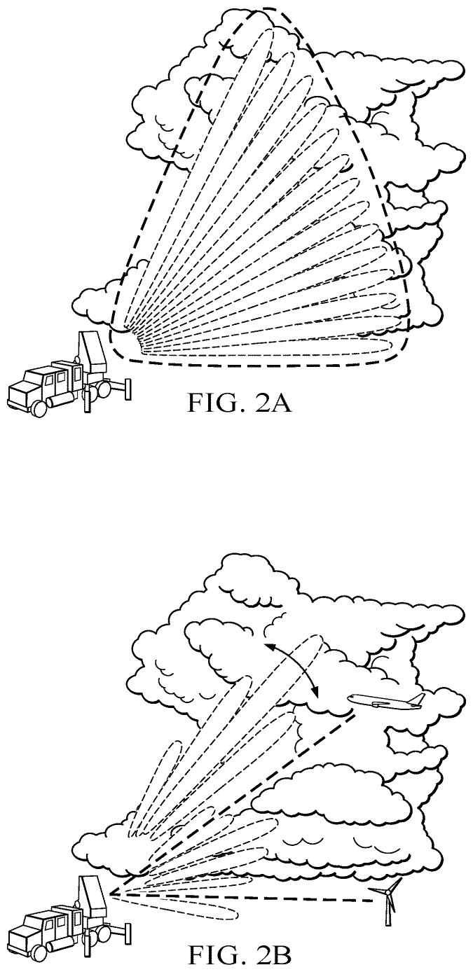

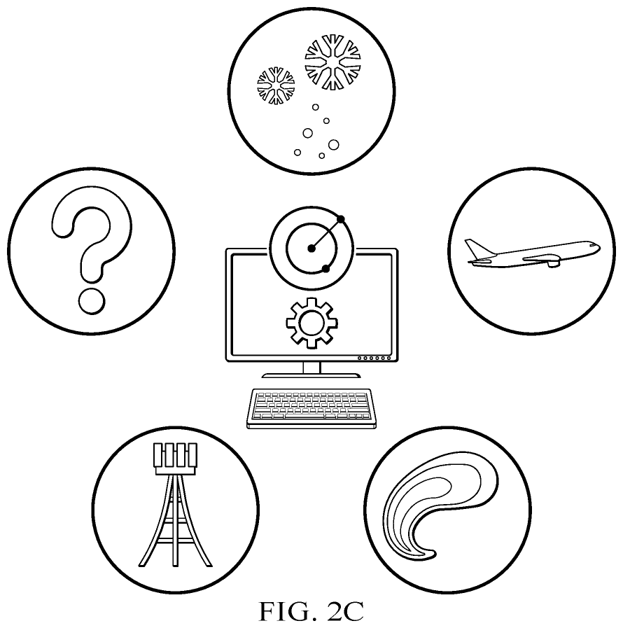

FIGS. 2A-2C are illustrations showing example capabilities of the presently disclosed PAR system. FIG. 2A illustrates dense vertical sampling using imaging in an RHI mode. FIG. 2A shows how the presently disclosed PAR system can be used for extremely dense sampling in elevation, thus minimizing the observational gaps discussed above. FIG. 2B illustrates how the presently disclosed PAR system can be used for adaptive nulling for interference mitigation, including non-stationary clutter. FIG. 2C is a symbolic depiction of how software reconfigured in the presently disclosed PAR system to accommodate future requirements or missions.

### B. Beam Agility and Interference Mitigation

An important capability of the presently disclosed PAR system is beamforming flexibility. Since the beamforming weights for each element (and polarization) are realized using software-based DSP, in contrast to the hardware dependence of analog beamforming systems, it is possible to form multiple arbitrary beams. Examples include spoiled transmit beams with potentially hundreds of simultaneous receive beams as shown in FIG. 2A. This mode of operation is called “imaging” in the weather radar community and can significantly enhance temporal resolution and vertical coverage at the cost of sensitivity and sidelobe performance. The loss in sensitivity is proportional to the spoiling factor. For example, if the transmit beam is spoiled by a factor of two, there would be a corresponding 3 dB loss in sensitivity. Sensitivity may not be an issue in high SNR environments (e.g., intense rainfall, hail) and can be mitigated through the use of phase-only transmit weights. The two-way sidelobe performance challenge can be addressed by using a spoiled transmit beam with multiple lobes spaces in angle, rather than a single wide transmit beam. This transmit beam design allows a more effective path to meeting two-way sidelobe requirements since the receive beams are not adjacent in angle.

Of all PAR architectures, the fully-digital architecture of the presently disclosed PAR system has the most degrees of freedom for adaptive beamforming on receive using methods such as MVDR as shown in FIG. 2B. These methods are extremely powerful for mitigation of interference, ground clutter, and even non-stationary clutter, such as reflections from wind turbines where the performance of conventional clutter filters is limited.

Further generalization of adaptive sensing can be employed through the use of STAP, which incorporates adaptive waveforms into the beamforming construct. Such adaptive methods intrinsically depend on the received data at each element and are therefore challenged by the need to aggregate the data in a single processing unit for covariance matrix estimation, matrix inversion, etc.

### C. Software-Defined Radar

Since each radiating element of the disclosed PAR system does not have hardware-based phase shifters and attenuators, such systems are by definition software-defined radars. In addition to the advantages just mentioned and as illustrated in FIG. 2C, a software-defined radar can more readily be reconfigured for new missions. Examples include array segmentation schemes for multiple missions (e.g., weather radar, air traffic control, communications), implementation of sidelobe canceling channels for improved clutter rejection, or new beam shapes for improved temporal resolution. In the operational weather radar community, it is not possible to predict all the future uses or configurations that the radar will have over the coming decades. Therefore, the software reconfigurability allowed by the disclosed PAR system is fundamentally important and will result in substantial savings in maintenance and operations costs over the lifetime of the radar.

### III. CHALLENGES AND SOLUTIONS

### A. Calibration—Polarimetric Requirements for Weather Observations

In the early 2000s, dual-polarization was investigated for improved weather observations. After the success of the JPOLE experiment led by NSSL, the WSR-88D radar network was upgraded with dual-polarization capability. This capability has become indispensable to the meteorological community, yielding important radar products such as hydrometeor classification and improved accuracy in precipitation rate estimation, a process that is referred to as QPE.

Useful dual-polarization observations are highly dependent on precise calibration. Although challenging, this level of calibration has been achieved with the WSR-88D radar. In the case of dual-polarization on a PAR, however, the challenge is more complex since the array must meet calibration requirements on potentially hundreds of beams with varying characteristics. A dish radar needs this calibration only for a single boresight beam, whereas a PAR requires a beamsteering-dependent calibration. For the presently disclosed PAR system, calibration is performed in three steps. First, utilizing a unique digital-at-every-element architecture, a novel, recursive, far-field calibration is applied. In this scheme, array panels are independently calibrated at short range, e.g., by using a standard gain horn antenna, thereby increasing SNR and mitigating multipath contamination, resulting in an initially calibrated array with uniform amplitude and phase excitations. Second, mutual coupling calibration is applied to correct for element-level amplitude/phase differences that may have occurred from the time the recursive calibration was applied to the radar deployment time. Third, after boresight array calibration is conducted, scan-loss correction for the co-polar H and co-polar V antenna gains are applied as a function of steering angle. In one embodiment, these corrections are derived from element-pattern measurements collected in an anechoic chamber, such as the anechoic chamber located at the ARRC in Norman, Oklahoma. Calibration parameters from the combination of these steps are produced on the fly and applied in real time. Equivalently, one could precompute a calibration table for each electronically steered beam position and apply the calibration tables in real time. Because Doppler measurements depend only on pulse-to-pulse relative phase changes, Doppler estimates are insensitive to PAR antenna-induced biases, and the standard error of Doppler velocity estimates only depends on the radar frequency and dwell time. Although ground truth near-field data are unavailable at this time, measurements suggest that the technique achieved acceptable polarimetric array calibration levels. A more extensive discussion is provided below.

The weather-derived products, which drive the requirements for the accuracy of polarimetric measurements, are Z_{DR}, ρₕᵥ, and K_{DP}. Z_{DR} is the logarithm of the H to V returned powers ratio, ρₕᵥ is the correlation coefficient between the H and V returns, and K_{DP} is the derivative of Φ_{DP} with respect to range; where Φ_{DP} is the phase difference between the returns in H and V polarized waves along a radial up to a specified range. To conduct precise measurements of polarimetric variables, it is crucial that the beams for transmitting the H and V polarized waves are well matched in gain and shape at every scanning direction. To achieve an accurate estimate of rainfall rates, it is recommended that the bias of Z_{DR} estimates is kept within ±0.1 dB for intrinsic Z_{DR} between 0 and 1 dB and less than 0.1×Z_{DR} for larger Z_{DR} values. It should be noted that keeping the bias of Z_{DR} estimates within ±0.1 dB is exceptionally difficult to achieve even in radars with parabolic antennas (e.g., WSR-88D network), and for this reason, the bias accuracy to within ±0.2 dB for Z_{DR} less than 1 dB (and up to 0.2×Z_{DR} for larger Z_{DR} values) has been broadly adopted as a calibration goal. In the case of ρₕᵥ estimates, a bias within ±0.006 dB is deemed sufficient for sensing the mixed-phase precipitation and gauging the hail size quantitatively.

Conventional large PAR systems are typically calibrated (e.g., phase/amplitude alignment) using a near-field scanner prior to system deployment. Unfortunately, any changes in the array performance after deployment in the field often result in a need for dismantling the radar and recalibration in a laboratory setting. The presently disclosed PAR system uses, in certain embodiments, the inherent mutual coupling among individual elements to realign the array after being deployed. This solution to the calibration challenge is an important advantage of this fully-digital PAR. Further discussion on the use of this approach is discussed below. Polarimetric performance enhancements can be achieved with a fully-digital array using the XPC technique. This method assigns a small number of elements from the entire array in an attempt to mitigate cross-polar contamination by transmitting the opposite phase from the original signal.

### B. Power Consumption

At a high level, prime power consumption of a PAR system can be segmented into the (1) TR modules including the HPA, LNA, and any phase shifters and attenuators; (2) digital transceivers; (3) back-end processors; and (4) off-array computational needs. For a fully-digital PAR, every element (and polarization) is digitized and processed, meaning that the digital transceivers and any onboard processing (e.g., FPGAs) dominate the power needs. Of course, onboard processing results in lower power consumption for off-array computations. Furthermore, fully-digital arrays require no phase shifters/attenuators in the TR module. Nevertheless, the prime power needs for a fully-digital PAR are larger than for a PAR based on analog beamforming. For example, the power needed for the present PAR system, assuming 1600 radiating elements, is approximately 50 kW of prime DC power for the array alone. This number does not include the radar infrastructure (e.g., chiller, back-end servers, pedestal), which can be significant but is independent of the PAR architecture. Fortunately, ASICs for digital radars may be available. In addition to providing the flexibility inherent in a digital array, the ASICs may have the capability to reduce overall power consumption.

### C. In-Band Interference

Interference is an important issue for any radar or communication system. Mitigation strategies include filtering with the goal of rejecting sources outside the operating frequency band. In-band interference can also be an issue, with sources from intentional jammers in defense applications to unintentional interference in all application spaces. A major concern with interference is that the ADCs or mixers in the digital transceivers could become saturated resulting in unusable data. Analog beamforming for either the entire array or at the sub-array level enables some level of angular directivity since the array (or sub-array) pattern will be relatively narrow compared to the radiation pattern of a single element. For a fully-digital system, there is little spatial directivity since each element is digitized and the element pattern can be about 40-60° wide.

There are at least two potential solutions for in-band interference of fully digital PARs. The presently disclosed PAR system, in a non-limiting embodiment described below, is based on an Analog Devices AD9371 digital transceiver IC. Other similar devices may be employed instead. The AD9371 is a direct conversion receiver; hence, this zero-IF down-conversion plan provides baseband I and Q digital signals with 16-bit sampling. The dynamic range afforded by this sampling is sufficient to adequately account for signals with moderate levels of interference. Moreover, the overall dynamic range of this digital beamforming radar is increased by a factor of 10 logo₁₀(N) compared to an analog beamforming radar that uses the same receiver. In the non-limiting embodiment of the PAR system 110, N>1000, and this is especially useful for civilian applications such as weather observations whose echo strengths can span an 80 dB power range. In another embodiment, miniaturized frequency-tunable filters could be embedded into the antenna array with little impact on antenna performance. Other, more-exotic mitigation strategies, such as element-level angular selectivity based on tunable mutual coupling resonant circuits, are possible.

### D. Data

With a calculation based on digitizing each element and polarization of an array made up of thousands of antenna elements, processing the large amount of data is a challenge. For example, an embodiment of the PAR system 110 comprising 1600 antenna elements would produce about 1.5 TB/s at full bandwidth if recording data at each element and polarization and assuming a reasonable received duty cycle. To elaborate, each of the 1,600 antenna elements has two radiating elements: an independent vertical (V) polarization channel, and independent horizontal (H) polarization channel, with each radiating element possessing its own digital receiver (located in RF board of the transmission-receiver-processor assembly). The AD9371 digital receiver is rated to sample up to 125 MSPS, and each 16-bit sample is mapped into a word of two bytes. Each receiver produces a unique, two-byte, in-phase signal and a unique, two-byte, quadrature signal. Collectively, this produces more than a terabyte of data at full bandwidth, as mentioned above. The sample rate of the in-phase and quadrature signals leaving the digital receivers are governed by changing decimation factors and designing decimation filters to produce output data rates that accommodate the next item in the digital chain.

On the other hand, analog beamforming systems and sub-array systems reduce the number of digitized channels at the expense of flexibility and advanced capabilities. Data reduction on a digital array can be achieved via digital coherent beamforming, which has the advantage of improved SNR since noise from different channels has a lower correlation, while reducing the sheer amount of data for both transport and processing. Various real-time beamforming topologies include systolic schemes and others that are discussed below.

### IV. PAR SYSTEM OVERVIEW

The PAR system 110 is an integrated radar system which demonstrates the power, versatility, and effectiveness of a fully-digital radar system. As mentioned above, in a non-limiting embodiment, the PAR system 110 comprises 1600 dual-polarization S-band elements. Each active element is driven by two fully-independent radar chains. The Table below lists high-level specifications of the PAR system 110 in one non-limiting embodiment.

TABLE
PAR system specifications

| Operating Frequency | 2.7-3.1 | GHz |
|---|---|---|
| Element Polarization | ATSR/STSR/RHCP/LHCP | |
| Tx Waveform Type | AWG/LFM/NLFM | |
| Tx Peak Power (single element) | 10 W/polarization | |
| Maximum Tx Pulse Width | 100 μs @ 10% duty cycle | |
| Maximum Tx Bandwidth | 100 | MHz |
| Element Spacing | 0.5 λ @ 2.951 GHz | |
| Total Number of Panels | 25 | (1600 elements) |
| Maximum Electronic Scan Angle | ±45° az, ±45° el | |
| Mechanical Positioner | 360° az, −1-92° el | |
| Aperture Size | 2.03 × 2.03 | m² |
| Tx/Rx Beamwidth Broadside | 2.58° | (no taper) |
| Total SNR Losses Tx/Rx | 6.01/9.81 | dB |

| | |
|---|---|
| Sensitivity (1 pulse) | 4.3 dBZ @ 50 km |

To elaborate the Table, conservative loss estimates have been accounted for during the design process, so that the resulting hardware system will perform as expected. For instance, total transmitter losses of 2 dB, an aperture efficiency of 50 percent, and a Tx waveform taper loss of 1 dB are estimated; hence, a 6 dB loss on transmit was estimated. On receive, lab data revealed a receiver noise figure of 3 dB, receive antenna losses (elevation scan angle loss of 1.5 dB, elevation beamwidth taper loss of 1.4 dB, azimuth scan angle loss of 1.5 dB, and azimuth beamwidth taper loss of 1.4 dB), and Rx waveform taper loss of 1 dB. The maximum pulse compression gain is established by the apex of the system's time bandwidth product, 100e-6×100e6=10e4, i.e., 40 dB. The following paragraphs and sections continue to build upon the data found in the Table.

In a non-limiting embodiment, as shown herein, the PAR system 110 is built on a truck 120 (in this case an International HV607 medium-duty truck). As mentioned above, one of the challenges with a fully digital array is high power consumption. A PTO generator, driven by the engine of truck 120 and capable of providing 150 KW, is integrated into the truck 120 below the chiller on the driver's side. The system is liquid-cooled via a 16.7-ton chiller located behind the truck cab. A pedestal provides mechanical pointing of the array in both azimuth and elevation. It can rotate continuously 360° at 12 RPM in azimuth. The elevation positioning is intended to deploy the array of the PAR system 110 to a configurable elevation tilt and remain at that angle during operations. A rotary assembly is integrated into the pedestal, which has an electrical slip-ring, rotary fluid union, and FORJ. The pedestal is placed on top of a riser, which elevates the bottom of the array of the PAR system 110 above the chiller when the array is deployed into the operational position. Telescoping outriggers are incorporated into the platform for stability and leveling.

The array and supporting electronics of the backend assembly 140 are mounted to the pedestal arms in weatherproof enclosures. The backend assembly 140 electronics encompass the array AC-DC power supplies, data processing and storage servers, networking, and centralized timing and synchronization electronics. Co-locating the digital array with the backend assembly 140 electronics simplifies the connections that are made through a rotary joint and slip rings.

### A. High-Level Architecture

System scalability was a key design consideration for the array electronics. Additionally, maintainability and modularity were important considerations during the design phase of the array electronics to ensure the PAR system could be supported for many years, while also offering opportunities to upgrade various aspects of the system during the course of future use, whether in the field, or for research.

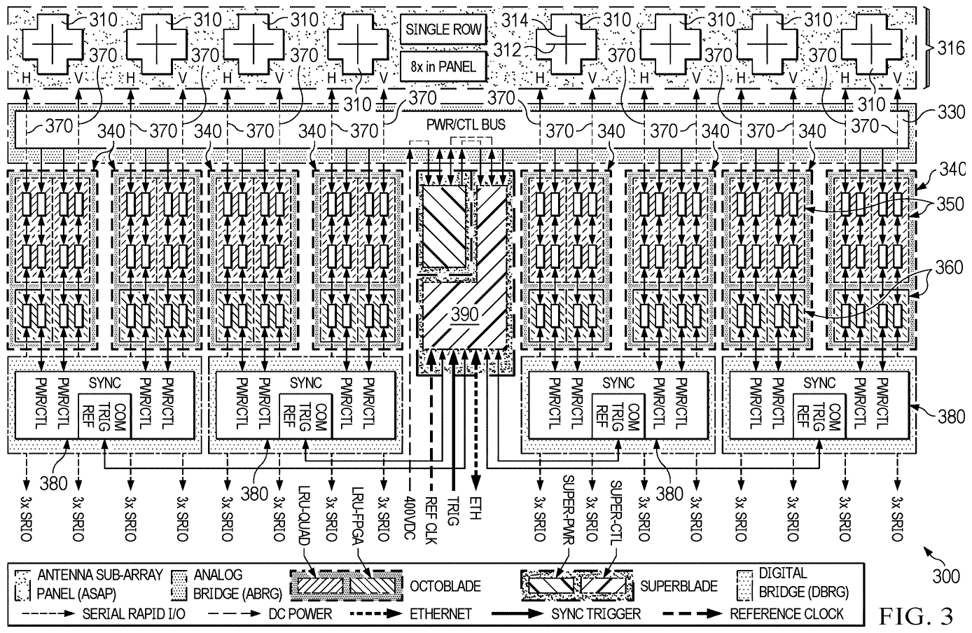

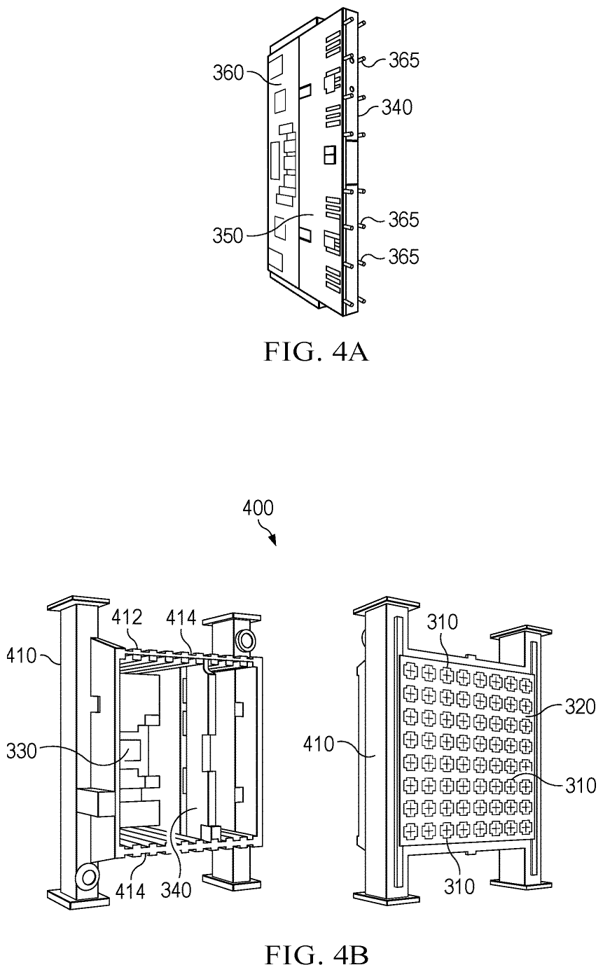

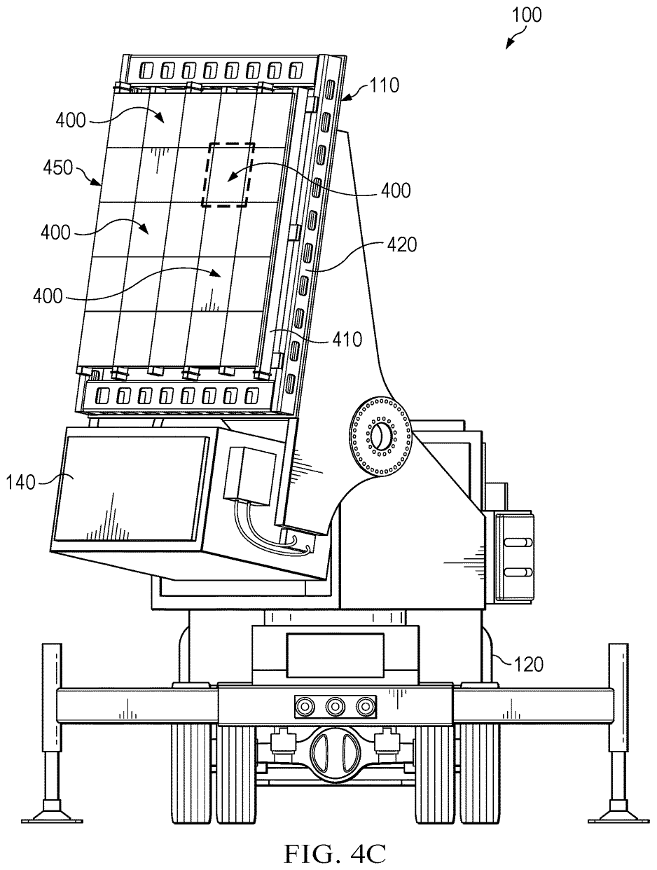

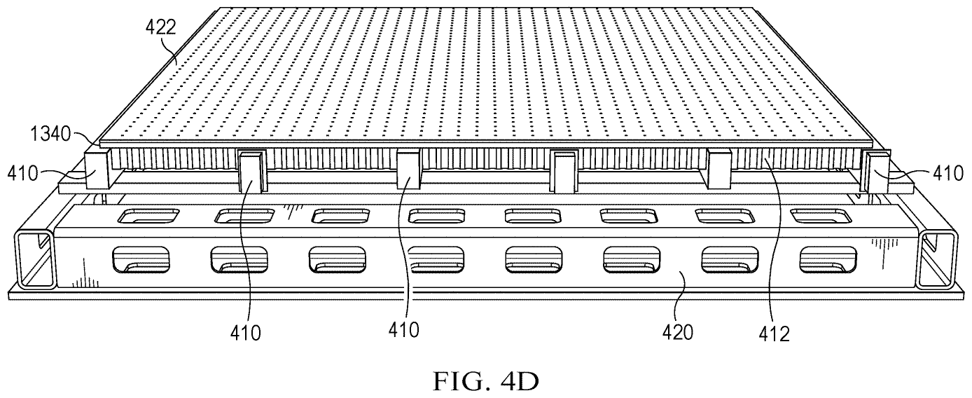

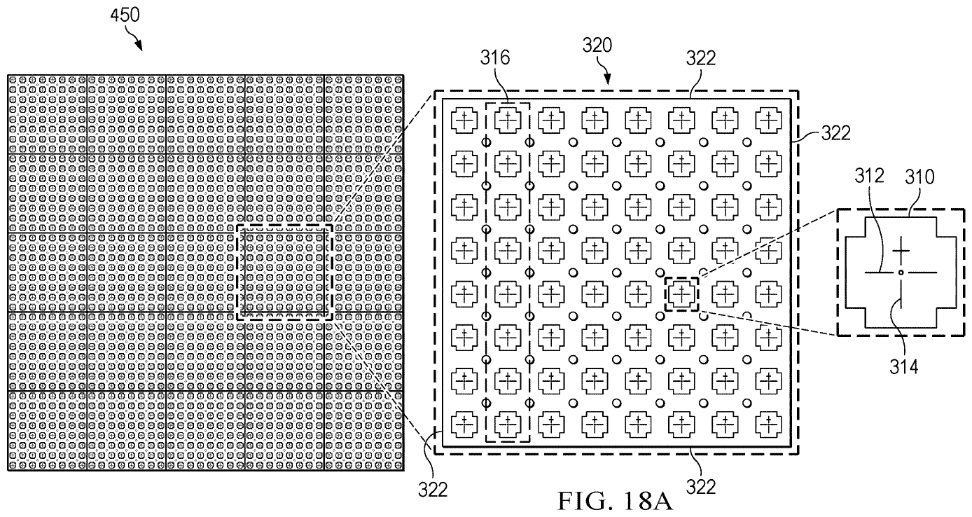

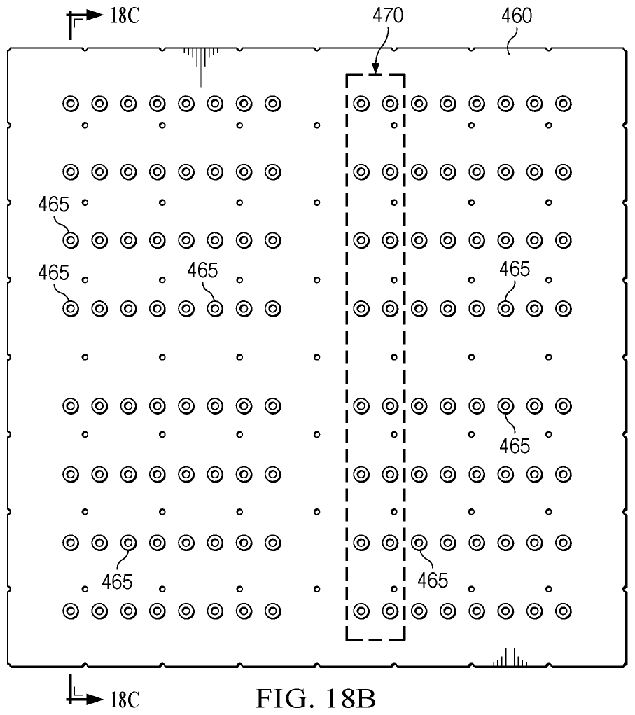

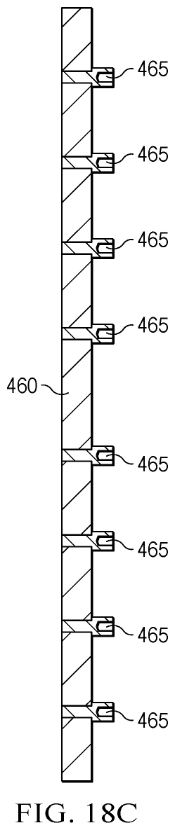

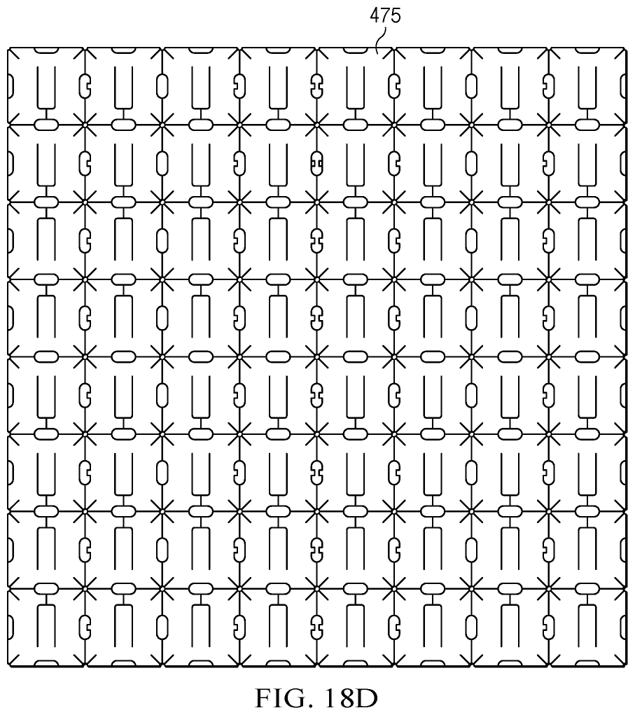

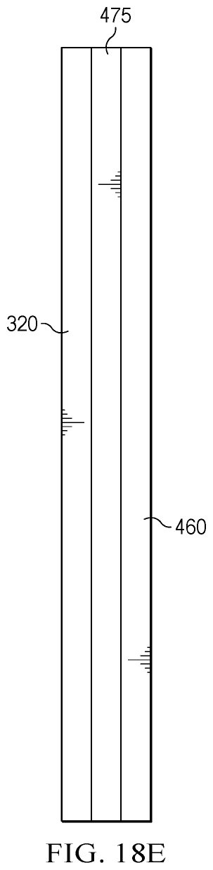

FIG. 3 is a block diagram 300 of an array panel (shown in perspective in FIG. 4B) showing a plurality of dual-polarization radiating elements 310 (referred to hereafter as a radiating element 310) mounted in a row (or column) on an antenna panel 320 in the PAR system 110. The block diagram 300 shows only a partial array panel because it does not include an array frame upon which the array components are mounted. Each of the 8 radiating elements 310 of the antenna panel 320 includes a horizontal (H) component 312 and a vertical (V) component 314. In this embodiment, the antenna panel 320 has eight radiating elements 310, but in other embodiments the number of radiating elements 310 could be less than or greater than 8. A power backplane 330 is positioned adjacent the antenna panel 320. Each H component 312 and V component 314 of each radiating element 310 is connected via an antenna port 465 (FIG. 18B) to a transmission-receiver-processor assembly (TRP assembly) 340 which transmits signals to and receives signals from the radiating elements 310 via an RF board 350, and processes the signals via a digital board 360 (an FPGA-based processing board). The TRP assembly 340 is connected to the antenna ports 465 of the antenna panel 320 via a plurality of connectors 365 (see FIG. 4A). Each H component and V component of a radiating element 310 has a separate signal path 370 through the corresponding RF board 350 and the digital board 360 of the corresponding TRP assembly 340. A digital bridging subassembly 380 is connected to each pair of TRP assemblies 340, which is used for synchronization and timing reference distribution. A supervisory assembly 390 provides power to the power backplane 330 which in turn provides power to the TRP assemblies 340 and provides synchronization of the TRP assemblies 340 through the digital bridging subassemblies 380.

Modular panel electronics in the array panels provide the scalable building block of the fully digital array. In the PAR system 110, an array panel assembly 400 comprises eight antenna panels 320, each of which comprises 8 radiating elements 310, for a total of 64 radiating elements 310 in the array panel assembly 400 (FIG. 4B). The radiating elements 310 are connected to the RF electronics of the RF boards 350 via connectors 365 such as, in a non-limiting example, SMP-MAX connectors. The antenna panels 320 of the array panel assemblies 400 are mounted upon a continuous ground plane module on the front of the PAR system 110, while the other electronics such as the TRP assemblies 340 are installed from the rear for accessibility during system maintenance (e.g., see FIG. 4A), as described in further detail below. The controller 150 (FIG. 1) is configured to provide operational instructions to the TRP assemblies 340, thereby enabling the TRP assemblies 340 to obtain radar data; receive the radar data from the array panel assemblies 400; process the radar data to obtain processed radar data; and display the processed radar data. The electronics of the presently disclosed PAR system utilize a brick architecture to provide a highly-serviceable and modular hardware platform. As a ground-based system, there is space for the depth of a brick architecture, rather than being constrained to panelization of the electronics in a tile. Since the electronics are not as tightly integrated as required by a tile architecture, the material stack-up and fabrication design rules for each PCB in the panel are individually tailored to improve manufacturability and minimize fabrication costs.

FIG. 4A is a perspective view of an (uncovered) assembled TRP assembly 340. Sixteen connectors 365 for connecting to the antenna ports 465 (FIG. 18B) are visible on the righthand edge of the TRP assembly 340.

FIG. 4B shows a rear (left) and a front (right) perspective view of an array panel assembly 400 within which can be installed the various digital electronic components such as the TRP assemblies 340, the digital bridging subassemblies 380, the supervisory assembly 390, the power backplane 330, and the various connecting cables. The array panel assembly 400 in FIG. 4B (right) shows 8 vertically-oriented antenna panels 320, each with 8 radiating elements 310. Each antenna panel 320 of 8 radiating elements 310 (arranged column-wise) is operably connected via 16 antenna ports 465 to one TRP assembly 340 via the 16 connectors 365. The TRP assemblies 340 are supported on an array frame 410 which comprises a card cage 412. The card cage 412 comprises a plurality of s 414 into which the TRP assemblies 340 are slotted. Thus, when fully assembled, the array panel assembly 400 comprises one antenna panel 320 (8 vertically-oriented antenna subpanels 316), 8 TRP assemblies 340 within the card cage 412, 4 digital bridging subassemblies 380, one supervisory assembly 390, and one power backplane 330 supported on the array frame 410. The card guides 414 comprise one card guide 414 configured to receive and position the supervisory assembly 390 and 8 card guides 414 configured to receive and position the 8 TRP assemblies 340. In other embodiments, the card guides 414 can be made to be extendable, enabling scalability of the supervisory assembly 390 and the TRP assemblies 340.

FIG. 4C is a rear perspective view of the mobile radar system 100 of FIG. 1, with the radome 130 of the PAR system 110 removed to expose a complete radar array 450 comprising 25 array panel assemblies 400 (in a 5×5 arrangement) mounted upon a superstructure 420. One antenna panel 320 is emphasized by dashed lines to show how the array panel assemblies 400 are arranged in the 5×5 array to form the radar array 450. In FIGS. 4A-4C, the scalability of the mobile radar system 100 is demonstrated. Array panel assemblies 400 can either be added or removed from the PAR system 110, thus scaling up or scaling down the system. A passive backplane for power distribution is installed inside the array panel assembly 400 as shown in FIG. 4B. Eight TRP assemblies 340 and a supervisory assembly 390 are positioned within the array panel assembly 400. A TRP assembly 340 contains the full radar chain from the analog RF RFEs (RF boards 350) through the digital transceivers and processors (digital boards 360) for 8 radiating elements 310 of each antenna subpanel 316. The supervisory assembly 390 is responsible for converting the system-level 400 VDC power to 50 VDC and 12 VDC used by array panel electronics, as well as centralized monitoring, control, and signal distribution for each array panel assembly 400. One digital bridging subassembly 380 connects two TRP assemblies 340 and assists the supervisory assembly 390 with distributing timing, synchronization, and control signals to the digital boards 360 within the TRP assembly 340. In FIG. 4C only the front “radiating element” surface of each antenna panel 320 is shown. As noted, the superstructure 420 supports 25 array panel assemblies 400. Referring to FIG. 4D, it is seen that the superstructure 420 supports a ground plane 422, which supports the individual antenna panels 320 that form the exposed frontal portions of the array panel assemblies 400. The ground plane 430 may also be referred to as a comprising ground plane modules. Shown in the ground plane 422 are a plurality of holes 424 through which the antenna ports 465 of the antenna panels 320 extend. It will be understood that the PAR system 110 is only one non-limiting embodiment of a PAR system described and enabled in the present disclosure. A PAR system of the present disclosure may be scaled up to include more than 1,600 radiating elements 310 or scaled down to include fewer than 1,600 radiating elements 310. In certain non-limiting embodiments, the PAR system may comprise radar arrays of, for example, 36 array panel assemblies 400 (6×6 arrangement), 49 array panel assemblies 400 (7×7 arrangement), 64 array panel assemblies 400 (8×8 arrangement), or even 81 array panel assemblies 400 (9×9 arrangement) if a sufficiently large and adequate support structure is constructed upon which the array panel assemblies 400 can be mounted. It will also be understood that array panel assemblies comprising more than or fewer than 64 radiating elements be used in the above radar arrays.

### B. Transmission-Receiver-Processor Assembly (a.k.a. “OctoBlade”)

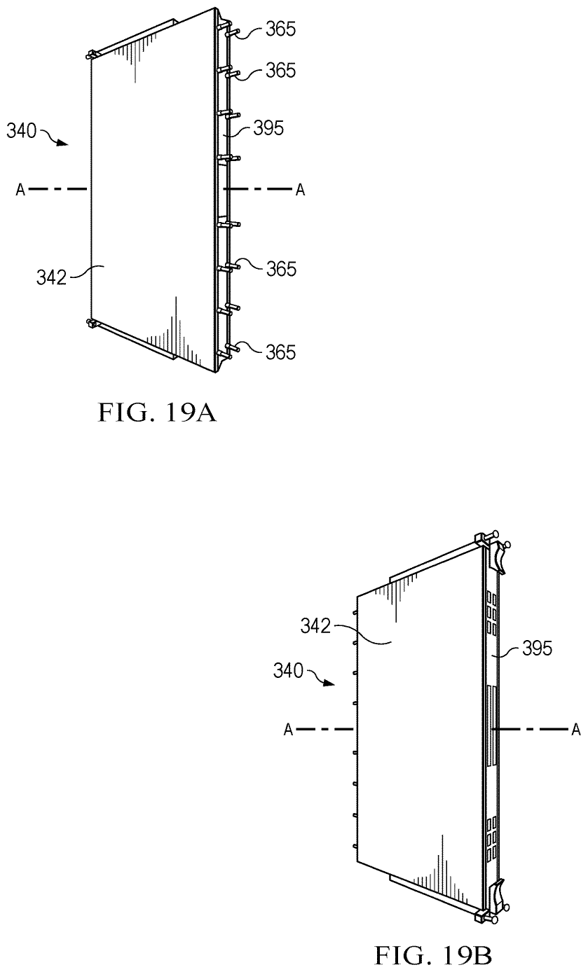

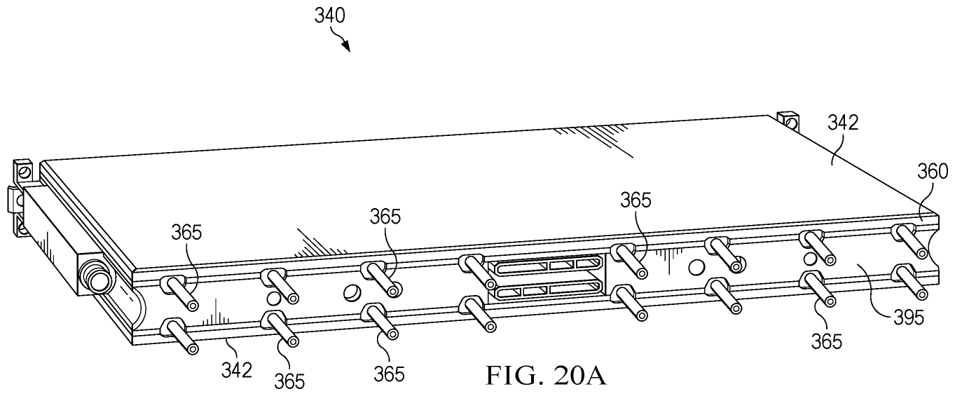

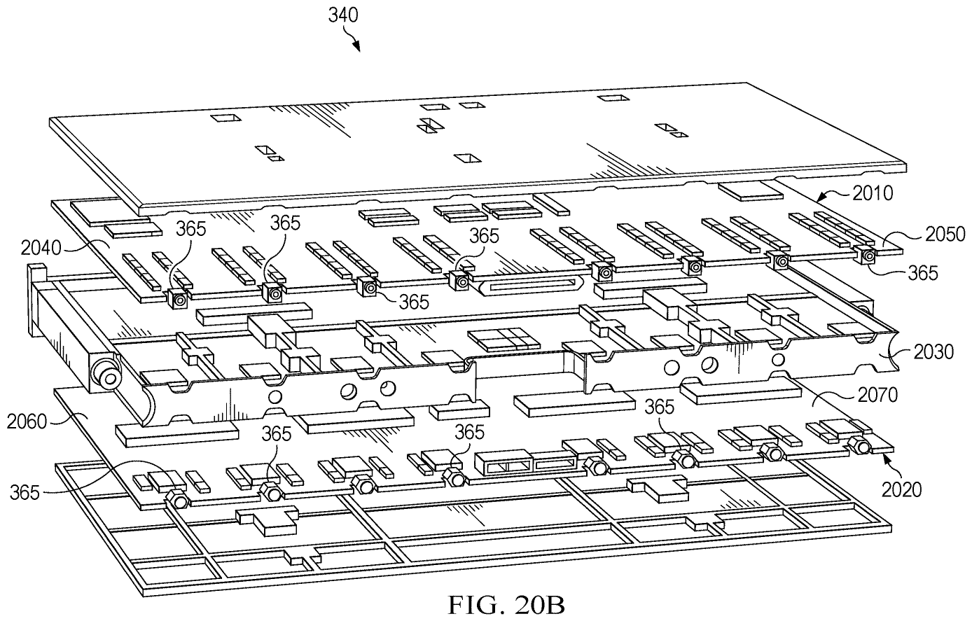

The transmission-receiver-processor (TRP) assembly is an LRU and is the fundamental building block of the disclosed PAR system A single TRP assembly 340 feeds eight dual-polarization radiating elements 310 and 16 channels of radar electronics. As with other aspects of the system, the TRP assembly 340 is also modular, primarily to facilitate system upgrades, scalability, and design reuse in future projects. Modularity is also beneficial during volume production for PCB yield rates, as it reduces the number of electronics that must be discarded if there is a PCB that does not pass quality assurance tests and is unable to be repaired. As shown in FIGS. 3 and 4A, the TRP assembly 340 has three main components: the RF board 350 (the “Octo-Quad”), the digital board 355 (the “Octo-FPGA”), and a heat transfer plate 395 (see FIG. 20A) which is sandwiched by mated RF board/digital board pairs 360 mounted on opposite surfaces of the heat transfer plate 395. These components are enclosed by a pair of metal TRP assembly covers 342 (see FIGS. 19A-19B) when the TRP assembly 340 is completely assembled. Each RF board/digital board pair 360 on either surface of the heat transfer plate 395 feeds eight RF ports for a single polarization (an H component or V component). By feeding the H and V components of the corresponding eight radiating elements 310 in this fashion, the TRP assembly 340 has the benefit of physically isolating the H and V polarization circuitry, which preserves the inherent polarimetric isolation provided by the radiating element by minimizing parasitic couplings. The TRP assembly 340 is hot-swappable and is also symmetric when rotated 180°, so the TRP assembly 340 is insensitive to orientation when installed in the array panel assembly 400.

The RF board 350 is responsible for analog RF circuitry and conversion between the RF and digital domains. Each of the eight channels on the RF board 350 has an independent radar chain with a 10 W GaN HPA, a T/R switch, a limiter, and an LNA. Since the PAR system 110 is a fully digital radar, digitally-controlled stepped attenuators and phase shifters are not necessary, as that functionality is implemented in the FPGA digital signal processing fabric of the digital board 355. An attenuated bypass path around the LNA is implemented to enable high-linearity measurements of mutual coupling while transmitting full power out of nearby elements to assist with system calibration. The AD9371 (Analog Devices) is a dual-channel RF transceiver capable of tuning from 300 MHz to 6 GHz with up to 100 MHz of instantaneous bandwidth. This highly-integrated transceiver is utilized on the RF board 350 to provide a translation layer between the RF RFE and the digital interface between the RF board 350 and the digital board 355. The RF board 350 also incorporates several supporting circuits, like numerous RF calibration paths between the AD9371 and the RFE, external LO distribution to the AD9371, and hot-swap power controllers to protect the RF board 350 in the event of power issues.

The main processing on the digital board 355 is implemented with a pair of Intel Arria 10 GX FPGAs that perform the array signal processing and digital waveform generation. Each Arria 10 is supported by a bank of DDR4 RAMs for storing arbitrary waveforms and buffering receive samples prior to digital beamforming. Utilization of DDR4 RAM in modern radars that rely on FPGAs is one of the best ways to achieve real-time beamforming and other radar functions at reasonable power and monetary costs. An Intel Cyclone V SoC FPGA based daughtercard, running Linux on hardened ARM processor cores, configures and manages the Arria 10s, configures and manages the AD9371 transceivers, performs online diagnostics, and ensures proper operation of the electronics. Four Samtec QRM8-RA connectors provide the JESD20B, SPI, and GPIO interfaces for the AD9371 transceivers and for controlling the RFE. External LOs for the AD9371s feed through the digital board 355 from the digital bridging subassembly 380 to the RF board 350. The data network on the PAR system 110 is implemented within the Arria 10 FPGAs and exposed via six Samtec ARC6 connectors on the rear of the PCB. These connectors route directly to four high-speed serial transceivers per port on the Arria 10 FPGAs. In addition to the external ports, there is an internal network port between the two Arria 10s routed through the PCB. This implementation is protocol agnostic, enabling the exploration of varying network protocols and architectures. Additional diagnostic interfaces, such as JTAG, I2C, and a serial UART console for the Cyclone V SoC, are available to the supervisory assembly 390 via the digital bridging subassembly 380 to support managing and debugging TRP assemblies 340 while installed in the PAR system 110.

The heat transfer plate 395 is a metal plate, constructed of a heat-conducting metal, for example, aluminum or copper. In certain embodiments, the heat transfer plate 395 comprises an internal serpentine fluid path for conducting a cooling fluid (“coolant”). The heat transfer plate 395 blind mates” to liquid distribution manifolds that are integral to the mechanical structure (the array frame 410) of the array panel assembly 400. The internal serpentine fluid path navigates by each of the major heat-producing components on the TRP assembly 340 to move the heat into the coolant. The heat transfer plate 395 utilizes, for example, Staubli dripless connectors to allow the TRP assembly 340 to be inserted and removed from the array panel assembly 400 without leaking, even while fluid is circulating through the rest of the system.

### C. Cooling and Structural System

To ensure system reliability and calibration performance of phased arrays, it is important to maintain stable thermal characteristics and minimize temperature gradients across the aperture. While the heat transfer plate 395 is responsible for transferring heat away from the TRP assembly 340, the PAR system 110 is designed to appropriately distribute and collect coolant fluid throughout the array panel assembly 400 in a practical and scalable manner.

The array frame 410 is configured to distribute a cooling fluid for cooling the supervisory assembly 390 and the TRP assemblies 340. Fluid distribution for the array panel assembly 400 is incorporated into the array frame 410. The electronics lattice is intentionally reduced compared to the element lattice spacing within the array panel assembly 400 in order to make space for the supporting array frame 410 and fluid distribution therein. FIG. 4B shows rectangular aluminum columns on either side of the array panel assembly 400. Horizontal fluid distribution manifolds are welded between the vertical columns at the top and bottom of the array panel assembly 400. Each horizontal manifold may open only to one of the vertical columns, forcing the fluid to flow through the heat transfer plates 395 of the TRP assemblies 340 and the supervisory assembly 390 in a array panel assembly 400 passing the exhaust fluid through the other horizontal manifold and vertical column. Each horizontal manifold is shared between adjacent array panel assemblies 400 vertically, alternating the fluid flow direction through each array panel assembly 400. Likewise, each vertical column is shared between adjacent array panel assembly 400 horizontally across the array. This method of fluid distribution ensures that all HTDs in the system are in parallel and no coolant flows out of one HTD and into another (in the embodiments of the array panel assembly 400 that have heat transfer plates 395 with fluid paths). This results in nearly uniform temperatures across the full array, minimizing thermal impacts on array calibration.

### D. Antenna Design and Validation

The PAR system 110 antenna design improves performance compared to that of WSR-88D parabolic-reflector antennas. These design specifications are important, given that the weather mission presents more challenging polarimetric requirements, in terms of accuracy of estimates, than those for aircraft surveillance missions. An array panel assembly 400 may comprise 64 radiating elements 310, in an 8×8 arrangement, configured in a two-dimensional square lattice of 0.52 spacing. In other embodiments of the present disclosure, the array panels may comprise fewer or more than 64 radiating elements 310. In a non-limiting embodiment, the radiating element 310 may be an aperture-coupled microstrip crossed-patch radiating element with independent feed layers for the H-polarization and V-polarization is adopted for high cross-polarization isolation of greater than 40 dB across a scan range of 90° in the principal planes. A parasitic microstrip patch layer is incorporated to have a frequency operation of 2.7-3.1 GHz. A Taconic substrate is used for the driving and parasitic crossed patch antennas, and a Rogers 4350B laminate is used for the feeding network.

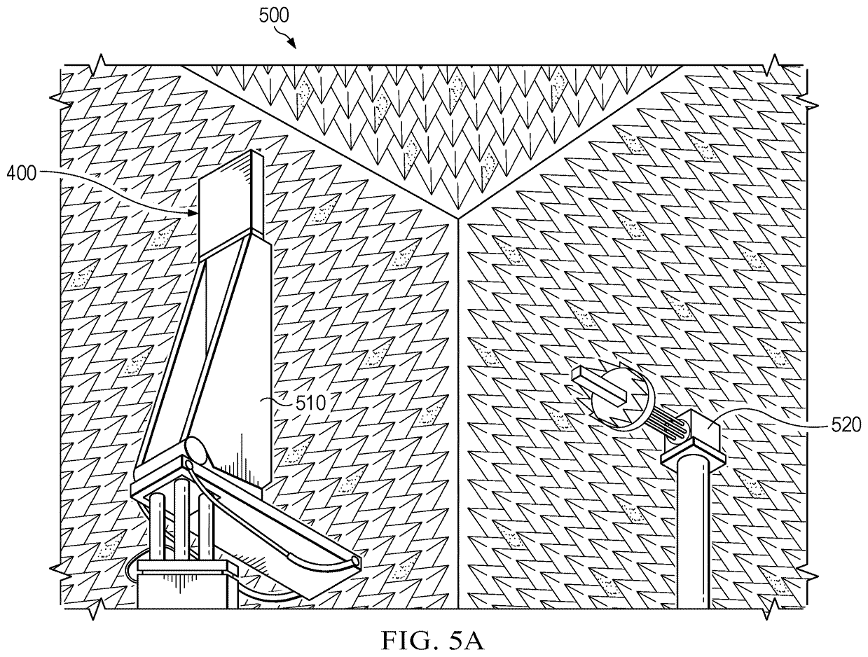

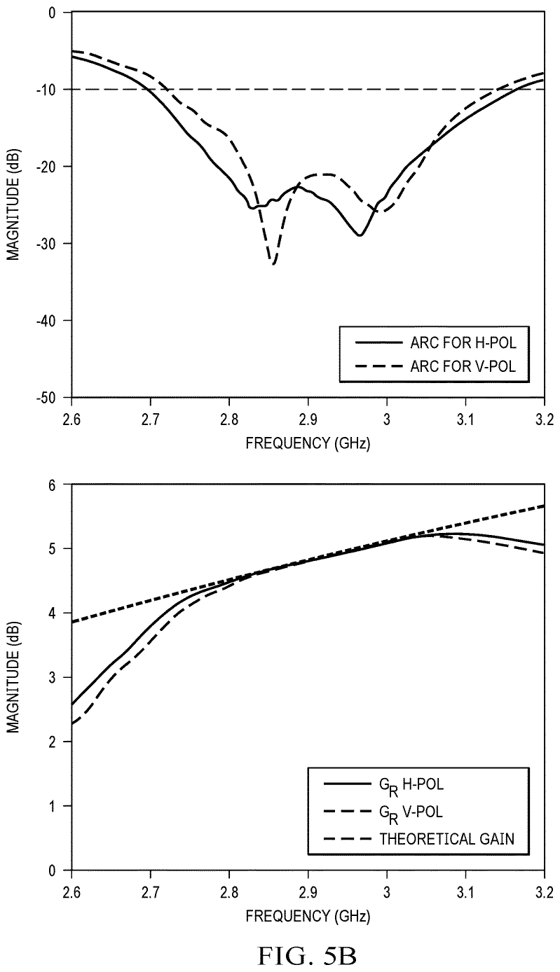

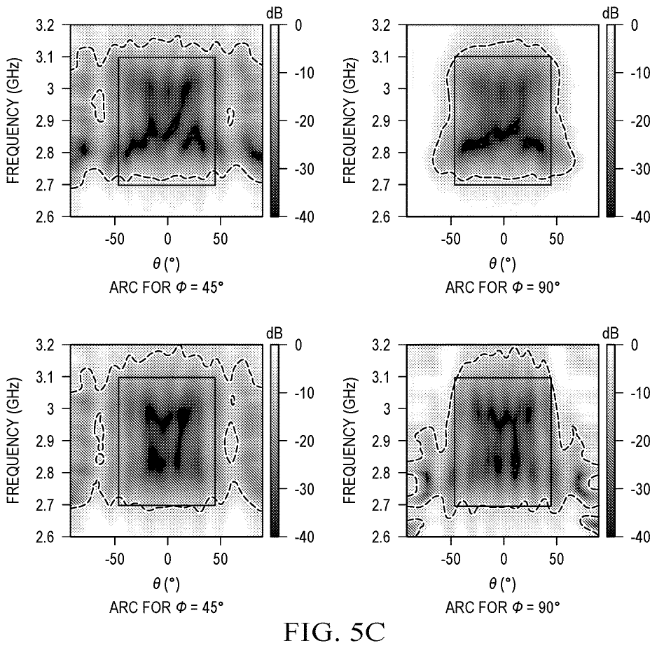

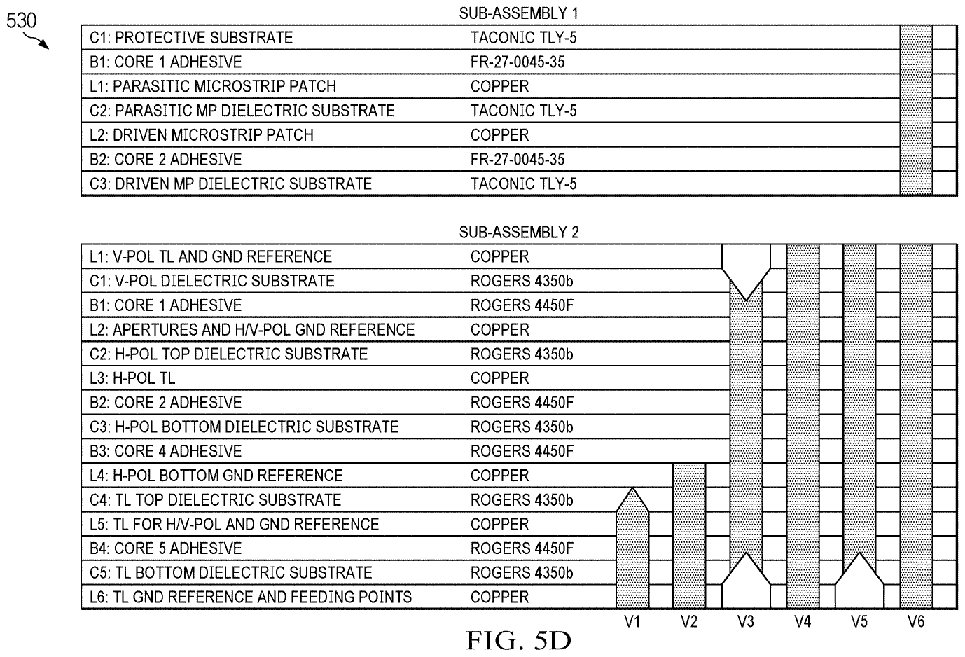

FIG. 5A is a picture of an experimental setup 500 of an array panel assembly 400 in a far-field anechoic chamber. The array panel assembly 400 under test is supported on a panel support structure 510 and is scanned with a probe 520. FIGS. 5B-5C show results measured from the experimental setup 500. Specifically, FIG. 5B shows graphical results of antenna embedded S-parameters. FIG. 5C shows graphs results of measured ARC as a function of scanning angle for H-polarization and V-polarization. FIG. 5D shows an antenna stack-up 530 of a non-limiting embodiment of an antenna element used in the PAR system 110. Multiple factors in the radiating elements were investigated during the design and fabrication process of the 8×8 array, and these factors include edge diffraction suppression; fabrication tolerances, including bandwidth in excess of 15.4% at a central frequency of 2.8 GHz; port-to-port isolation in the element on the order of −50 dB; cross-polarization levels below −40 dB and co-polar mismatch below 0.1 dB at ±45° and ±10° for a scanning range in the azimuth and elevation planes; and an active reflection coefficient of at least −10 dB at ±40° for a scanning range in any plane.

### E. Software Architecture

The PAR system 110 is a software-defined radar, which presents many opportunities to develop novel capabilities, along with risks and pitfalls in managing the system complexity and usability. PAR system 110 is intended to not only be a testbed for advanced fully-digital experiments, but also a fieldable system used to routinely collect polarimetric weather data. Significant effort was invested in identifying the most likely deployment scenarios to determine tolerable constraints and assumptions to incorporate into the software, while still enabling many unique capabilities. This resulted in a substantial improvement in system usability and frees the operator to focus on radar applications rather than radar technology. Since PAR system 110 is software-defined, the system may be continuously upgraded to enable new capabilities.

The software is partitioned into four main layers: the deterministic radar signal processing and control in the Arria 10 FPGAs, the embedded software managing the TRP assemblies 340 on the Cyclone V SoCs, back-end data processing on servers, and the operator interface running on desktop or laptop computers.

The Arria 10 FPGAs define the low-level capabilities of PAR system 110, implementing the radar processing chain in fabric. A transmit processing chain in the FPGA encompasses generation of parametric or arbitrary waveforms, transmit beamforming that applies spatial weights to the generated waveform, transmit alignment calibration to compensate for amplitude and phase offsets between elements, and transmit predistortion to improve system linearity. All of these coefficients may be non-adaptive. For instance, the predistortion coefficients can be computed offline. On receive, the samples pass through a receive alignment calibration block, undergo down-conversion and decimation to select the desired bandwidth, and then undergo buffering into RAM prior to beamforming. The Arria 10 FPGAs manage scan scheduling, configuring the appropriate settings for each pulse, and deterministic triggering and control of the functions within the FPGA, as well as the RF hardware on the RF board 350.

To make the high volume of data produced across the array manageable, the typical PAR system 110 operating mode digitally beamforms on the array so that the data processing servers receive fully-formed beams. This enables the reuse of algorithms and processing software. PAR system 110 implements a systolic beamforming architecture over a RapidIO network that interconnects all TRP assemblies 340 in an array panel assembly 400. RapidIO is a commercial, open-standard interface that supports high-bandwidth, low-latency, packet-switched interconnect between multiple DSP processing elements and between DSP processing elements and bulk memory. For PAR system 110, RapidIO is used to transfer high-speed data between FPGAs for scan configuration and receive beamforming. RapidIO helps to form the distributed backend of the radar. When an Arria 10 FPGA receives a packet containing beam data, it retrieves the relevant samples from memory, locally beamforms the directly attached channels, and combines it with the data it received. In brief, each of the four Arria 10 FPGAs form weighted sums of the I and Q baseband data that are produced by the four digitizers that precede each FPGA with partially completed beams from upstream FPGAs; hence, partial beamforming is achieved to reduce the amount of raw I and Q data that need to be routed. Once the FPGA has contributed its data to the partial beam, a packet is sent to the next FPGA to repeat the process until the beam is fully formed and ingested by a server via a PCIe FPGA card connected to the RapidIO network.

Overall, PAR system 110 is controlled by a scheduler that can switch among scan strategies on a CPI basis. Generally, the scan strategy refers to the pulse waveform, polarization state, transmit/receive beam weights, PRT, CPI, number of beams, etc. Therefore, the volumetric update rate can be readily traded with data quality. From a system design perspective, the PAR system 110 software architecture is designed to provide the user maximum flexibility with the overarching goal of producing the highest temporal resolution possible while maintaining high-quality, polarimetric, weather radar observations.

### V. CALIBRATION

As highlighted in section III above, the technology landscape supporting modern digital arrays has continually maturing tools for establishing and maintaining calibration and alignment as an intimate corollary to their inherent challenges and opportunities. For PAR system 110, the focus is on approaches to maintaining proper alignment, sufficiently low sidelobes, and correcting for polarimetric measurement errors. Alignment of a phased-array antenna has been described as the process of bringing all of the radiating elements into phase alignment so that the radiated power adds coherently in a given direction. The development of PAR system 110 allows for the exploration of the practical limitations in digital array calibration. This includes quantifying and extending other performance metrics such as dynamic range and spectrum-related interoperability using digital NLEQ, DPD, or intentional decorrelation of spurious products to maximize dynamic range. For example, such relatively low-power spurious products include third-order harmonics and intermodulation terms.

PAR system 110 has a number of tools from which it can leverage built-in or auxiliary measurements to assess or estimate the element-level amplitudes and phases of the signals on the ADCs and DACs relative to what they should be, ideally, if the array is scanning (transmitting or receiving) to or from a particular angle. PAR system 110 achieves this with a specific overall aperture window or taper, taking all physical effects into account. The techniques being used and explored all seek to assess these ground-truth relations between the element-specific and polarization-specific digital waveform amplitudes and phases and the actual fields that would exist in a clear atmosphere.

### A. Far-Field Calibration and UAS-Based Measurements

Methods for far-field phased array calibration are extensions of classical far-field measurements to element-level amplitude and phase alignment or for assessment of dual-polarization performance. Characterizing antenna patterns with high accuracy typically requires the use of specialized indoor or outdoor antenna range facilities. In both cases, the intrinsic properties of the antenna pattern measurements must exclude undesirable reflections, diffraction, and other external sources of contamination that may influence the overall measurement. When the radar system is deployed, the antenna array is mounted on a mechanical pedestal and is surrounded by other elements such as a radome, a tower, lightning protection, and RF equipment. Ground irregularities produced by topography, morphology, and environmental conditions, such as temperature and humidity, that are different for each site have also been proven to negatively impact the overall performance of radars. Nevertheless, far-field measurements have been leveraged for array alignment and calibration. For large arrays, such an approach requires a separation between the radar of aperture diameter D and measurement antenna on the order of 2D2/λ, which is not practical indoors for S-band weather radar systems.

As an alternative to this far-field measurement, a method to characterize the antenna patterns of PAR system 110 and far-field calibration using an UAS can be used. A UAS RF test system uses a commercial hexacopter UAS platform implemented with a customized RF transceiver and antenna probe that provide excellent dynamic range polarization performance. The UAS platform dimensions and features were selected to support an RF metrology mission for long endurance, position accuracy, stability, and enough payload to carry out an RF transceiver, DGPS system, and RF probe.

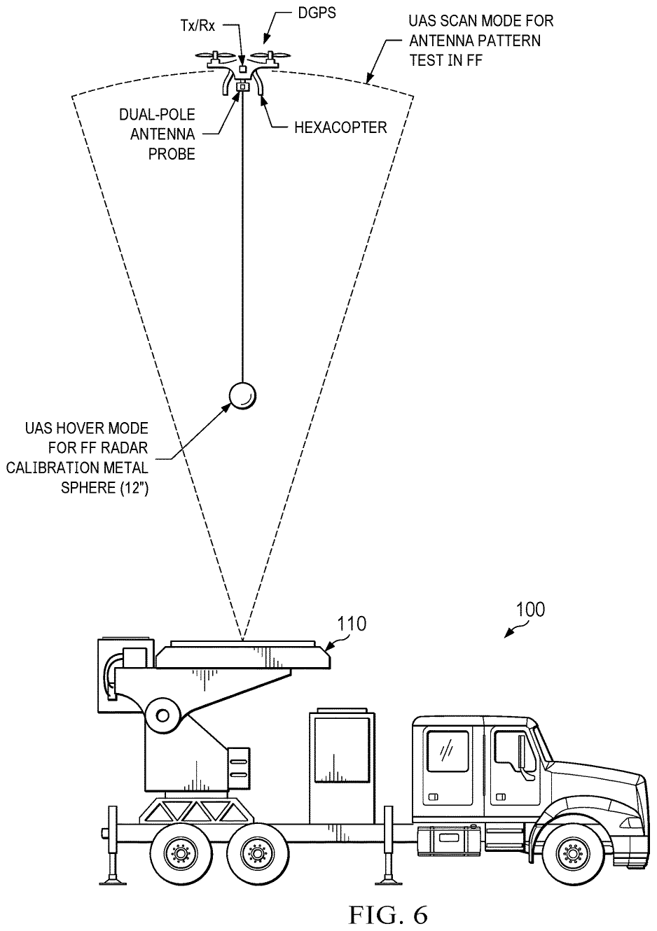

FIG. 6 illustrates how polarimetric far-field calibration and antenna pattern characterization of PAR system 110 in bird-bath mode can be performed using a UAS. A 12-inch diameter metallic sphere tethered to the UAS platform in hover mode is used to perform the calibration in the far-field region, which is greater than 80 m. In this case, a separation of 20 m from the UAS to the metallic sphere is used to minimize the back-scattering contamination from the drone. The UAS in spherical scanning mode is used to characterize antenna patterns in the far field. For antenna pattern characterization, an antenna probe was designed with high polarization isolation of less than 50 dB and beamwidth of less than 40° to minimize scattering fields induced in the UAS. Antenna patterns of PAR system 110 can be obtained using a spherical scanning mode when PAR system 110 is aimed upwardly. This test procedure reduces ground and clutter contamination.

### B. Near-Field Calibration

For most large arrays, near-field measurements provide the standard mechanisms to carefully assess the array characteristics. This is especially true for determining sidelobe levels and pointing accuracy, among other important characteristics. If performed carefully, near-field measurements can provide an understanding of root causes of any antenna limitations.

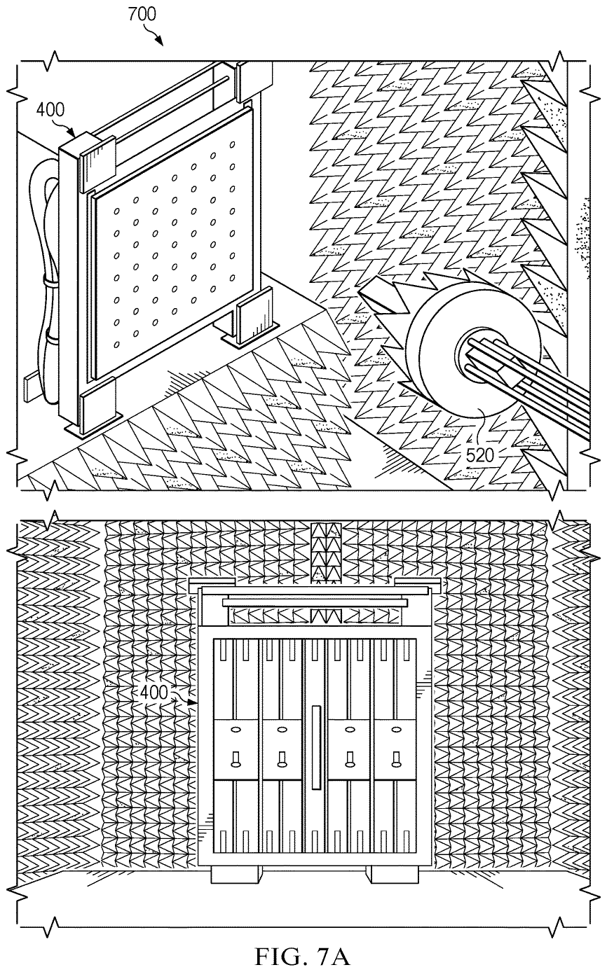

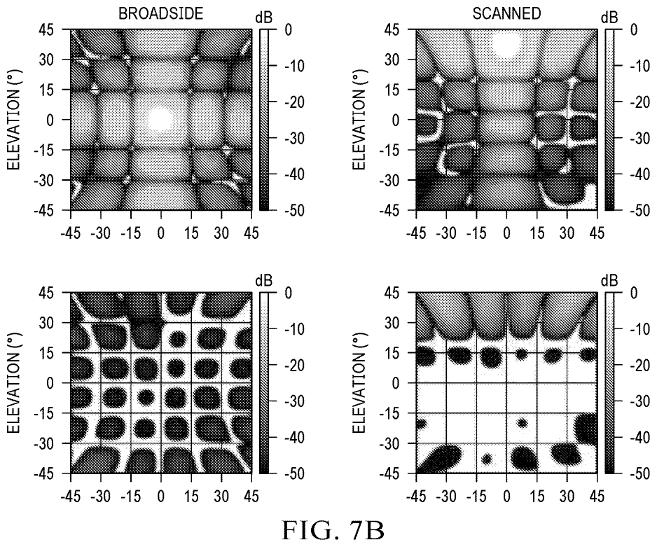

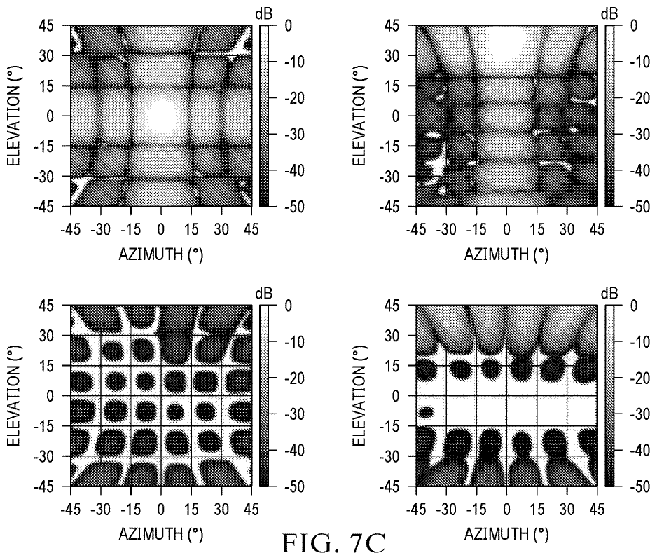

FIG. 7A illustrates a near-field scanner setup used to characterize H and V antenna patterns of a fully active array panel assembly 400. The array panel assembly 400 was fully populated with electronics that made up the transmit and receive signal paths. The front side of the array panel assembly 400 is shown in the upper panel of FIG. 7A and the open rear side of the array panel assembly 400, with the various internal array electronics exposed, is shown in the lower panel of FIG. 7A The complete subsystem was mounted in a near-field chamber for testing. The near-field scanner is comprised of two motorized Velmex BiSlide assemblies, one Velmex VXM Stepper Motor Controller, an S-band OEWP, a Newport optical breadboard base, and an RF absorber. These features enable the measurement of antenna patterns for H and V polarizations.

The current process for Horus near-field calibration uses a park-and-probe technique to measure amplitude and phase at each channel. Then the alignment weights are generated, applied digitally, and verified. Measurement of a full, dual-polarimetric transmit or receive pattern requires four separate data collections, one for each combination of array polarization and OEWP orientation of 0° or 90°. The array panel assembly 400 hardware can receive both polarizations simultaneously and feed the data back separately. Multiple beam angles can be collected simultaneously on receive. Up to 16 beams can be formed sequentially. After applying the park/probe and the back-projection calibration methods on the array panel assembly 400, the near-field patterns were measured and transformed into the far field.

FIG. 7B shows graphical results of the normalized H co-polar and cross-polar far-field patterns derived from near-field measurements. FIG. 7C shows graphical results of the normalized V co-polar and cross-polar far-field patterns derived from near-field measurements. The left columns of FIGS. 7B and 7C show broadside beam measurements, and the right columns of FIGS. 7B and 7C show a beam scanned at 36° in elevation. Dotted contours on the co-polar H and V patterns indicate the half-power beamwidth of −3 dB, whereas dotted contours in the cross-polar patterns indicate the −40 dB level. A qualitative comparison of the broadside patterns shows excellent mainlobe agreement between the H and V polarizations. The sidelobe structure for each polarization appears to be symmetric about the mainlobe for the horizontal and vertical cuts. Cross-polarization levels are below −50 dB at the peak of the corresponding co-polar patterns, and generally going from −55 dB to −45 dB across all angles. Achieving cross-polarization levels below −45 dB was one of the key goals in the design of PAR system 110, given the importance of minimizing this contamination for accurate polarimetric measurements.

### C. Mutual Coupling

Highly digital arrays can be used to leverage inherent inter-element mutual coupling measurements to provide feedback paths that encompass the individual phase and magnitude errors of the transmit and receive element's electronics. This concept is useful for initial calibration and alignment without the use of near-field or far-field test equipment, and for in-situ realignment and enforcement of new weightings in digital array systems.

An experiment was designed to measure relative performance of reference-based mutual coupling. A calibration horn was placed in the near field of an array panel assembly 400 and connected to an ODL repeater. By transmitting toward the horn from a single array element and receiving time-delayed returns from all array elements, relative alignment was established. Aligning the array using this test setup effectively focuses the array toward a fixed point in space some distance from the array face and provides a repeatable calibration target, which can be returned to for validation.

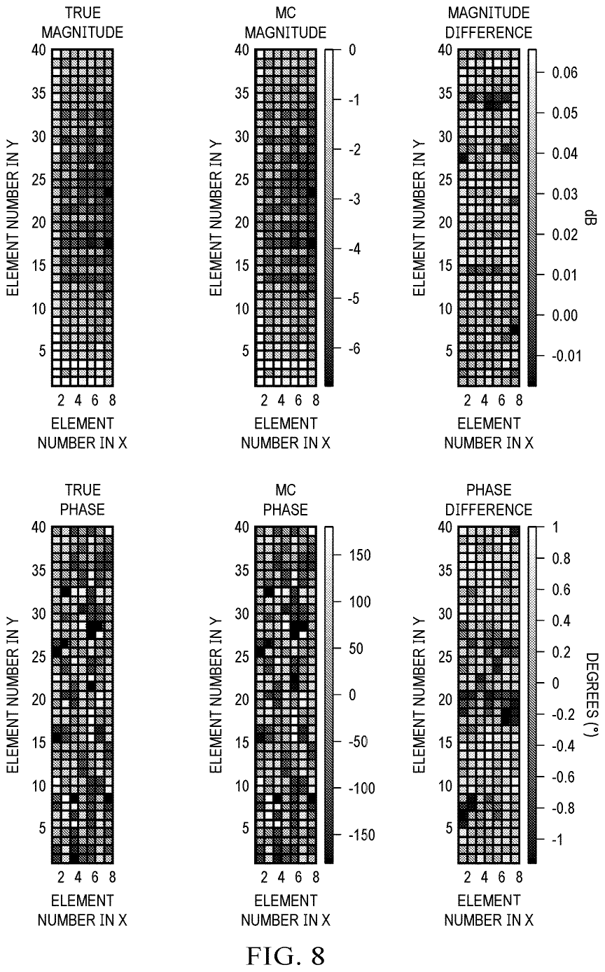

FIG. 8 shows graphical results from the experiments. The upper and lower panels show the array magnitude and phase, respectively, for the 5×1 array of panels (320 independent, dual-polarization radiating elements) that were populated with electronics at the time of the experiment. The true magnitude provides the magnitude of the ground-truth alignment weights from the experiment. The organized pattern seen in the magnitude data results from the actual antenna pattern of the horn. The MC magnitude provides weights estimated based on inter-element mutual coupling. With the array uncalibrated, mutual coupling calibration was applied targeting the focused array state, which produced an accurate estimate of the true weights. The difference between the truth and the estimated magnitude is provided in the right panel and has a standard deviation across the array of 0.012 dB. The lower panels are equivalent except for phase across the 320 channels. The standard deviation, in this case, is 0.395°.

Although just one example, the FIG. 8 results illustrate how mutual coupling can be used to realign the array to an arbitrary array state.

### VI. INITIAL WEATHER OBSERVATIONS WITH MOBILE RADAR SYSTEM 100

### A. Meteorological Conditions

During an afternoon in 2023, a mesoscale convective system formed along a cold front moving west to east over the Southern Great Plains of the United States. Forecast soundings suggested favorable deep shear for supercells (i.e., tornado-producing storms) with intense (25-35 m/s) winds in the 400-mb layer contributing to effective-shear magnitudes in the 30 m/s range. Temperatures changed throughout the day from ~10° C. to ~20° C. with similar changes in dewpoint, producing CAPE around 2,000 J/kg in central Oklahoma. This environment resulted in several storms that produced damaging winds, lightning, hail, and heavy rain from northwest Texas into central Oklahoma, as reported by the United States NWS. Many severe thunderstorm and flash flood warnings were issued by the NWS forecasters throughout the event.

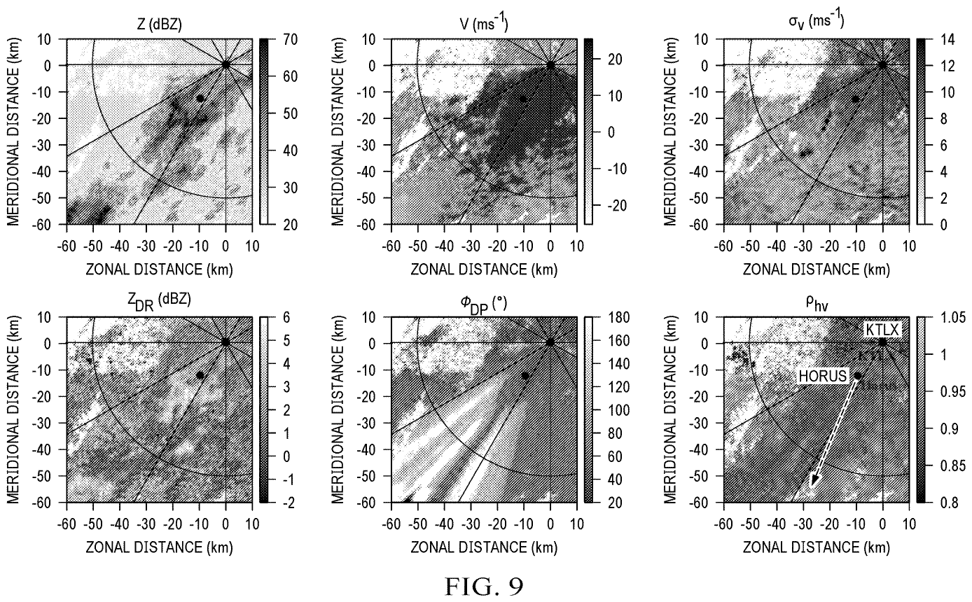

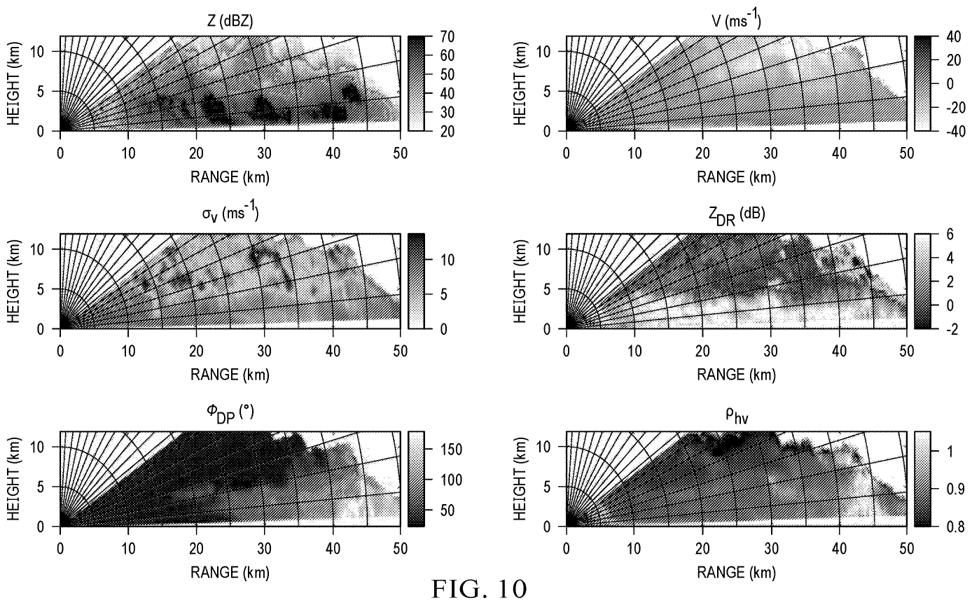

FIG. 9 shows graphical data collected by the operational KTLX WSR-88D in Twin Lakes, Oklahoma, at 20:35:06 Z. The top-left graph 900 shows radar reflectivity, the top-center graph 900 shows Doppler velocity, the top-right graph 900 shows spectrum width, the bottom-left graph 900 shows differential reflectivity, the bottom-center graph 900 shows differential phase, and the bottom-right graph 900 shows correlation coefficient. Data are from a PPI scan at the 0.5° elevation. Polarimetric weather data were collected with PAR system 110 simultaneously to evaluate initial polarimetric calibration and system performance. The radar was deployed at the Radar Innovations Laboratory in Norman, Oklahoma, from approximately 17:06:22 Z to 21:12:40 Z. Black circles in the graphs of FIG. 9 represent the location of KTLX and PAR system 110, where KTLX is in the origin of the polar coordinate system shown in the bottom-right graph. A dotted black line in the bottom-right graph indicates the azimuth direction corresponding to the PAR system 110 RHIs in FIG. 10.

### B. Experimental Radar Configuration

These initial weather observations were conducted with only a partial array of one complete vertical column of 5 array panel assemblies 400, forming a 5×1 radar array comprising 320 independent, dual-pol radiating elements. The half-power beamwidth of this configuration is approximately 13° in azimuth by 3.1° in elevation. The radar was configured to scan in the RHI mode from 0.5° to 32.5° with 0.5° sampling. A PRT of 1 ms with 64 samples per dwell was used, resulting in a scan time of 4.096 s. Pulse compression waveforms with non-linear frequency modulation were used with a pulse width of 80 μs and a bandwidth of 5 MHz, resulting in a range resolution of 30 m. The progressive pulse compression technique was implemented to mitigate the pulse-compression blind range. Range-time samples were produced at a rate of 15.625 MSPS, resulting in a range sampling interval of approximately 10 m. Data were collected for a range from 0.5-100 km for approximately 10 minutes pointing the antenna broadside to 205° azimuth, scanning the evolving storm cells as they moved toward the radar.

A single beam was formed by the real-time, digital beamforming network, and the time-series I/Q data were processed. The weather signal processor includes several methods to improve data quality, such as spectral-based noise estimation, electromagnetic interference filter, ground-clutter filtering, and multi-lag estimation.

FIG. 10 shows graphical results of polarimetric fields obtained with the 5×1 radar array, described above, at about 20:35:03 Z in 2023. The RHI scans are from 0.5° to 32.5° elevation, with sampling of 0.5°. The top-left graph 1000 shows Z, the top-right graph 1000 shows v, the middle-left graph 1000 shows σᵥ, the middle-right graph 1000 shows Z_{DR}, the bottom-left graph 1000 shows φ_{DP}, and the bottom-right graph 1000 shows ρₕᵥ.

### Data Quality Discussion

A qualitative evaluation of the fields shown in FIG. 10 indicates that data were coherently received and processed since they are relatively smooth and have realistic values. First, the Zₕ field shows smooth transitions from lower reflectivities of ~20 dBZ around the edges of the storm to reflectivities of up to ~55-60 dBZ at certain convective cores within the storm. This follows a conceptual model of the physics of storms, whereby stronger updrafts near the core produce a larger concentration and size of hydrometeors, increasing the overall reflectivity. Next, the vr field shows smooth variation with outbound velocities near the surface in red and shows relatively high inbound velocities aloft in green. The transition in Doppler velocity estimates at approximately ~500 m going from outbound to inbound through an iso-Doppler level, shown in grey, indicates a smooth change in the direction of the wind field. This is typical in convective storms and represents a change in storm advection direction.

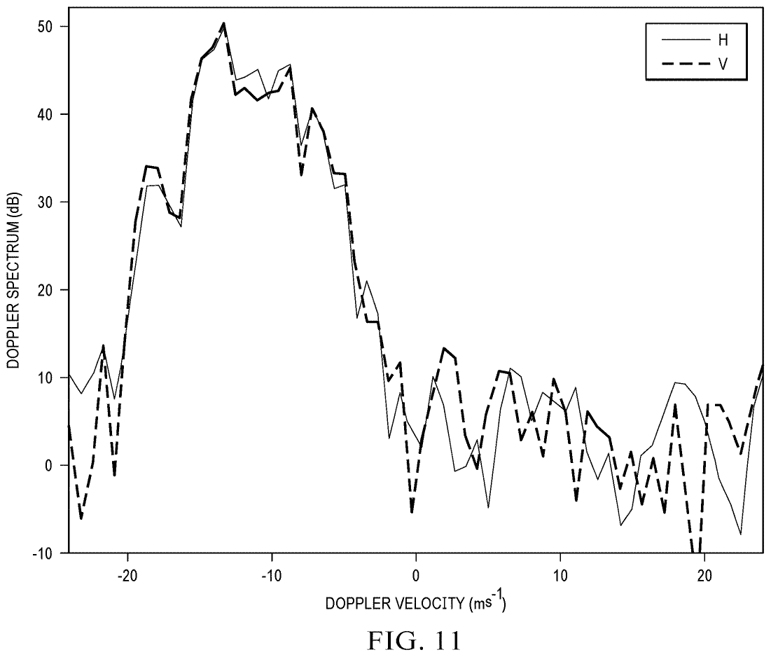

FIG. 11 shows graphical results of Doppler spectra from a location with weather returns of high SNR. The results show the approximately Gaussian shapes of the H and V spectra. Further, the spectra have similar shapes implying good matching of H/V beam patterns and indicating reasonable polarimetric calibration.

Returning to FIG. 10, the Z_{DR} and ρₕᵥ field present relatively smooth changes and plausible values. Specifically, Z_{DR} values are mostly between 0-3.5 dB. Lower values near 0 dB are expected at the higher levels of the storm or in regions with low Zₕ, indicating the presence of small, nearly-spherical raindrops or small, randomly-oriented ice particles such as crystals or snow when above the atmospheric melting layer. At lower heights, Z_{DR} is larger as the process of collision/coalescence increases raindrop size and due to air drag force raindrops become oblate as they are falling. This increases the Z_{DR}, which explains the larger values of 1-3.5 dB at lower altitudes. Certain regions of high Z_{DR} coincide with regions of high Zn, which is typically observed in storm updraft regions where larger and more oblate raindrops are present, for example, along the 30 km range and 3 km height.

The magnitude of the correlation coefficient between the horizontally-polarized returns and vertically-polarized returns, ρₕᵥ is a key parameter defining the quality of polarimetric radar measurements. The ρₕᵥ field in the bottom-right graph of FIG. 10 shows relatively high values of 0.9-1 as expected from hydrometeors. Most values are approximately 0.99, representing pure water raindrops. The standard errors of the estimates of polarimetric variables are significantly reduced if the maximum ρₕᵥ of the weather signals exceeds 0.99, which is a basic requirement for polarimetric weather radars. A region of lower ρₕᵥ is observed at a range of approximately 40-46 km, where a vertical column with ρₕᵥ ~0.92 is present. This may indicate the presence of mixed-phase precipitation, possibly a combination of raindrops and small hailstones, coupled with some signal attenuation, which is likely higher in the H polarization, as the beam propagated through strong precipitation cores. Although this was not confirmed by in-situ instrumentation, it is consistent with the conceptual model of deep convective storm cells. Several hail reports were received by the NWS and are available online.

The ρₕᵥ is defined as the normalized absolute lag-0 cross-correlation estimate, i.e., |R\hat{ }ₕᵥ(0)|/S\hat{ }ₕS\hat{ }ᵥ. At low SNR regions, estimates have a high standard deviation, therefore, the geometric mean of signal power estimates may be larger than the lag-0 cross-correlation, i.e., S\hat{ }ₕS\hat{ }ᵥ>|R\hat{ }ₕᵥ(0)|, which results in ρₕᵥ>1. S\hat{ }ₕ and S\hat{ }ᵥ are also estimates that depend on the noise power estimate. Correlation coefficient estimates larger than 1 are typically present on the edges of the precipitation, far from the radar where the SNR is low, and are considered invalid. This is commonly observed on ρₕᵥ estimates from any polarimetric weather radar, including those from the operational WSR-88D.

Accurate measurements of ρₕᵥ are crucial for polarimetric detection of the melting layer and determination of its height and are crucial for identification of the areas with hail and quantification of its size. Therefore, the requirements for the ρₕᵥ measurements in the design of the radars for weather observations are very strict and important.

Data from a sequence of 352 scans were analyzed and showed a smooth evolution of the discussed fields. The scan time series exhibited natural meteorological features consistent with storm evolution and advection, indicating that the PAR system 110 data appear accurate and therefore a fully digital PAR technology can be used for polarimetric weather observations.

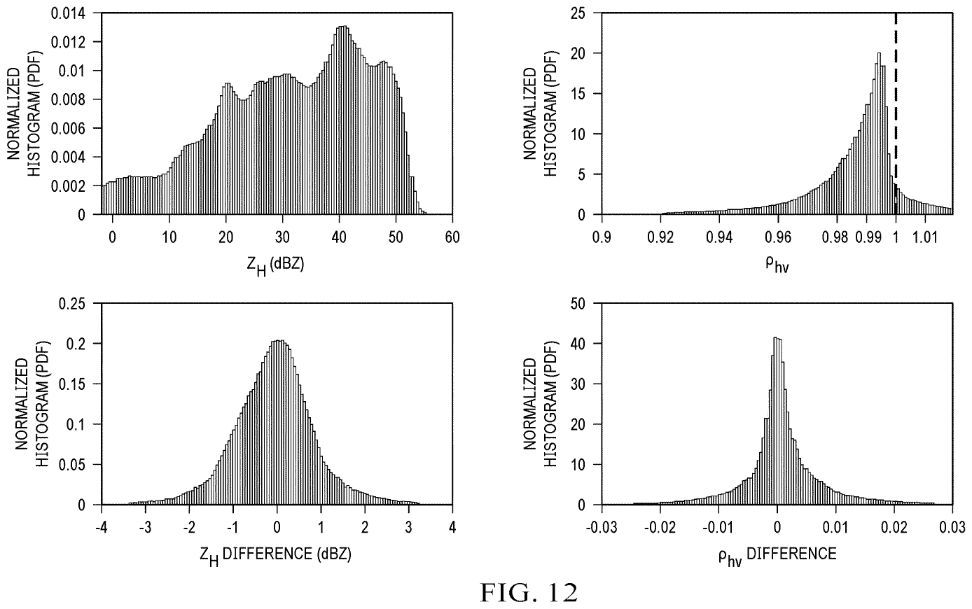

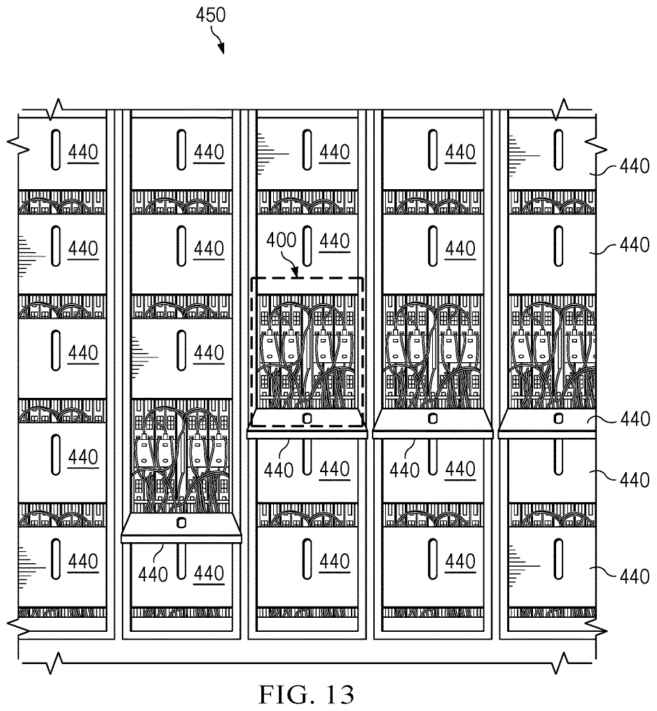

FIG. 12 shows histogram graphs which quantify the quality of polarimetric data gathered by PAR system 110. The top-left histogram shows Zₕ values. The top-right histogram shows ρₕᵥ values. The bottom-left histogram shows differences between Zn fields. The bottom-right histogram shows differences ρₕᵥ between fields.

A qualitative analysis of the top-left histogram of FIG. 12 shows that measured reflectivity values were between approximately −2 dBZ up to 55 dBZ. The top-left histogram looks smooth reflecting the expected dependence of returns from precipitation systems, which usually do not have sharp gradients. The top-right histogram shows that most values are concentrated between about 0.97 and 1, with a peak at approximately 0.994. This is a key indicator of the quality of polarimetric calibration and beam matching and indicates that PAR system 110 can measure the correlation coefficient of raindrops with accuracy exceeding the requirements. The top-left histogram and the top-right histogram were computed using data from the first 60 scans lasting approximately 4 minutes and include 10 million points. Data censoring was applied using SNR thresholds of 5 dB for Zₕ and 15 dB for ρₕᵥ to reduce the impact of measurement noise on polarimetric-variable estimators. The bottom-left histogram and the bottom-right histogram were derived using the first ten scans, whereby the weather data from the first five scans were averaged and subtracted from averaged weather data from the latter five scans. Data censoring was applied using an SNR threshold of 15 dB. The bottom-left histogram and the bottom-right histogram have an approximate zero-mean Gaussian distribution, which is expected, and have relatively narrow standard deviations. The standard deviation of the bottom-left histogram is 0.7824 dBZ, and the standard deviation for the bottom-right histogram is 0.0057. The standard deviations are within the NOAA/NWS functional requirements for the future operational U.S. weather radar, which are 1 dBZ for Zₕ and 0.006 dBZ for ρₕᵥ.

### VII. CONCLUSIONS

### A. Perspective on the Fully-Digital PAR System

This disclosure conveys the usefulness of fully-digital PARs in general and for weather observations in particular. The high temporal resolution afforded by phased arrays is necessary to unravel processes in severe storms, tornadoes, and other high-impact events. In addition to rapid beam steering, fully-digital arrays are highly agile in terms of angular sampling and general beam shaping. For example, these sophisticated radars have the potential of creating adaptive nulls on receive with unprecedented degrees of freedom for interference and clutter mitigation. This is particularly important for moving clutter such as that caused by wind turbines. Fully-digital arrays are uniquely designed as software-defined radars and therefore minimize obsolescence concerns with the ability to reconfigure the array for future and yet-to-be-defined missions. This quality of being “future-proof” will reap a significant reduction of overall operation and maintenance costs over the lifetime of these sophisticated instruments. Although a digital-at-every-element architecture offers extreme flexibility, there is significant power consumption of ADCs at every element, a significant amount of digital data that needs to be routed, the need to carefully maintain clock synchronization at each data converter, and a high cost that is sometimes mitigated by subarraying.

Shown herein is a fully-digital PAR system. For weather observations, the is a strict requirement for polarimetric quality to be similar to the WSR-88D dish-based weather radars operated by the NWS. It is well understood that the combination of radar polarimetry with phased arrays has arguably been the most difficult challenge presented by the technology. Fortunately, the PAR system disclosed herein has been shown to meet this challenge through advanced mutual-coupling-based calibration methods, which are unique to fully-digital arrays. For the first time ever, fully-digital phased array weather radar data were obtained when PAR system 110 was deployed near Norman, OK. In addition to general weather observations, the presently disclosed PAR system can be used to conduct observations of a variety of weather conditions including winter precipitation and deep convection in the spring storm season. Non-weather uses of interest include observations for wind farms, wildfires, space debris, aerial biota, and aircraft. The inherent panel-level scalability of the disclosed PAR technology can be exploited by using a larger array SuperStructure, tower, power source, and so on, a fully-digital, S-band, phased array, thereby creating a weather radar having an angular resolution of ~1°. Such a system will have, for example, about 10,000 radiating elements. Since the total transmit power scales with the array size, the sensitivity of the system would rival that of the WSR-88D radar, but with all the advantages of the fully-digital PAR system disclosed herein.

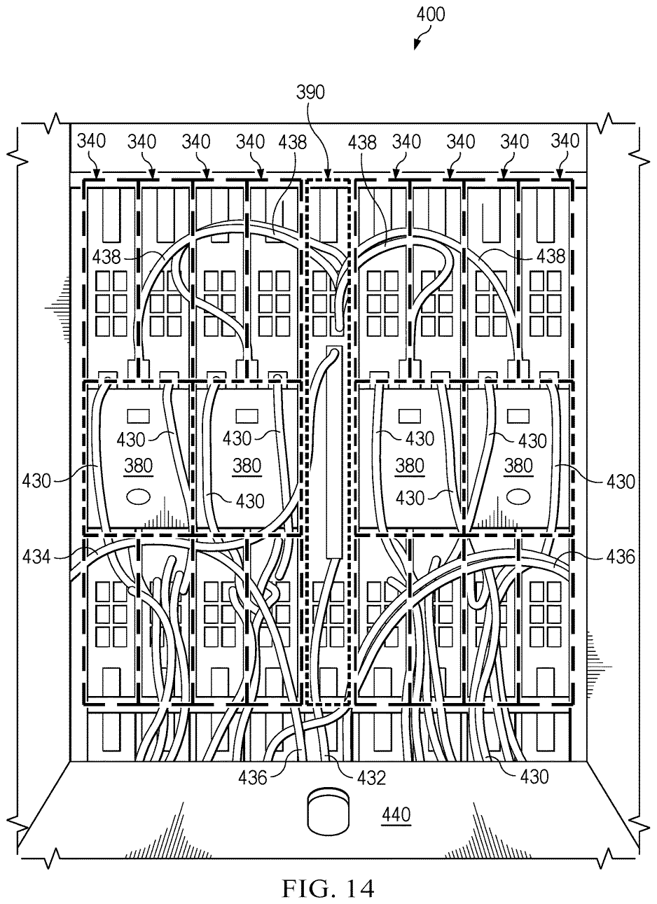

Returning now to the figures, FIG. 14A shows a rear perspective view of the 25 array panel assemblies 400 of the radar array 450 of the PAR system 110. The rear sides of the 25 array panel assemblies 400 in the 5×5 arrangement are shown. The network shelf subassemblies 440 of four of the array panel assemblies 400 have been lowered to show the inner components of the four array panel assemblies 400.

FIG. 14B shows a view of one array panel assembly 400 of FIG. 14A which has been enlarged to show the subcomponents which include the various components schematically represented in the component block diagram 300 of FIG. 3, including eight TRP assemblies 340, two digital bridging subassemblies 380, and a supervisory assembly 390. The array panel assembly 400 may be configured to contain any number and arrangement of the TRP assemblies 340, digital bridging subassemblies 380, and supervisory assemblies 390 that are required for suitable operation of the PAR system 110. Also shown are various cables which interconnect the various components of the array panel assembly 400 with the backend assembly 140. TRP assembly network cables 430 interconnect each TRP assembly 340 with the supervisory assembly 390. Supervisory network cables 432 and array panel synchronization cable 434 interconnects the supervisory assembly 390 to the backend assembly 140. Array panel network cables 436 interconnect the network shelf subassembly 440 with the backend assembly 140. Digital bridging assembly synchronization/control cables 438 connect each digital bridging subassembly 380 with the supervisory assembly 390. In certain non-limiting embodiments, the synchronization/control cables 438 are the only cables coupling the supervisory assembly 390 to the digital bridging subassemblies 380. The supervisory assembly 390, TRP assemblies 340, and the digital bridging subassemblies 380 are modular and independently removable and replaceable. As explained previously, each array panel assembly 400 is electrically and mechanically scalable.

Returning now to the figures, FIG. 14A shows a rear perspective view of the 25 array panel assemblies 400 of the radar array 450 of the PAR system 110. The rear sides of the 25 array panel assemblies 400 in the 5×5 arrangement are shown. The network shelf subassemblies 440 of four of the array panel assemblies 400 have been opened to show the inner components of the four panel assemblies 400.

FIG. 14B shows a view of one array panel assembly 400 of FIG. 14A which has been enlarged to show the subcomponents which include the various components schematically represented in the component block diagram 300 of FIG. 3, including eight TRP assemblies 340, two digital bridging subassemblies 380, and a supervisory assembly 390. The array panel assembly 400 may be configured to contain any number and arrangement of the TRP assemblies 340, digital bridging subassemblies 380, and supervisory assemblies 390 that are required for suitable operation of the PAR system 110. Also shown are various cables which interconnect the various components of the array panel assembly 400 with the backend assembly 140. TRP assembly network cables 430 interconnect each TRP assembly 340 with the supervisory assembly 390. Supervisory network cables 432 and array panel synchronization cable 434 interconnects the supervisory assembly 390 to the backend assembly 140.

Digital bridging assembly synchronization/control cables 438 connect each digital bridging subassembly 380 with the supervisory assembly 390. In certain non-limiting embodiments, the synchronization/control cables 438 are the only cables coupling the supervisory assembly 390 to the digital bridging subassemblies 380. The supervisory assembly 390, TRP assemblies 340, and the digital bridging subassemblies 380 are modular and independently removable and replaceable. As explained previously, each array panel assembly 400 is electrically and mechanically scalable.

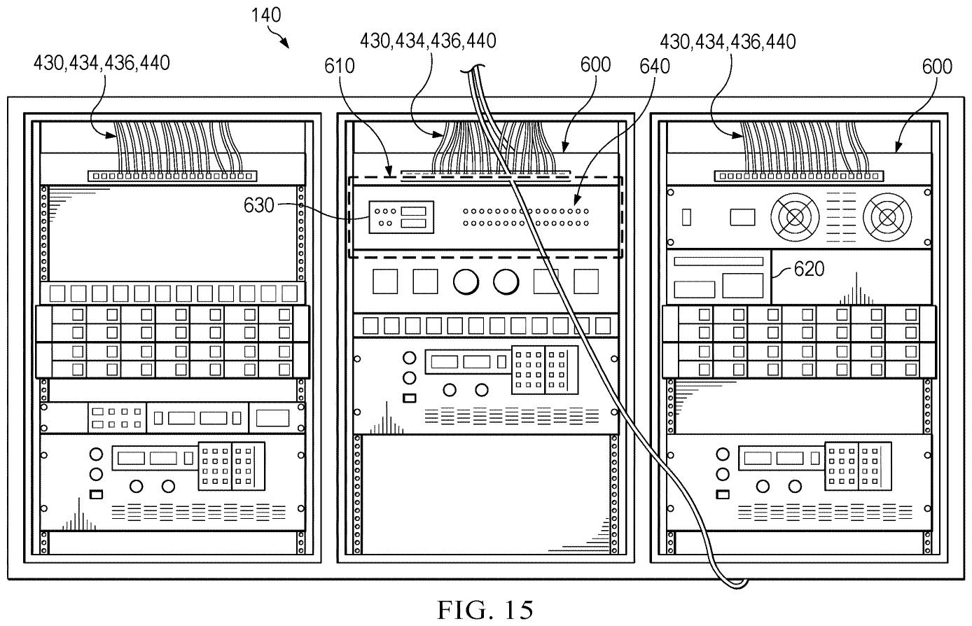

FIG. 15 is a frontal view of the interior of the backend assembly 140 in FIG. 1 with a cover or covers removed for visibility. The backend assembly 140 comprises the origin of the network cables 430, 432, 436, and 440 and the synchronization cables 434 and 438, a network switch 600, a synchronization subsystem 610, and a clock generator 620. In one embodiment, the network cables 430, 432, 436, and 440 connect the network switch 600 to the rest of the backend assembly. Alternatively, a single network switch cable couples the backend assembly 140 to the network switch 600. The synchronization subsystem 610 may also be referred to as a synchronization subassembly. The synchronization subsystem 610 comprises a GPS module 630 and a synchronization board 640. The clock generator 620 may also be referred to herein as a timing device.

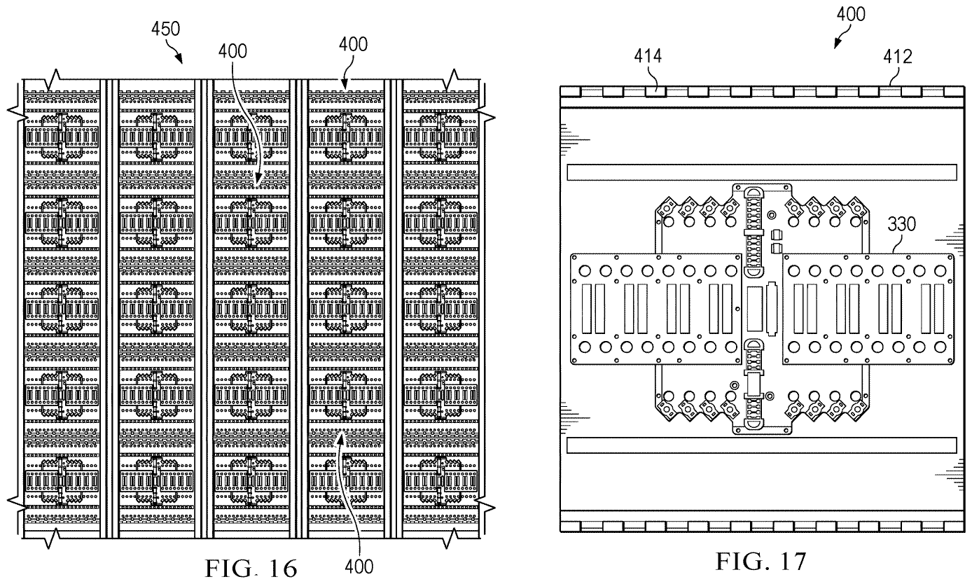

FIG. 16 shows a rear view of the back of the radar array 450 in FIG. 14 after the array panel back covers 460, TRP assemblies 340, digital bridging subassemblies 380, and supervisory assemblies 390 of each array panel assembly 400 have been removed to enable visibility of the rear-most components of the array panel assembly 400. In FIG. 17, a single array panel assembly 400 of the radar array 450 of FIG. 16 has been enlarged to show the back of the card cage 412 and the power backplane 330 (a.k.a. “passive power backplane” or “analog bridge”). The card cage 412 comprises 9 card guides 414, in this non-limiting embodiment.

FIG. 18 shows (left) a frontal view of the radar array 450 of FIG. 4C with all 1600 radiating elements 320 of the 25 array panel assemblies 400 shown. A single array panel assembly 400 has been enlarged (center) to show the 64 radiating elements 310 of eight antenna subpanels 316 on one antenna panel 320 in greater detail. A single antenna panel 320 is shown within the dashed-lined box. A single radiating element 310 has been enlarged (right) to indicate an H component 312 and a V component 314 of the radiating element 310. In the embodiment shown, adjacent array panel assemblies 400 are separated by less than about 0.05 cm to about 5 cm. The radiating elements 310 are operably connected to corresponding TRP assemblies 340 via antenna ports 465 which extend through the ground plane 430 (FIG. 4D). There is substantially equal spacing between adjacent radiating elements 310 within the array panel assembly 400, where “adjacent” means immediately left, right, above, or below. There is equal spacing between the radiating elements 310 at the perimeter of one array panel assembly 400 and the radiating elements 310 at the perimeters of the adjacent array panel assemblies 400. The spacing is less than about. 05 cm to about 5 cm. Each antenna panel 320 is passive and removable from the array panel assembly 400. Likewise, the antenna ports 465 are passive.

FIG. 19A-19B are vertical rear and front perspective views, respectively, of a TRP assembly 340 as shown in FIG. 4A except it is shown as covered by a pair of lids 342 that cover and protect the RF boards 350 and digital boards 360 (see FIG. 4A). As shown in FIG. 4A, 16 connectors 365 extend outwardly to operably engage the antenna ports 465 of the radiating elements 310 of the corresponding antenna panel 320. As explained previously, the TRP assembly 340 is electrically and mechanically symmetric so that it can engage the array frame 410 and the corresponding antenna panel 320 in either a first orientation (topside-up, bottomside-down) or a second orientation (topside-down, bottomside-up) and still maintain complete functionality. In this manner, when the TRP assembly 340 is rotated 180° to the topside-down/bottomside-up orientation along an axis A, as indicated in FIGS. 19A-19B, complete functionality of the TRP assembly 340 is maintained. The TRP assembly 340 is configured to transmit independent transmission signals to radiating elements 310 via antenna ports 465 in the corresponding antenna panel 320; receive independent reception signals from the radiating elements 310 via antenna ports 465 in the antenna panel 320; process and sample the independent reception signals; and maintain complete functionality when disconnected from the antenna ports 465 in the antenna panel 320, rotated 180°, and reconnected to the antenna ports 465 in the antenna panel 320.

FIG. 20A is a horizontal rear perspective diagram of the TRP assembly 340 in FIG. 18. The TRP assembly 340 comprises a heat transfer/support plate 395, an RF board/digital board pair 360 mounted on each side of the heat transfer/support plate 395, and TRP assembly cover 342 removably mounted over each of the RF board/digital board pairs 360. Each of the RF board/digital board pairs 360 are attachable to and detachable from the antenna ports 465 of the antenna panel 320 to maintain complete functionality in a first orientation or a second orientation in the manner previously described (see FIGS. 19A-19B). The circuitry of each RF board/digital board pair 360 is substantially identical. Thus, either one of the RF board/digital board pair 360 is able to connect to and support either the H component 312 or the V component 314. Each of the of the RF board/digital boards of the RF board/digital board pair 360 is responsible through its respective circuitry for conversion between RF analog signals and digital signals and for digital signal processing. The circuitry of first RF board/digital board of the RF board/digital board pair 360 and the circuitry of second RF board/digital board of the RF board/digital board pair 360 are physically separated such that parasitic couplings between the circuitries are minimized. The heat transfer/support plate 395 may also be referred herein to as a cold plate, an HTD, or a support plate. FIG. 20B is an exploded diagram of the TRP assembly 340 of FIG. 20A.

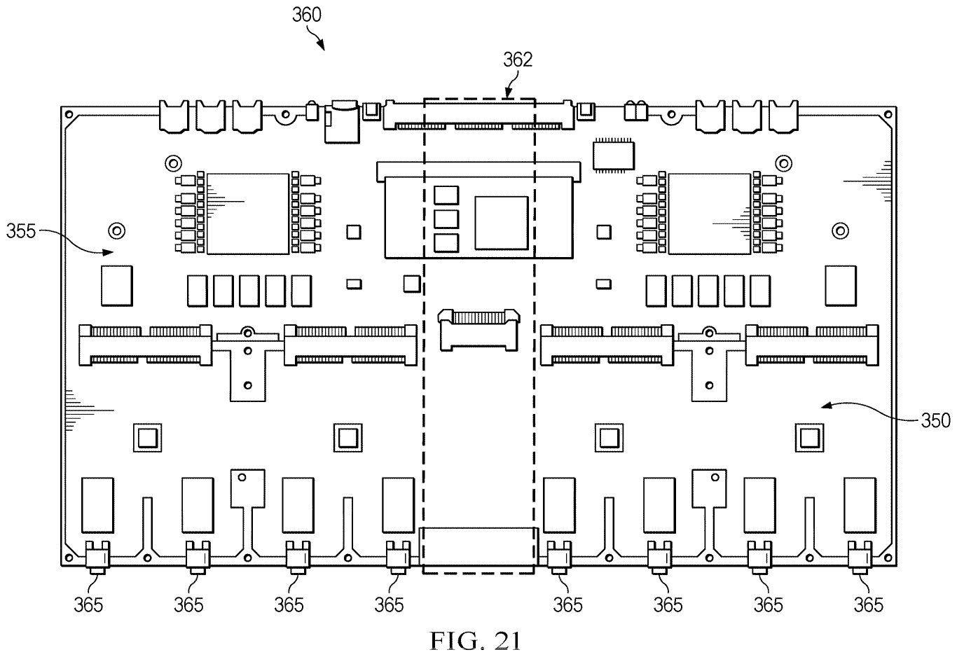

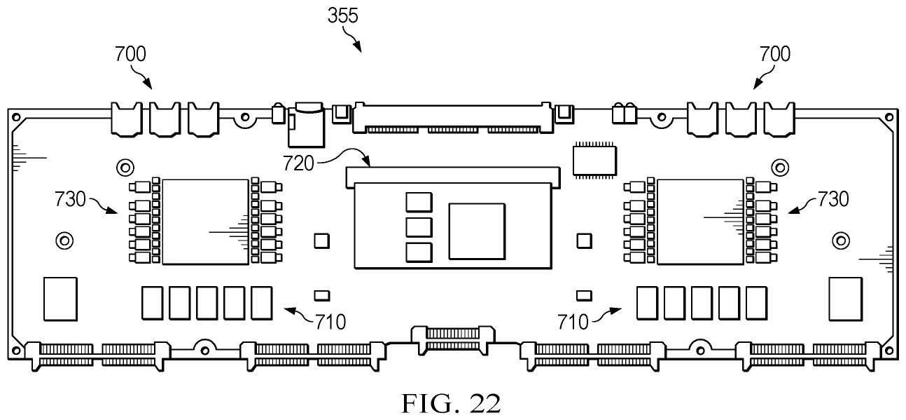

FIG. 21 is a top plan view of an RF board/digital board pair 360. The RF board/digital board pair 360 comprises a digital board 355, a power spine 362, and an RF board 350. Each RF board 350 comprises 8 connectors 365, each of which is constructed to engage a corresponding 8 (i.e., half) of the antenna ports 465 of a corresponding antenna panel 320. FIG. 22 is a top plan view of the digital board 355 of FIG. 21. The digital board 355 comprises cable ports 700, memories 710, a controller 720, and processing units 730. The cable ports 700 accept cables that couple the processing units 730. The memories 710 store hard-coded parameters. The controller 720 may be, for example, an SoM. The SOM may comprise an FPGA, and the FPGA may comprise an integrated processor configured to run an operating system. The controller 720 is disposed at or near a center point of the digital board 355 and is configured to monitor performance of a TRP assembly 340 in a non-deterministic manner, power on and power off with the TRP assembly 340, receive commands from the supervisory assembly 390, and execute the commands. The non-deterministic manner means at a time that is not based on a synchronization signal of the PAR system 110. The controller 720 and the processing units 730 comprise counters and registers. The processing units 730 may be FPGAs. The processing units 730 are disposed symmetrically with respect to the center point of the digital board 355 and are configured to perform beamforming in a deterministic manner and a dedicated manner, power on and power off in response to instructions from the controller 720, operate independently of each other, not share processing resources with each other, and provide a high throughput of over about 10 Gb/s. The deterministic manner means automatically at a specified time based on a synchronization signal of the PAR system 110.

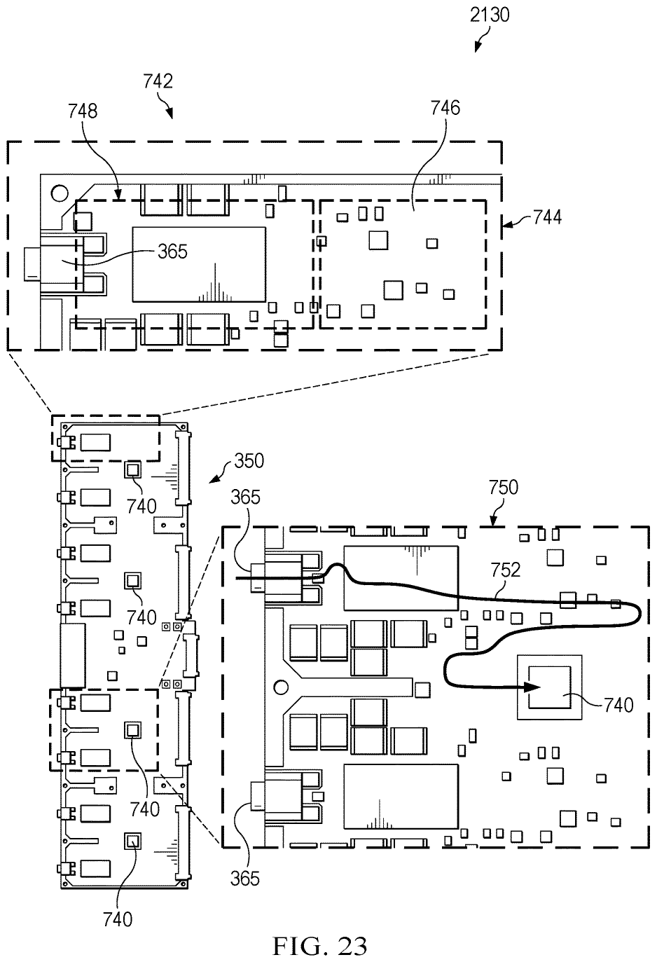

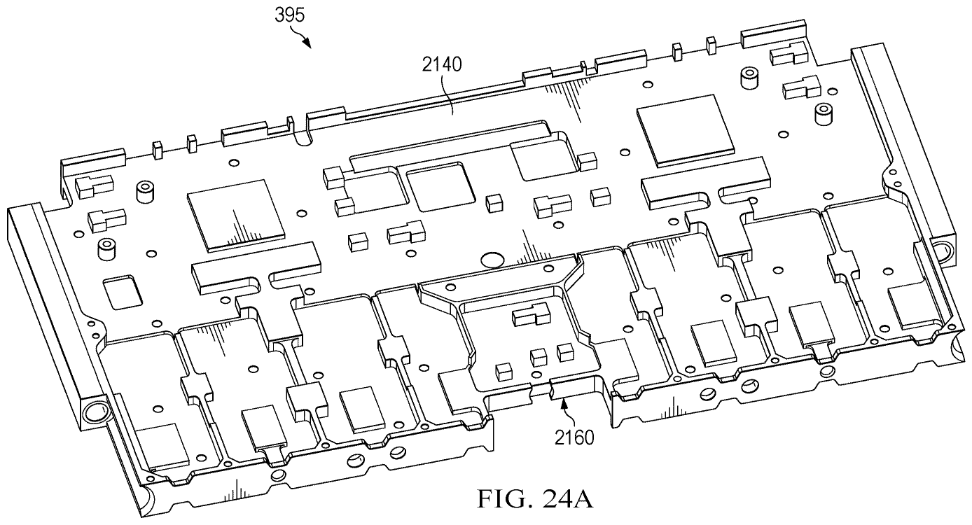

FIG. 23 provides top plan views of the RF board 350 in FIG. 21 in further detail. The RF board 350 in the lower left recapitulates the RF board 350 in FIG. 21, including 4 transceivers 740. A first magnified portion 742 of the RF board 350 shows a channel 744 which comprises mid-layers 746 and RFEs 748. A second magnified portion 750 shows that each of the connectors 365 has a reception path 752 to a respective transceiver 740.

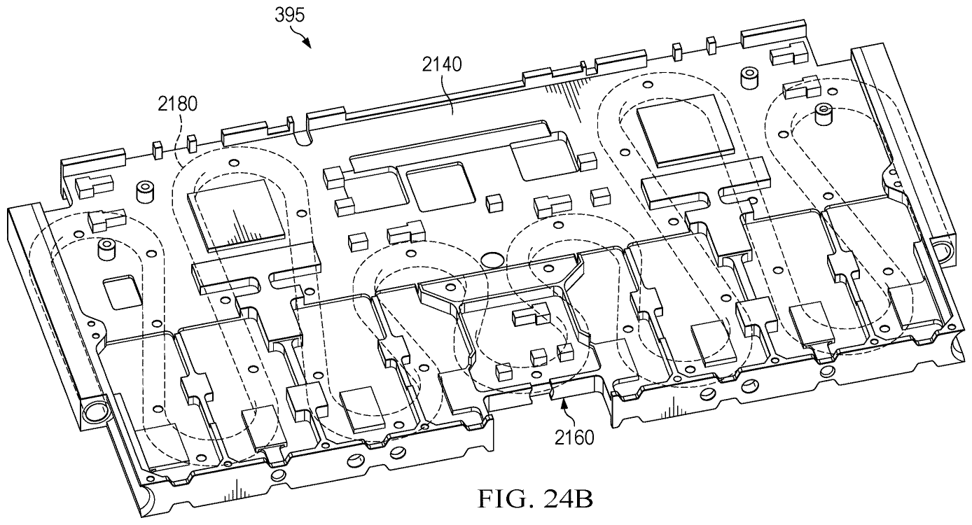

FIG. 24A is a diagram of the heat transfer/support plate 395 in FIGS. 20A and 20B. FIG. 24A shows that the heat transfer/support plate 395 comprises a first side 2140 and a second side 2160 opposite the first side 2140. FIG. 24B shows an optional, non-limiting, embodiment of the heat transfer/support plate 395 which comprises a serpentine cooling path 2180. FIG. 24B shows the serpentine cooling path 2180 in phantom. In this embodiment, the heat transfer/support plate 395 is configured to remove heat from the RF board/digital board pair 360 and transfer heat to a cooling fluid distributed within the array frame 410 that flows through the serpentine cooling path 2180. The RF board/digital board pair 360 is attached to the first side 2140 and the second side 2160. The serpentine cooling path 2180 may be referred to a conduit.

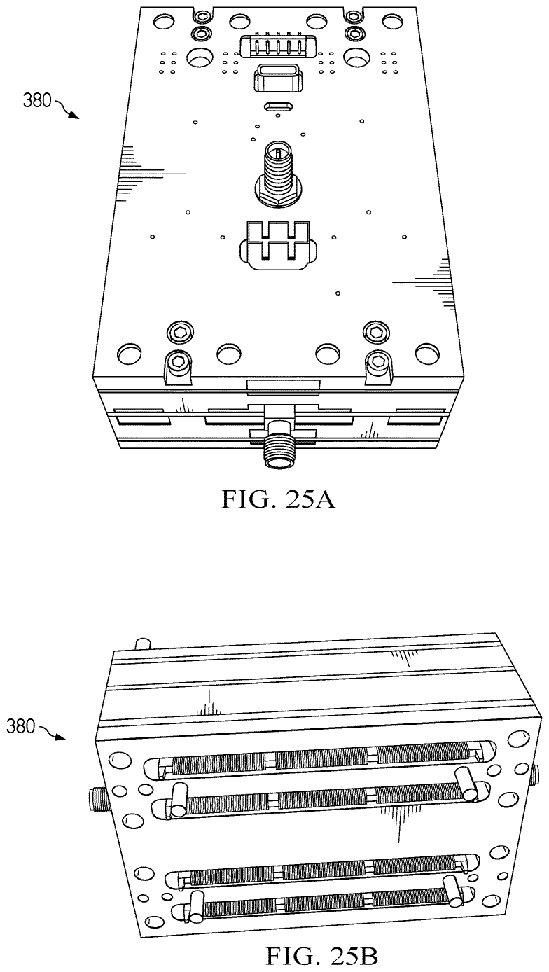

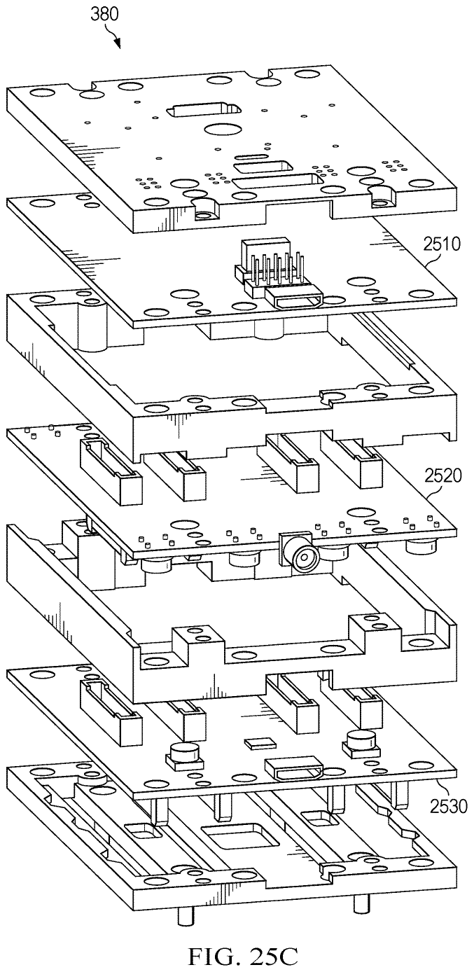

FIG. 25A shows a top perspective view of the digital bridging subassembly 380 shown in FIG. 14B. FIG. 25B shows a bottom perspective view of the digital bridging assembly 380 of FIG. 25A. FIG. 25C is an exploded diagram of the digital bridging assembly 380. FIG. 25C shows that the digital bridging assembly 380 comprises a debugging and control board 2510, an LO distribution board 2520, and a primary synchronization board 2530. The digital bridging assembly 380 is configured to receive the synchronization signals, the control signals, and the supervisory signals from the supervisory assembly 390 and is configured to distribute the synchronization signals, the control signals, and the supervisory signals to a pair of TRP assemblies 340.

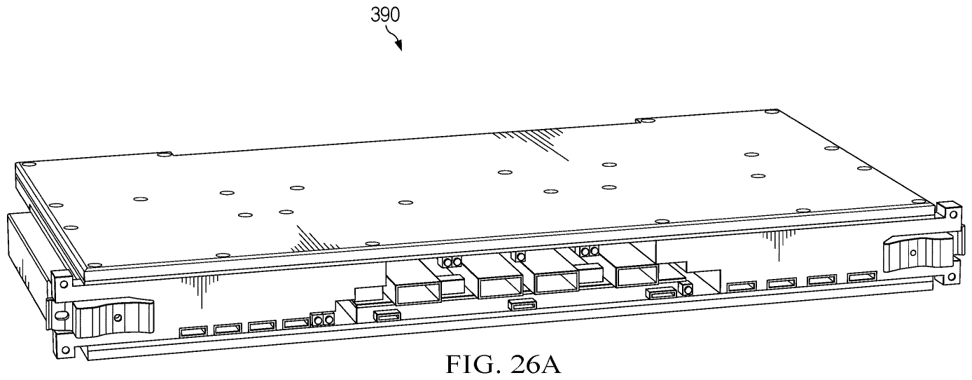

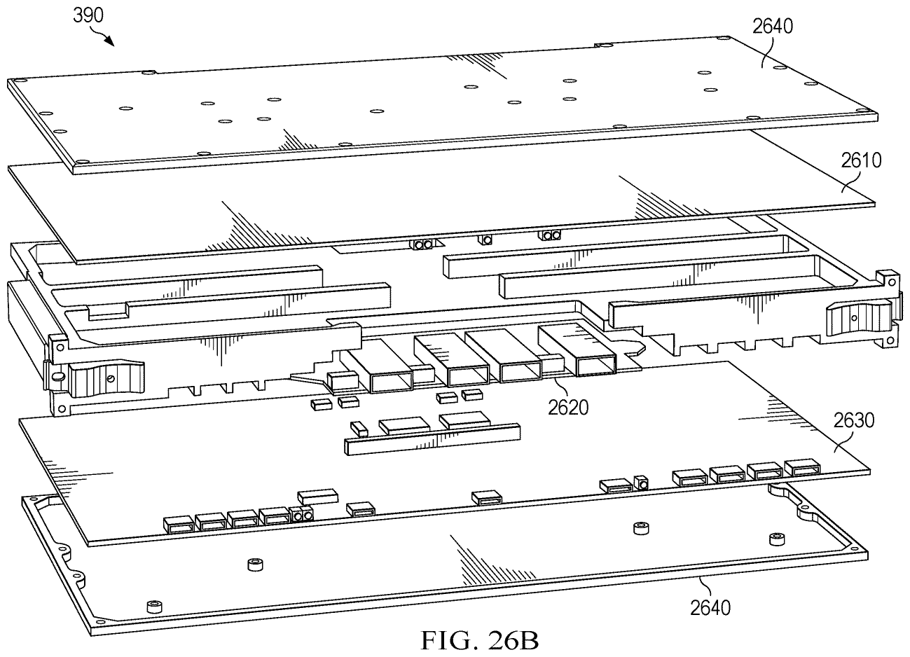

FIG. 26A is a diagram of the supervisory assembly 390 in FIG. 14B. FIG. 26B is an exploded view of the supervisory assembly 390 in FIG. 26A. FIG. 26B shows that the supervisory assembly 390 comprises a power board 2610, a fiber board 2620, a control board 2630, and covers 2640. The supervisory assembly 390 is configured to receive a high-voltage, low-current power; convert the high-voltage, low-current power into a low-voltage, high-current power; distribute the low-voltage, high-current power to the power backplane 330 for providing high-current power to the TRP assemblies 340; supervise the TRP assemblies 340; and distribute synchronization signals, control signals, and supervisory signals to the TRP assemblies 340. The supervisory assembly 390 comprises conduits for conducting a cooling fluid therein. The supervisory assembly 390 comprises at least one heat conducting element configured to be in contact with the cooling fluid in the array frame 410.

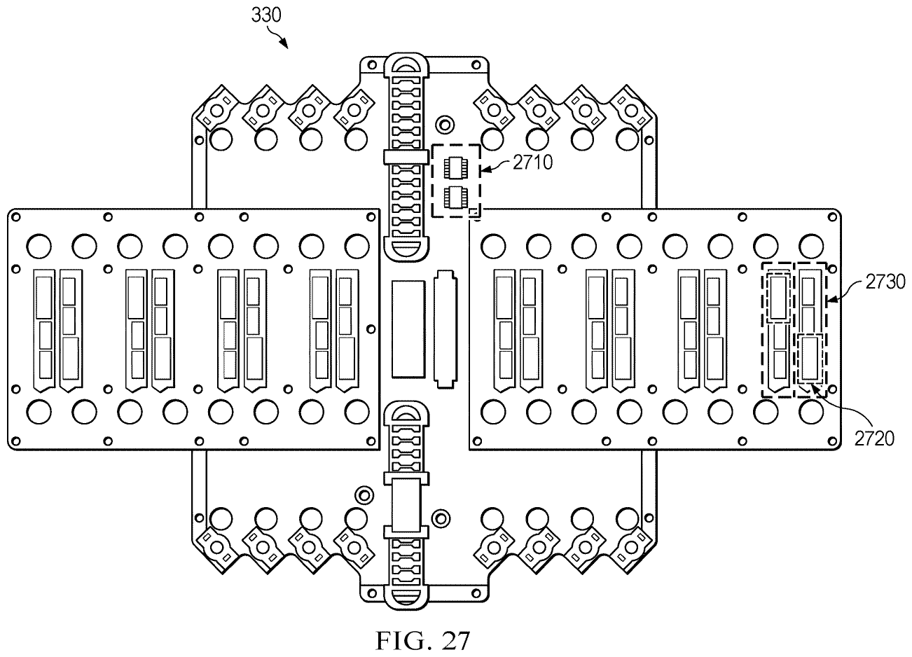

FIG. 27 is a top plan view of the power backplane 330 shown in FIG. 17. The power backplane 330 comprises DIP switches 2710, pin sets 2720, and slots 2730. The power backplane 330 1620 is connected to a back surface of the card cage 412, or other suitable surface., and is configured to receive power from the supervisory assembly 390 without using cables, and configured to distribute the power to the TRP assemblies 340 without using cables.

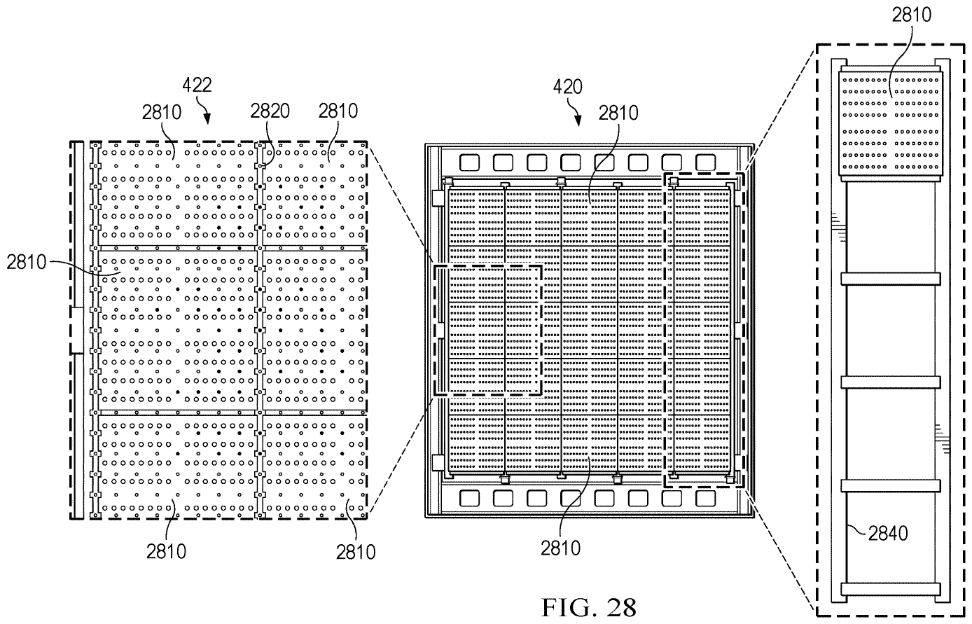

FIG. 28 comprises plan views of the ground plane 422 in FIG. 4D. A view of the entire ground plane 422 supported on the superstructure 420 is shown in the center. The ground plane 422 is modular, mounts and secures the power backplane 330 (not shown), and is configured to reflect radio waves. A first magnified view (left) shows several ground plane modules 2810. The ground plane 422 is formed by 25 such ground plane modules 2810, all of which are substantially identical. Each ground plane module 2810 comprises seams 2820 that connect adjacent ground plane modules 2810. A second magnified view (right) focuses on a single ground plane module 2810 which is mounted upon an array frame module 2840 from the array frame 410 in FIG. 4B. Though the array frame module 2840 is shown as mounting only one ground plane module 2810, the array frame module 2840 is configured to mount 5 ground plane modules 2810. The array frame module 2840 is ladder shaped. The array frame 410 is formed by the array frame module 2840 and 4 other substantially identical array frame modules 2840, all of which directly coupled to form the single array frame 410. Though the ground plane 422 is described as being formed by 25 ground plane modules 2810 and the array frame 410 is described as being formed by 5 array frame modules 2840, the modular nature of the ground plane modules 2810 and the array frame modules 2840 allow for the ground plane 422 to have any suitable number of the ground plane modules 2810, and the array frame 410 to have any suitable number of the array frame modules 2840 in accordance with description and embodiments shown elsewhere herein.

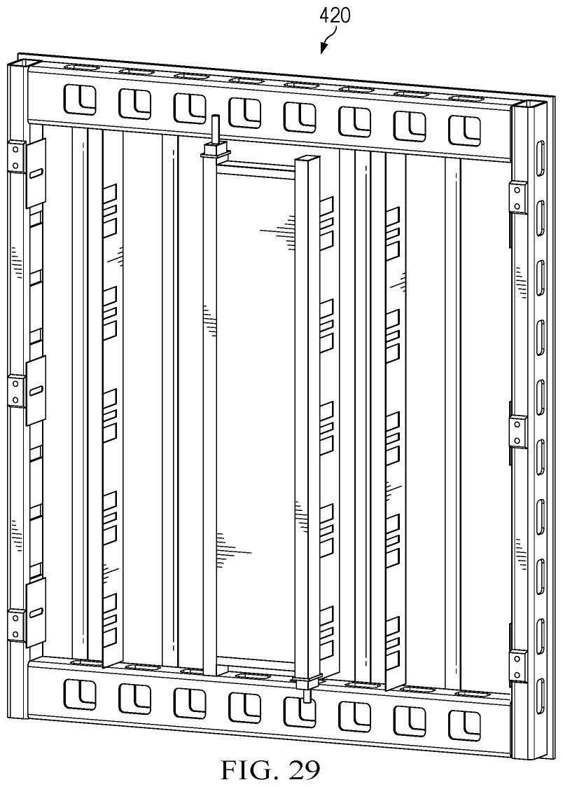

FIG. 29 is a diagram of the superstructure 420 in FIG. 4C in further detail. The superstructure 420 mounts and supports the array frame 410, which in turn mounts the array panel assemblies 400. Specifically, the array frame 410 supports the array panel assemblies 400, the supervisory assembly 390, the TRP assemblies 340, and the digital bridging subassemblies 380.

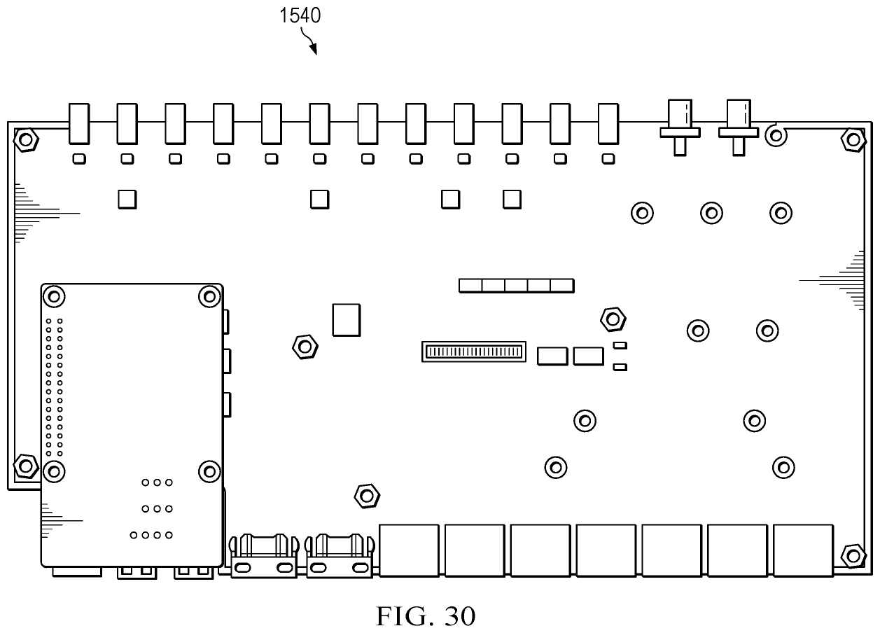

FIG. 30 is a photograph of the synchronization board 640 of the synchronization subsystem 610 in FIG. 15. The synchronization board 640 is configured to distribute reference clock signals to synchronization points. The synchronization points may be the supervisory assemblies 390, the TRP assemblies 340, and other components of the PAR system 110.

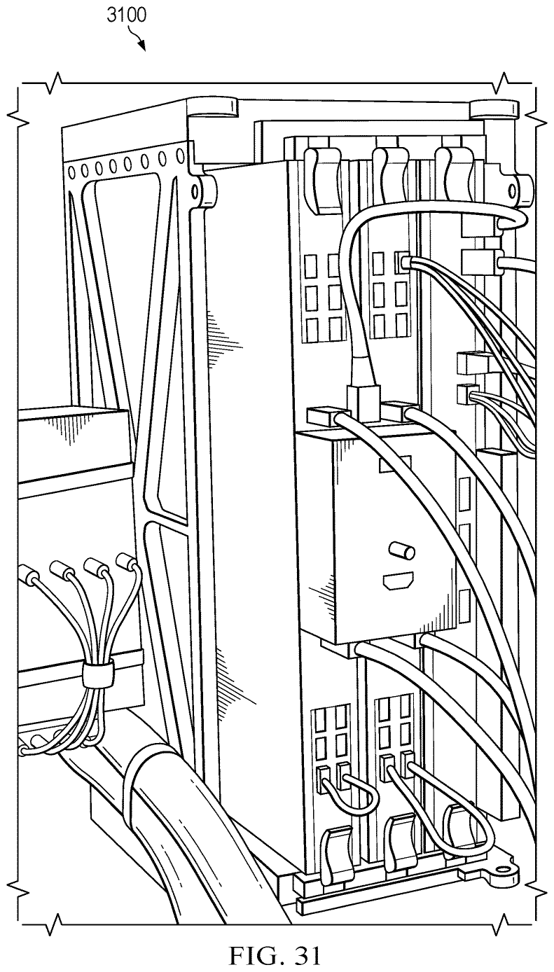

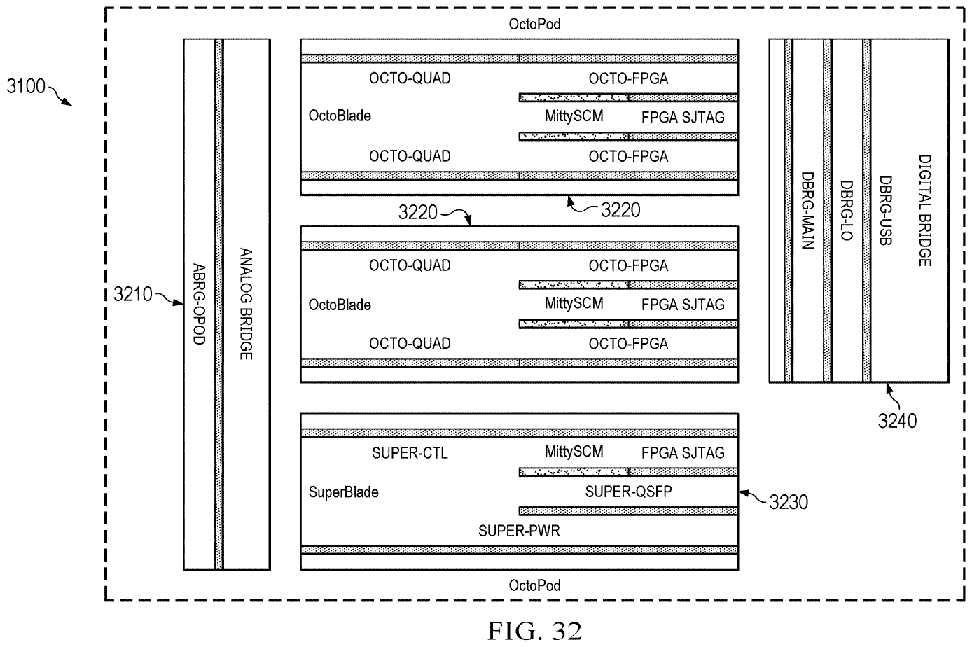

FIG. 31 is a photograph of a dual TRP assembly module 3100 which comprises a pair of TRP assemblies 340, a supervisory assembly 390, a digital bridging subassembly 380, and a power backplane submodule 332. FIG. 32 is a logical diagram of the dual TRP assembly module 3100 in FIG. 31 and diagrammatically shows the pair of TRP assemblies 340, a supervisory assembly 390, a digital bridging subassembly 380, and a power backplane submodule 332. The dual TRP assembly module 3100 can be used alone for communicating and processing radar signals.

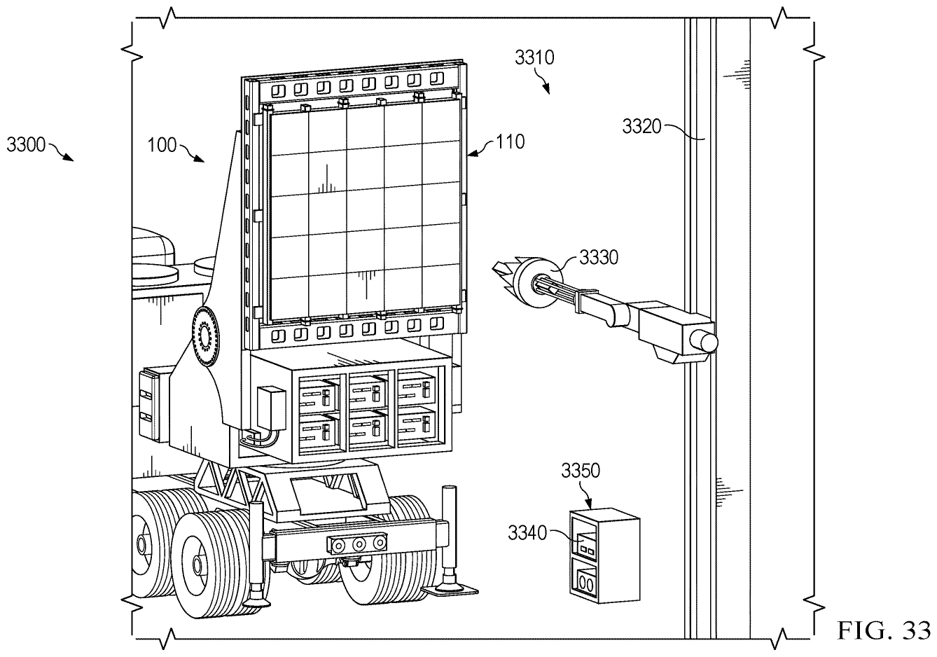

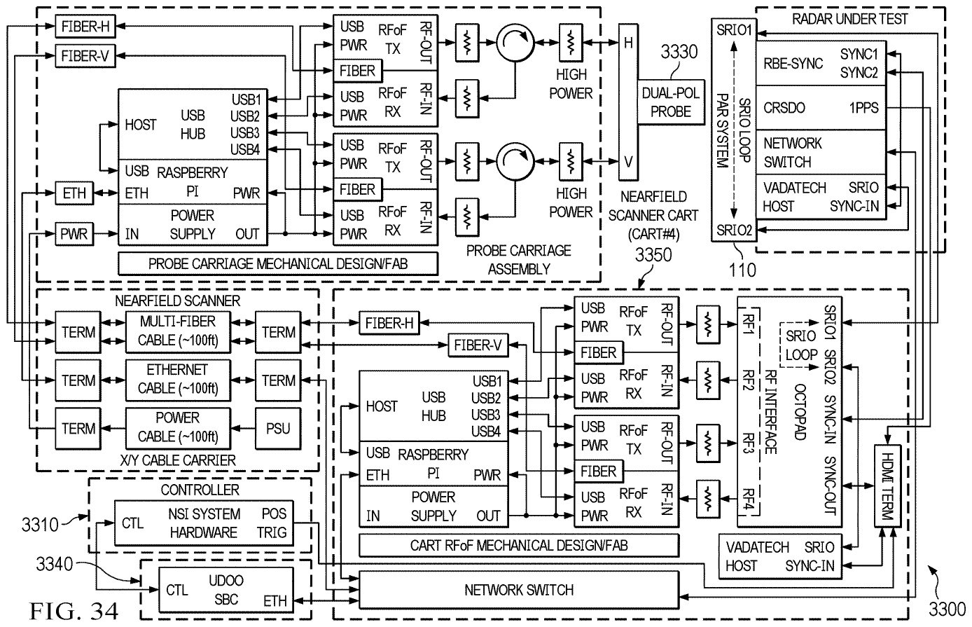

FIG. 33 is a perspective view of a radar testing system 3300. FIG. 34 is a logical diagram of the radar testing system 3300 in FIG. 33. The testing system 3300 comprises a mobile radar system 100 with a PAR system 110, a near-field scanner 3310, a mechanical controller 3340, and a testing PAR system 3350. The near-field scanner 3310 may also be referred to as a scanner. The near-field scanner 3310 comprises an x-y positioner 3320 and a probe 3330. The probe 3330 may also be referred to as an RF probe.

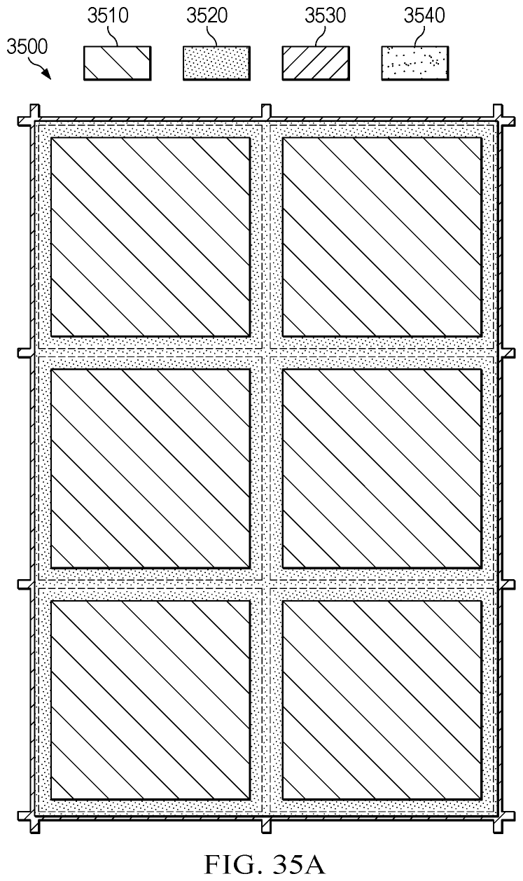

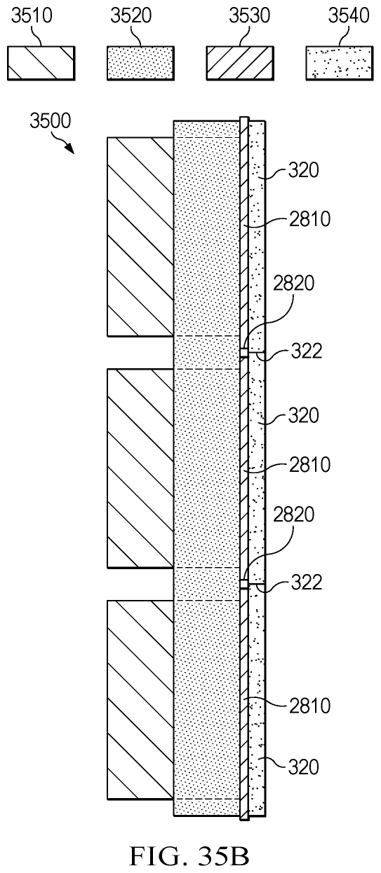

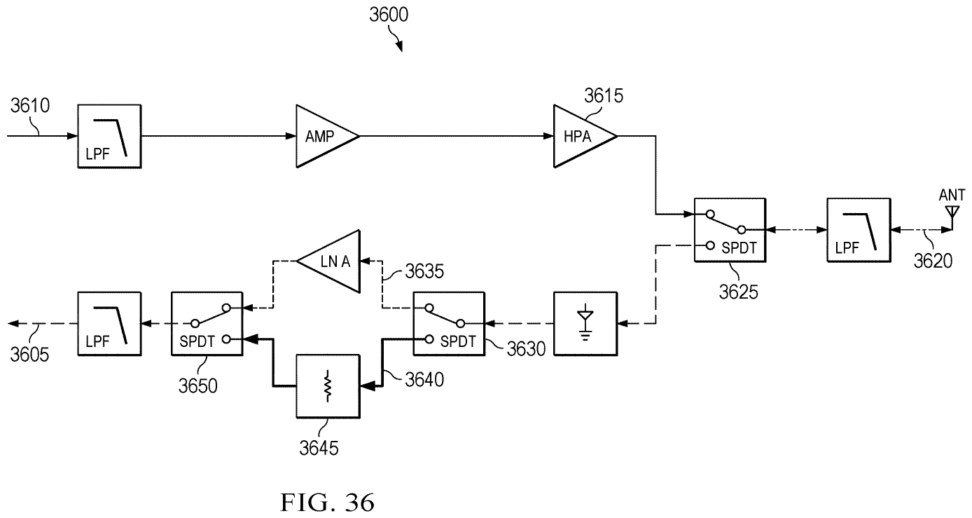

FIG. 35A is a front view of a simplified schematic diagram of a portion 3500 of the PAR system 110 of FIG. 1. FIG. 35B is a side view of the portion 3500 in FIG. 35A. The portion 3500 comprises electronics 3510, a portion 3520 of the array frame 410, a portion 3530 of the ground plane 422 which comprises a subset of the ground plane modules 2810, and a subset 3540 of the antenna panels 320. The electronics 3510 comprise the power backplane 330, the supervisory assemblies 390, the TRP assemblies 340, the digital bridging subassemblies 380, and cables of the array panel assembly 400. The antenna panel 320 comprises edges 322 which overlap the seams 2820 of the ground plane modules 2810, thereby forming an electrically continuous ground plane 422. The edges 3222 and the seams 2820 may do so without gaskets or EMI treatment.

As can be seen in FIGS. 35A and 35B, each antenna panel 320 has a first footprint defined by the antenna panel edges 322 of the antenna panel 320 (refer to FIG. 18A) which together provide an outer perimeter. The first footprint is substantially rectangular or substantially square. The antenna panel 320 corresponding to the first footprint can be divided into a first portion and a second portion. The first portion is configured to provide mounting of and liquid cooling to the array panel assembly 400, for instance, via the array frame 3520. The electronics 3510 are configured to generate and communicate radar signals. The electronics 3510 have a second footprint defined by the outer perimeter of the electronics 3510. The second footprint is substantially rectangular or substantially square. The first footprint is larger than the second footprint. For instance, the first footprint is about 16 inches×16 inches, and the second footprint is about 14 inches×14 inches. A first difference between the first footprint and the second footprint defines the first portion. Other antenna panels 320 and their corresponding array panel assemblies 400 have about the same first footprint, and other electronics 3510 have about the same second footprint.

FIG. 36 is a schematic diagram of an RFE 3600 according to a first embodiment. The RFE 3600 may implement the RFE 748 in FIG. 23. The RFE 3600 comprises a transmission path 3610, a transmission/reception path 3620, and a reception path 3605. The transmission path 3610 comprises an HPA 3615. The transmission/reception path 3620 comprises a switch 3625. The reception path 3605 comprises a high-gain path 3635 and a low-gain path 3640. The high-gain path 3635 may also be referred to as an amplification branch. The low-gain path 3640 may also be referred to as an attenuation branch. The low-gain path 3640 is a linear path configured to pass high-power signals. The low-gain path 3640 comprises a switch 3630, an attenuator 3645, and a switch 3650. The switches 3625, 3630, and 3650 may instead be circulators.

The processing units 730 in the digital board 355 of the TRP assembly 340 are configured to cause the TRP assembly 340 to selectively switch between the high-gain path 3635 and the low-gain path 3640 based on an instruction from the controller 150. Specifically, in a first example, the transmission/reception path 3620 and the reception path 3605 are associated with a second antenna and are configured to receive portions of first radar signals from first antennas based on mutual coupling between the second antenna and the first antennas. The RFE 3600 is configured to pass the portions along the low-gain path 3640. In a second example, the second antenna is configured to receive a second radar signal from a source external to the PAR system 110. The RFE 3600 is configured to pass the second radar signal along the high-gain path 3635.

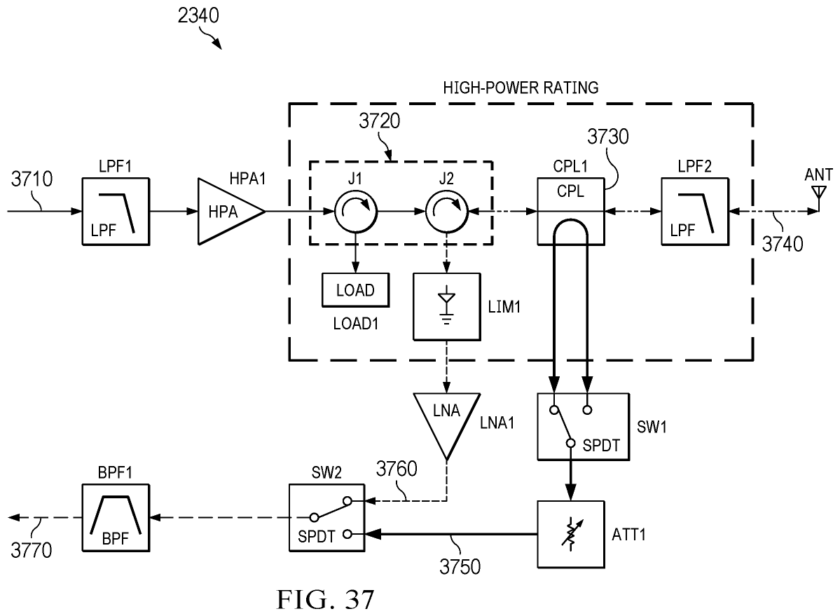

FIG. 37 is a schematic diagram of an RFE 3700 according to a second embodiment. The RFE 3700 may implement the RFE 748 in FIG. 23. Like the RFE 3600, the RFE 3700 comprises a transmission path 3710, a transmission/reception path 3740, and a reception path 3770. In addition, like the reception path 3605, the reception path 3770 comprises a high-gain path 3760 and a low-gain path 3750. However, unlike the transmission path 3605, the transmission path 3710 comprises a circulator 3720. Unlike the transmission/reception path 3620, the transmission/reception path 3740 comprises a directional coupler 3730.

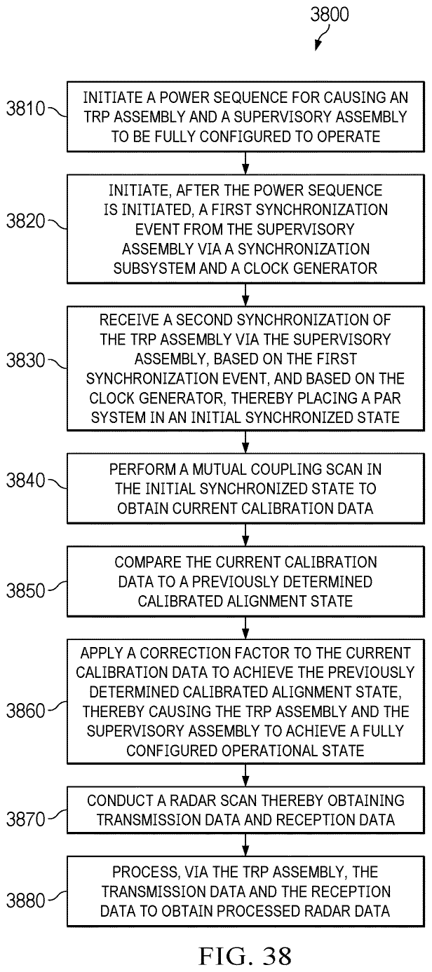

FIG. 38 is a flowchart illustrating a method 3800 of initializing and operating the PAR system 110 in FIG. 1. The controller 150 performs the method 3800. At step 3810, a power sequence is initiated for causing a TRP assembly 340 and a supervisory assembly 390 to be fully configured to operate. At step 3820, after the power sequence is initiated, a first synchronization event is initiated from the supervisory assembly 390 via a synchronization subsystem 610 and a clock generator 620. In this way, the RBE 140 is configured to provide a timing mechanism and synchronization signals to the supervisory assembly 390. At step 3830, a second synchronization of the TRP assembly 340 is received via the supervisory assembly 390, based on the first synchronization event, and based on the clock generator 620, thereby placing the PAR system 110 in an initial synchronized state. At step 3840, a mutual coupling scan is performed in the initial synchronized state to obtain current calibration data. At step 3850, the current calibration data are compared to a previously determined calibrated alignment state. At step 3860, a correction factor is applied to the current calibration data to achieve the previously determined calibrated alignment state, thereby causing the TRP assembly 340 and the supervisory assembly 390 to achieve a fully configured operational state. At step 3870, a radar scan is conducted, thereby obtaining transmission data and reception data. At step 3880, the transmission data and the reception data are processed via the TRP assembly 340 to obtain processed radar data.

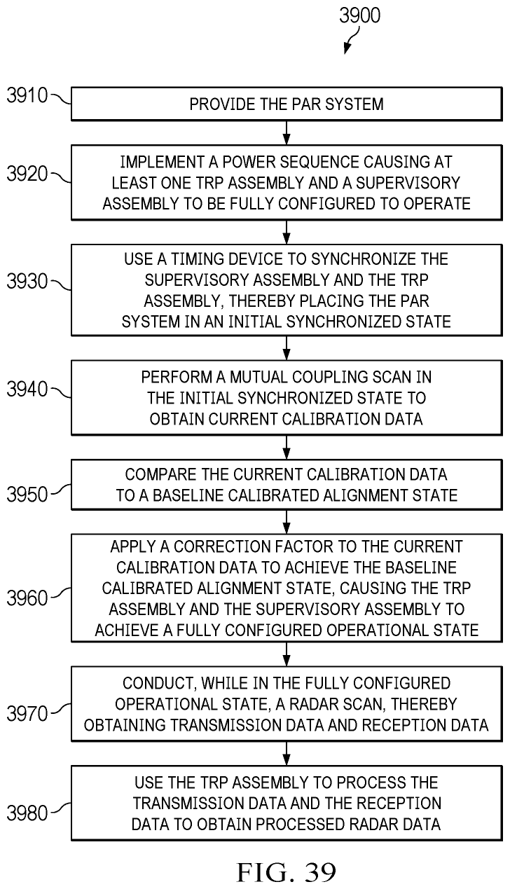

FIG. 39 is a flowchart illustrating a method 3900 of operating the PAR system 110 in FIG. 1. At step 3910, the PAR system 110 is provided. At step 3920, a power sequence is implemented, causing at least one TRP assembly 340 and a supervisory assembly 390 to be fully configured to operate. At step 3930, a timing device is used to synchronize the supervisory assembly 390 and the TRP assembly 340, thereby placing the PAR system 110 in an initial synchronized state. At step 3940, a mutual coupling scan is performed in the initial synchronized state to obtain current calibration data. At step 3950, the current calibration data are compared to a baseline calibrated alignment state. At step 3960, a correction factor is applied to the current calibration data to achieve the baseline calibrated alignment state, causing the TRP assembly 340 and the supervisory assembly 390 to achieve a fully configured operational state. At step 3970, while in the fully configured operational state, a radar scan is conducted, thereby obtaining transmission data and reception data. At step 3980, the TRP assembly 340 is used to process the transmission data and the reception data to obtain processed radar data.

The method 3900 may implement additional embodiments. For instance, the processed radar data are displayed on a screen or a monitor. The screen or the monitor may be on the controller 150. Implementing the power sequence comprises causing the backend assembly 140 and the supervisory assembly 390 to power on and boot up so that the supervisory assembly 390 causes the TRP assembly 340 to power on and boot up. The controller 140 controls the RBE 130 and the supervisory assembly 390. The baseline calibrated alignment state is obtained by obtaining a scanner 3310 comprising an RF probe 3330 and an RF transceiver, obtaining a scanner controller, using the scanner controller to transmit to the at least one TRP assembly 340 an instruction to perform an initial alignment calibration whereby initial alignment calibration data are obtained, transmitting the initial alignment calibration data from the TRP assembly 340 to the scanner controller, using the scanner controller and the initial alignment calibration data to determine element alignment weights for the plurality of radiating elements 310, and transmitting the element alignment weights from the scanner controller to the at least one TRP assembly 340. The method 3900 further comprises locally saving, by the at least one TRP assembly 340, the element alignment weights; and calculating the baseline calibrated alignment state using the element alignment weights. The scanner 3310 is a near-field scanner comprising an x-y positioner 3320.

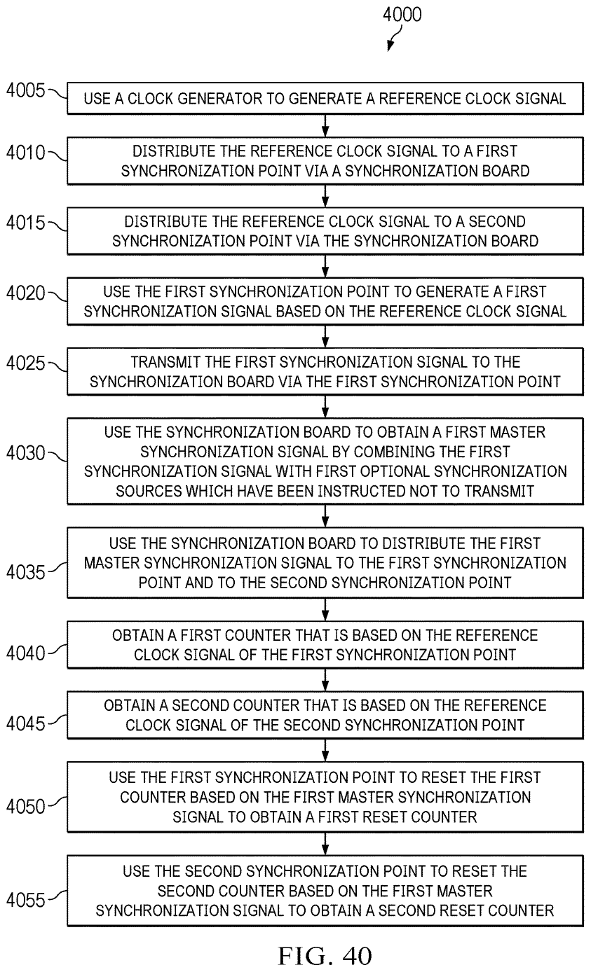

FIG. 40 is a flowchart illustrating a method 4000 of synchronizing the PAR system 110 in FIG. 1. At step 4005, a clock generator 620 is used to generate a reference clock signal. At step 4010, the reference clock signal is distributed to a first synchronization point via a synchronization board 640. At step 4015, the reference clock signal is distributed to a second synchronization point via the synchronization board 640. At step 4020, the first synchronization point is used to generate a first synchronization signal based on the reference clock signal. At step 4025, the first synchronization signal is transmitted to the synchronization board 640 via the first synchronization point. At step 4030, the synchronization board 640 is used to obtain a first master synchronization signal by combining the first synchronization signal with first optional synchronization sources which have been instructed not to transmit. At step 4035, the synchronization board 640 is used to distribute the first master synchronization signal to the first synchronization point and to the second synchronization point. At step 4040, a first counter that is based on the reference clock signal of the first synchronization point is obtained. At step 4045, a second counter that is based on the reference clock signal of the second synchronization point is obtained. At step 4050, the first synchronization point is used to reset the first counter based on the first master synchronization signal to obtain a first reset counter. At step 4055, the second synchronization point is used to reset the second counter based on the first master synchronization signal to obtain a second reset counter.

The method 4000 may implement additional embodiments. For instance, the method 4000 further comprises receiving, by the clock generator 620, a GPS DO signal from a GPS module 630; and generating, by the clock generator 620, the reference clock signal based on the GPS DO signal. The GPS DO signal comprises a first frequency of about 10 MHz. The reference clock signal comprises a second frequency of about 25 MHz. A TRP assembly 340 comprises an internal clock comprising a third frequency in a range of about 25 MHz to about 200 MHz.

The method 4000 further comprises distributing via the synchronization board 640 the reference clock signal to the first synchronization point through a first synchronization cable; distributing via the synchronization board 640 the reference clock signal to the second synchronization point through a second synchronization cable; transmitting via the first synchronization point the first synchronization signal to the synchronization board 640 through the first synchronization cable; distributing, via the synchronization board 640 the first master synchronization signal to the first synchronization point and though the first synchronization cable; and distributing via the synchronization board 640 the first master synchronization signal to the second synchronization point and though the second synchronization cable. The first synchronization cable and the second synchronization cable are substantially similar to each other and are phase-matched. The first synchronization cable and the second synchronization cable are of a substantially similar type and produce a substantially similar latency.

The method 4000 further comprises generating, via the first synchronization point, the first synchronization signal in response to an instruction from the controller 150. The instruction designates only the first synchronization point as a synchronization master. Combining the first synchronization signal with the first optional synchronization sources comprises using OR logic gates.

The first synchronization point is a first supervisory assembly 390 or a first host card of the PAR system 110. The second synchronization point is a second supervisory assembly 390 or a second host card of the PAR system 110. The method 4000 further comprises distributing the first master synchronization signal to a first TRP assembly 340 of the PAR system 110 via the first supervisory assembly 390, and distributing the first master synchronization signal to a second TRP assembly 340 of the PAR system 110 via the supervisory assembly 390. The method 4000 further comprises distributing the first master synchronization signal to a first plurality of chips in the first TRP assembly 340, and distributing the first master synchronization signal to a second plurality of chips in the second TRP assembly 340. The first plurality of chips and the second plurality of chips are FPGAs. The method 4000 further comprises resetting a third counter of the first TRP assembly 340 based on the first master synchronization signal to obtain a third reset counter, and resetting a fourth counter of the second TRP assembly 340 based on the first master synchronization signal to obtain a fourth reset counter. The method 4000 further comprises transmitting a transmission instruction to the first TRP assembly 340 and to the second TRP assembly 340 via the supervisory assembly 390, transmitting a first transmission signal at a first time based on the third reset counter via the TRP assembly 340 in response to the transmission instruction, and transmitting a second transmission signal at a second time based on the fourth reset counter via the second TRP assembly 340 in response to the transmission instruction. The method 4000 further comprises executing, by the first TRP assembly 340 and by the second TRP assembly 340, the transmission instruction without handshakes with other components of the PAR system 110.

The method 4000 further comprises using the second synchronization point to generate a second synchronization signal based on the reference clock signal, transmitting the second synchronization signal to the synchronization board 640 via the second synchronization point, obtaining a second master synchronization signal by using the synchronization board 640 to combine the second synchronization signal with second optional synchronization sources which have been instructed not to transmit, distributing the second master synchronization signal to the first synchronization point via the synchronization board 640, distributing the second master synchronization signal to the second synchronization point via the synchronization board 640, using the first synchronization point to reset the first reset counter based on the second master synchronization signal to obtain a third reset counter, and using the second synchronization point to reset the second reset counter based on the second master synchronization signal to obtain a fourth reset counter.

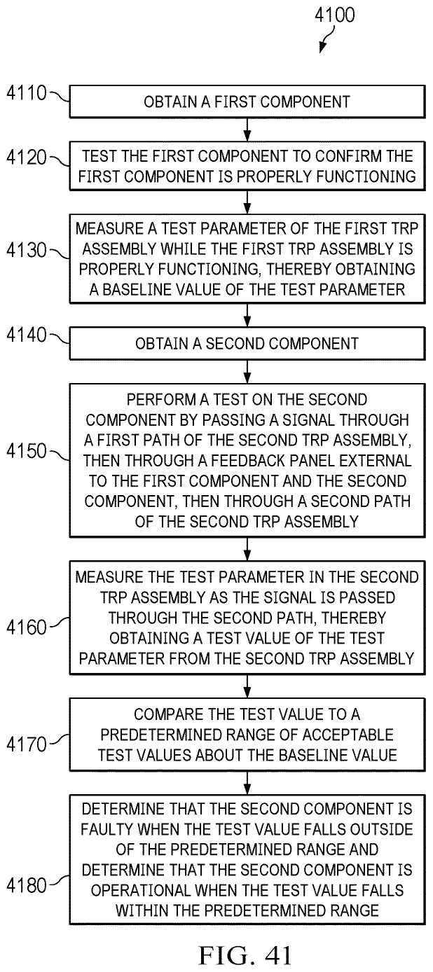

FIG. 41 is a flowchart illustrating a method 4100 of testing a component for use in the PAR system 110 in FIG. 1. At step 4110, a first component is obtained. The first component comprises a first TRP assembly 340. At step 4120, the first component is tested to confirm the first component is properly functioning. At step 4130, a test parameter of the first TRP assembly 340 is measured while the first TRP assembly 340 is properly functioning, thereby obtaining a baseline value of the test parameter. At step 4140, a second component is obtained. The second component comprises a second TRP assembly 340 that is substantially identical to the first TRP assembly 340. At step 4150, a test is performed on the second component by passing a signal through a first path of the second TRP assembly 340, then through a feedback panel external to the first component and the second component, then through a second path of the second TRP assembly 340. At step 4160, the test parameter in the second TRP assembly 340 is measured as the signal is passed through the second path, thereby obtaining a test value of the test parameter from the second TRP assembly 340. At step 4170, the test value is compared to a predetermined range of acceptable test values about the baseline value. At step 4180, it is determined that the second component is faulty when the test value falls outside of the predetermined range, and it is determined that the second component is operational when the test value falls within the predetermined range.

The method 4100 may implement additional embodiments. For instance, the first path and the second path are the same. The first path and/or the second path is through a transceiver 740, a mid-layer 746, and an RFE 748 of the second TRP assembly 340. The test is selected from the group consisting of a high-power transmit test, a low-power transmit test, a high-gain receive test, and a low-gain receive test. The method 4100 further comprises performing the test automatically. The method 4100 further comprises performing the test while the PAR system 110 is operating. The method 4100 further comprises removing the second component from the PAR system 110 when the second component is faulty. The method 4100 further comprises replacing the second component with a replacement component while the PAR system 110 is operating.

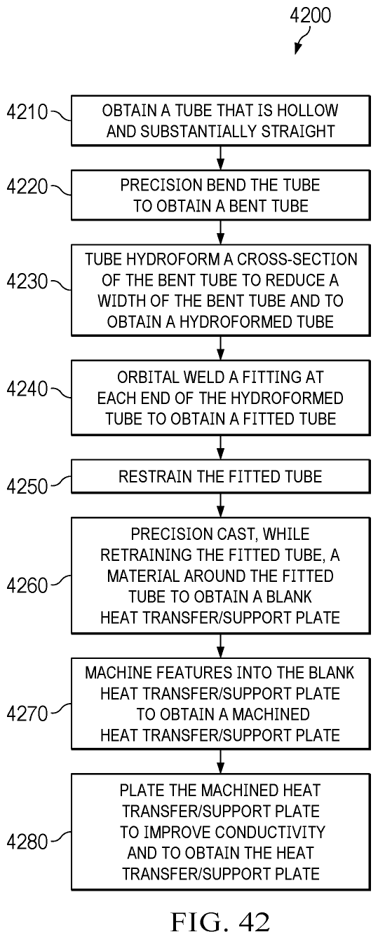

FIG. 42 is a flowchart illustrating a method 4200 of manufacturing the heat transfer/support plate 395 in FIG. 20A. The heat transfer/support plate 395 of FIG. 20A is a non-limiting embodiment of the TRP assembly 340. In other embodiments, the heat transfer/support plate does not include a tube as described herein. At step 4210, a tube that is hollow and substantially straight is obtained. At step 4220, the tube is precision bent to obtain a bent tube. At step 4230, a cross-section of the bent tube is tube hydroformed to reduce a width of the bent tube and to obtain a hydroformed tube. At step 4240, a fitting is orbital welded at each end of the hydroformed tube to obtain a fitted tube. At step 4250, the fitted tube is restrained. At step 4260, while retraining the fitted tube, a material is precision casted around the fitted tube to obtain a blank heat transfer/support plate. At step 4270, features are machined into the blank heat transfer/support plate to obtain a machined heat transfer/support plate. At step 4280, the machined heat transfer/support plate is plated to improve conductivity and to obtain the heat transfer/support plate.

The method 4200 may implement additional embodiments. For instance, the tube comprises a metal, and the metal comprises stainless steel or copper. The tube comprises a substantially circular cross-section. The bent tube comprises a serpentine shape. The hydroformed tube comprises a substantially ovular cross-section. The material is a metal, and the metal comprises stainless steel or copper. The features comprise hollow pedestals for removal of heat from mounted components. The method 4200 further comprises further machining features on both sides of the blank cold plate. The method 4200 further comprises further plating the machined cold plate with a metal, and the metal comprises nickel.

Alternatively, a printed cold plate can be 3D printed to comprise a tube and features made of a first metal. The tube is hollow and has a substantially ovular cross-section. The features comprise pedestals. The printed cold plate is plated to obtain the cold plate. In additional embodiments, the first metal comprises aluminum. The fitted cold plate is plated with a second metal. The first metal and the second metal are the same. The second metal comprises nickel.

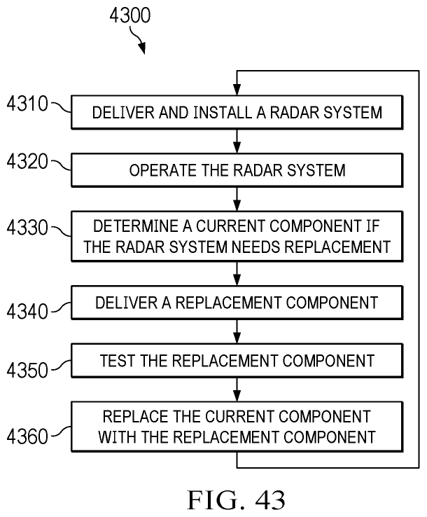

FIG. 43 is a flowchart illustrating a method 4300 of installation, operation, and maintenance of a PAR system 110. At step 4310, the PAR system 110 is delivered and installed. At step 4320, the PAR system 110 is operated. The radar system may be operated for a predetermined period of time. At step 4330, it is determined that a current component of the PAR system 110 needs replacement. Alternatively, it is determined that multiple current components of the PAR system 110 need replacement. At step 4340, a replacement component is delivered. At step 4350, the replacement component is tested. The replacement component may be debugged and repaired. At step 4360, the current component is replaced with the replacement component. Alternatively, the current component may be moved within the PAR system 110.

In summary, the following describes various problems addressed and solved by the Horus PAR system (in one embodiment referred to herein as Horus) of the present disclosure.

### Digital Array Cost:

Use of COTS components combined with custom-developed HW and low-cost manufacturing in Horus makes the system the most cost-effective complete digital array radar system in the world (we believe). Even comparable analog and subarray digital architectures are similar in cost or even more expensive when the full system cost is considered.

### Massive Data Growth:

Massive amounts of data are accumulated during operation of the disclosed PAR system. The Horus architecture solves this problem with a unique high-speed data network which can be run in series to limit data growth which provides many of the benefits of a digital array without most of the baggage. The flexible network can also be run in parallel to maximize data bandwidth from the array (second-stage beamformer)

### Channel Synchronization:

The Horus synchronization system is robust and massively scalable.

### Dual-Polarization Performance:

This may be the most difficult problem associated with the application of phased-arrays to weather radar. Largely thanks to the difficulty of the weather radar application, Horus is the most advanced and highest performing dual-pol S-band phased-array radar ever built. The world-class dual-pol performance of the antenna panel combined with the powerful digital calibration techniques of Horus make this system absolutely unmatched in this regard

### Array Calibration:

The Horus architecture is designed to take advantage of several novel and conventional phased-array calibration techniques. Digital arrays in general have calibration advantages due to (1) their extreme effective amplitude/phase resolution (16-bit samples for Horus rather than 6-bit attenuators and phase-shifters and (2) their ability to localize the calibration problem to individual independent channels. Horus combines a high-precision initial calibration with periodic mutual-coupling-based calibration maintenance. We have demonstrated the use of the same park-and-probe calibration reference over several months and the calibration holds even through complete HW (OctoBlade) swaps.

### System Maintainability:

Horus has been designed for extreme serviceability. The architecture is highly modular and easy build and maintain. An OctoBlade swap, for instance, can be accomplished in 10-15 minutes without powering down the system. Cables throughout the system have been minimized (this can be a huge problem for complex arrays) and massive aggregations of cables have been avoided

### Array Power Density and Cooling:

By their nature, digital arrays need to pack more heat into a given volume than other architectures. The thermal management system in Horus solves this problem using frame-integral liquid cooling and brings the fluid path into extreme proximity (as close as ⅛″) to the heat sources in the system. This effectively moves the problem to a higher level in the system where there are many more options for removing the heat

### Array Heat Distribution:

The Horus architecture employs a unique reverse-return fluid distribution system with all electronics blades effectively in parallel. This prevents non-uniform heat/temperature build-up in the array and minimizes the overall gradient and are very conducive to true graceful degradation.

Further aspects of the PAR system are described below.

Horus uses high performance radiating elements. High levels of integration within the octoblade enable dual-pol-digital-at-the-element system. Enabling technology is AD9371 direct conversion RF transceiver. Other appropriate RF transceivers can be substituted. Modularity and scalability through clever use of hierarchical subassemblies. Digital processing and beamforming is performed within the octoblade on powerful FPGAs. Partial beams are formed at each FPGA and passed along to be added to other partial beams at other nodes in the system. Final output to host is typically beamformed data (element data is also possible).

Flexible High-speed network architecture provides direct serial transceiver access to the primary FPGAs. This allows for the addition of a high-speed performance second-stage beamformer (SSB) with zero octoblade HW modifications. Full system I/Q bandwidth can be transferred to SSB with just one cable per FPGA (32 cables per panel/SSB). Full panel bandwidth or massively parallel partial beams can then be transported off the array through high-bandwidth fiber optic links. Clock distribution system provides phase-aligned throughout the system at all end points. Modularity hierarchy embeds system REF clock with other critical signals to minimize the required number of cables. Multiple points in hardware system to both measure and correct any bulk timing skew. System clocks are derived from a 10 MHz GPSDO. Modular clock distribution system with considerations for long required path lengths. Jitter cleaners used to re-acquire clock after long runs. The system is designed to be extremely scalable to 100s of panels and physically large array sizes. Phase noise performance verified at system/RF level.

Combined with the in-phase REF clock, the SYNC logic signal is used to establish an absolute time reference at all system endpoints. Easiest to think of it as a single pulse (even if this isn't 100% accurate). SYNC generation occurs at the panel level, usually in the superblade control board. Any SYNC end point in the system (but only one at a time) can be assigned as the “SYNC Master” to generate sync for the system. Once the SYNC signal is generated, it is transmitted through the same phase-matched cables used for REF distribution back to the RBE-SYNC. Within the RBE-SYNC subsystem (can be one or more subassemblies), all potential SYNC sources are combined through OR gates until they reach a single common point. This “Master SYNC” signal is then retransmitted to all endpoints in the system, including the “SYNC master”. After the SYNC signal has been generated and aggregated into the Master RBE-SYNC board, it is re-transmitted to all endpoints in the system (including the original source of the SYNC signal, the “SYNC Master”). The SYNC distribution system utilizes the same cables (different shielded differential pairs) as the REF clock distribution system. The SYNC signal is distributed beyond the Superblade to all FPGAs. The arrival of the SYNC signal at each endpoint allows each FPGA to “reset their counters”. This establishes a common time base throughout the system, enabling highly complex local operations with no need for costly coordination and interaction between parallel system resources.

The Horus power system is designed for massive scalability. High-voltage, high power DC supplies are operated in parallel, typically 400 V. Each circuit is used to power one or more array columns. High voltage allows column feeds to be “tapped” at panels with negligible voltage drops. All panel power is routed and distributed through the analog bridge (power backplane). Bus converter modules (BCMs) are used within the superblade power board to generate 50V and 12.5V rails from 400V at very high power and efficiency. The Superblade control board is used to control panel power. AUX supply allows this board to be powered as long as 400 V is present. Power control of the octoblade is routed through the digital bridge. Hot swap controllers are used for power monitoring and circuit protection. Octoblades use a central “power spine”. Power is tapped from the center of each board for local devices. The configuration is one of the enablers for the symmetry of the octoblade.

The Horus system uses external LOs. Operating the AD9371s with external LOs improves system phase noise performance, simplifies some aspects of phase calibration, and makes the system immune to injection locking which can be a problem at certain frequencies and power levels. There are also downsides, including slightly degraded I/Q spur performance and LO leakage. Horus external LO generation and distribution system was designed to minimize the M&O impacts. Existing REF clock in SUPER-CTL-1 is used with a frequency synthesizer to generate the LO (currently one LO for TX and RX). The LO signal is distributed to the digital bridges through a small number of coaxial cables and then further distributed to the octoblades within the DBTG assembly. The LO signal passes through the FPGA board (digital board) and into the QUAD board (RF board). The LO signal is then distributed within the QUAD board to each AD9371. Separate RX/TX LO networks are maintained outside of SUPER-CTL1. SUPER-CTL1 (only one per panel) can be modified to introduce better frequency hopping support.

Command and control takes place over ethernet network (these are relatively low bandwidth communications which are not time sensitive. This allows the Horus system to leverage existing network equipment and simplifies SW development. The Network shelf of each array panel assembly minimizes cables that would interfere with maintenance. Low-level communication bus (I2C) used for direct control of devices throughout the superblade and all octoblades (through the digital bridging assemblies (“DRBG”)). SUPER-CTL1 supervises and controls power/status for SUPERPWR1 and octoblades.

Critical radar timing into the Octoblade MitySOM. Signals and control restricted to A10 FPGAs and synchronized with Tx, Rx, and beamforming. Incredible in-system HW/SW debugging tools are integrated including multi-master IC communication, JTAG access to every single FPGA in the entire system remotely, and a UART debug interface.

System-level write-protect network to all devices with non-volatile memory allowing for HW-based system WP restriction. Chip-to-chip (C2C) interface allows A10 FPGAs to integrate seamlessly with MitySOM. Efficient SPI communication with AD9371s supporting simultaneous configuration.

Regarding system maintenance, the octoblade is the key element. Swapping octoblades is easy, and they are hot-swappable even when fluid is flowing, Requires simple tools for removal. Removal causes no impact on calibration reference. The system automatically detects the change.

Regarding Octoblade repairability, the system uses 100% SMT/TH construction (no wires, bare dies, or any other irreversible fabrication processes). Octoblades can be disassembled, PCBs removed, PCBs repaired, and reassembled in less than 2 hours. Strong argument for avoiding conformal coat. Quad board (RF board) failures are highly localizable with the FGA board (digital board). Most of the debugging process is done before reaching the bench. Each octoblade is essentially an independent radar system, powered up on the bench. Estimated replacement times are: (1) Octoblade: 15 min (hot-swap OK), (2) Superblade: 10 min (400V power down required), (3) Digital bridge: 10 min (hot swap OK), (4) Analog bridge: 1 hr (400V power down required), and (5) Antenna panel: 1 hr (not including radome removal).

The Horus system has automatic blade position recognition. Blades can automatically read their slot position, orientation, and array panel position from pins on the analog bridge (power backplane). X/Y dip switches for setting the panel position allow this feature to support radar arrays as large as 4,096 panels (64×64). This allows the SW to automatically assign element positions within the radar array and detect blade changes, swaps, etc. The system allows gradual, non-catastrophic degradation allowing for inevitable component failures while minimizing the impact on overall system performance. Operating temperature drives long-term electronics reliability. Liquid cooling system minimizes thermal gradients across the radar array and are effectively in parallel. This minimizes temperature rise to that of a single blade. Even this residual rise can be mitigated through periodic blade rotation or array flow reversal.

Regarding health/status monitoring, each octoblade is a complex and intelligent system. Each blade has a wealth of status, debugging, health, fault, and other measurements which are continuously logged. This includes temperatures from sensors all over the blade, voltages, currents, power consumption, etc. This data can be displayed and stored continuously. Critical parameters have HW setpoints to allow the octoblade to self-protect without SW intervention. Other operational limits can be set in SW to allow the system to intervene if a parameter is measured that exceeds limits.

The system uses mutual passive couplings between antenna elements to return to a known state (and cancel out electronics variation). Mutual coupling is used primarily for maintaining system calibration, but it is also useful for maintaining the system. Every time the system is turned on, a “mutual coupling scan” is performed to calibrate the radar array. This scan generates a table of “corrections” that are applied to each element. By tracking these corrections, Tx/Rx failures can be detected and even slow degradation at extremely high accuracy. It may even be possible to recognize a “pre-failure footprint” thus anticipating certain types of failures, triggering preventive maintenance.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

In at least certain non-limiting embodiments identified below, the present disclosure is directed to a phased array radar (PAR) system comprising the following apparatus, components, and methods of use.

Clause 1. A phased array radar (PAR) system comprising:
(1) at least one array panel assembly comprising:
   (a) at least one antenna panel comprising a plurality of dual polarization radiating elements and a plurality of antenna ports, wherein the at least one antenna panel is passive and removable, and wherein each of the dual polarization radiating elements comprises a horizontal (H) component and a vertical (V) component, and wherein each H component and each V component is operably connected to a corresponding antenna port, and wherein the plurality of antenna ports are passive;
   (b) at least one transmission-receiver-processor assembly connected to the plurality of antenna ports and comprising:
      (1) at least one first radio frequency (RF) board/digital board pair which is operably connected to the H components;
      (2) at least one second RF board/digital board pair which is operably connected to the V components, wherein each RF board of the at least one first RF board/digital board pair and the at least one second RF board/digital board pair is responsible for conversion between RF analog signals and digital signals, wherein each digital board of the at least one first RF board/digital board pair and the at least one second RF board/digital board pair is responsible for digital signal processing, and wherein the at least one first RF board/digital board pair is physically separated from the at least one second RF board/digital board pair such that parasitic couplings between the at least one first RF board/digital board pair and the at least one second RF board/digital board pair are minimized; and
      (3) a heat transfer plate comprising a first side, and a second side opposite the first side, and configured to remove heat from and separate the at least one first RF board/digital board pair and the at least one second RF board/digital board pair, wherein the at least one first RF board/digital board pair is attached to the first side, and the at least one second RF board/digital board pair is attached to the second side, and
wherein the at least one transmission-receiver-processor assembly is configured to:
   (i) transmit independent transmission signals to the plurality of antenna ports;
   (ii) receive independent reception signals from the plurality of antenna ports; and
   (iii) process and sample the independent reception signals;
   (c) a passive power backplane configured to provide power to the at least one transmission-receiver-processor assembly;
   (d) a supervisory assembly configured to:
      (1) receive a high-voltage, low-current power;
      (2) convert the high-voltage, low-current power into a low-voltage, high-current power;
      (3) distribute the low-voltage, high-current power to the passive power backplane for providing high-current power to the at least one transmission-receiver-processor assembly;
      (4) supervise the at least one transmission-receiver-processor assembly; and
      (5) distribute synchronization signals, control signals, and supervisory signals to the at least one transmission-receiver-processor assembly; and
   (e) an array frame upon which the at least one antenna panel, the at least one transmission-receiver-processor assembly, and the supervisory assembly are mounted, wherein the array frame is configured to distribute a cooling fluid for cooling the at least one transmission-receiver-processor assembly and the supervisory assembly; and
(2) a backend assembly comprising a destination for processed data from the at least one transmission-receiver-processor assembly.

Clause 2. The PAR system of clause 1, further comprising a controller configured to operate the plurality of dual polarization radiating elements via the at least one transmission-receiver-processor assembly.

Clause 3. The PAR system of claim 2, further comprising a synchronization subsystem and a timing device, wherein the controller is further configured to:
(a) initiate a power sequence for causing the at least one transmission-receiver-processor assembly and the supervisory assembly to be fully configured to operate;
(b) initiate, after the power sequence is initiated, a first synchronization event from the supervisory assembly via the synchronization subsystem and the timing device;
(c) receive a second synchronization of the at least one transmission-receiver-processor assembly via the supervisory assembly, based on the first synchronization event, and based on the timing device, thereby placing the PAR system in an initial synchronized state;
(d) perform a mutual coupling scan in the initial synchronized state to obtain current calibration data;
(e) compare the current calibration data to a previously determined calibrated alignment state;
(f) apply a correction factor to the current calibration data to achieve the previously determined calibrated alignment state, thereby causing the at least one transmission-receiver-processor assembly and the supervisory assembly to achieve a fully configured operational state;
(g) conduct a radar scan thereby obtaining transmission data and reception data; and
(h) process, via the transmission-receiver-processor assembly, the transmission data and the reception data to obtain processed radar data.

Clause 4. The PAR system of claim 2 or 3, wherein the controller is further configured to:
provide operational instructions to the at least one array panel assembly thereby enabling the at least one array panel assembly to obtain radar data;
receive the radar data from the at least one array panel assembly; and
process the radar data to obtain processed radar data.

Clause 5. The PAR system of any one of clauses 2-4, wherein the controller is a computer, and wherein the controller is further configured to display the processed radar data.

Clause 6. The PAR system of any one of clauses 2-5, wherein the controller is an integral component of the backend assembly.

Clause 7. The PAR system of any one of clauses 2-5, wherein the controller is separate from the backend assembly.

Clause 8. The PAR system of any one of clauses 1-7, wherein the at least one transmission-receiver-processor assembly and the supervisory assembly are modular and independently removable from and replaceable in the array panel assembly.

Clause 9. The PAR system of any one of clauses 1-8, wherein the backend assembly is configured to provide a timing mechanism and the synchronization signals to the supervisory assembly.

Clause 10. The PAR system of any one of clauses 1-9, further comprising a superstructure upon which the at least one array panel assembly is mounted.

Clause 11. The PAR system of clause 10, wherein the backend assembly is mounted to the superstructure.

Clause 12. The PAR system of any one of clauses 1-11, wherein the heat transfer plate comprises conduits configured to deliver the cooling fluid within the heat transfer plate.

Clause 13. The PAR system of any one of clauses 1-12, wherein the heat transfer plate comprises at least one heat conducting element configured to be in contact with the cooling fluid in the array frame.

Clause 14. The PAR system of any one of clauses 1-13, wherein the supervisory assembly comprises conduits for conducting the cooling fluid therein.

Clause 15. The PAR system of any one of clauses 1-14, wherein the supervisory assembly comprises at least one heat conducting element configured to be in contact with the cooling fluid in the array frame.

Clause 16. The PAR system of any one of clauses 1-15, wherein the at least one transmission-receiver-processor assembly comprises a plurality of transmission-receiver-processor assemblies.

Clause 17. The PAR system of any one of clauses 1-16, comprising a plurality of array panel assemblies.

Clause 18. The PAR system of any one of clauses 1-17, comprising from 2 to 64 array panel assemblies.

Clause 19. The PAR system of any one of clauses 1-18, comprising 25 array panel assemblies in a 5×5 arrangement, and wherein each array panel comprises 64 dual-polarization radiating elements.

Clause 20. The PAR system of any one of clauses 1-19, wherein the at least one array panel assembly is removable, electrically scalable, and mechanically scalable.

Clause 21. The PAR system of any one of clauses 1-20, wherein the at least one transmission-receiver-processor assembly is further configured to maintain functionality when the at least one transmission-receiver-processor assembly is disconnected from the antenna ports, rotated 180°, and reconnected to the antenna ports.

Clause 22. The PAR system of any one of clauses 1-21, wherein each digital board of the at least one first RF board/digital board pair and the at least one second RF board/digital board pair comprises a plurality of field-programmable gate arrays (FPGAs) which are interconnected to form a beamforming network.

Clause 23. The PAR system of any one of clauses 1-22, wherein the heat transfer plate is further configured to transfer heat to the cooling fluid distributed within the array frame.

Clause 24. The PAR system of any one of clauses 1-23, wherein the heat transfer plate further comprises an internal conduit configured to distribute the cooling fluid.

Clause 25. The PAR system of any one of clauses 1-24, wherein the array frame comprises a card cage which comprises:
a first card guide configured to accept the at least one transmission-receiver-processor assembly; and
a second card guide configured to accept the supervisory assembly,
and optionally, wherein the first card guide and second card guide are extendable to enable scalability of the at least one transmission-receiver-processor assembly and the supervisory assembly, respectively.

Clause 26. The PAR system of any one of clauses 1-25, wherein the array frame comprises a card cage which comprises a plurality of card guides configured to accept the at least one transmission-receiver-processor assembly and the supervisory assembly, and optionally wherein the card guides are extendable to enable scalability of the at least one transmission-receiver-processor assembly and the supervisory assembly.

Clause 27. The PAR system of any one of clauses 1-26, wherein the array frame comprises a card cage which comprises a plurality of card guides configured to accept one or more pairs of transmission-receiver-processor assemblies and a single supervisory assembly, and optionally wherein the card guides are extendable to enable scalability of the one or more pairs of transmission-receiver-processor assemblies and the supervisory assembly.

Clause 28. The PAR system of any one of clauses 1-27, further comprising a modular ground plane upon which the passive power backplane is mounted and secured, wherein the modular ground plane comprises seams, wherein the at least one panel assembly further comprises edges and is coupled to the modular ground plane in a configuration such that the edges overlap the seams to form an electrically continuous ground plane, wherein the modular ground plane is configured to reflect radio waves.

Clause 29. The PAR system of any one of clauses 1-28, wherein the at least one array panel assembly comprises (1) at least one pair of antenna panels, (2) at least one pair of transmission-receiver-processor assemblies, and (3) a digital bridging subassembly electrically connected to each transmission-receiver-processor assembly of the at least one pair of transmission-receiver-processor assemblies, and wherein the digital bridging subassembly is configured to:
receive the synchronization signals, the control signals, and the supervisory signals from the supervisory assembly; and
distribute the synchronization signals, the control signals, and the supervisory signals to each transmission-receiver-processor assembly of the at least one pair of transmission-receiver-processor assemblies.

Clause 30. The PAR system of clause 29, wherein each transmission-receiver-processor assembly of the at least one pair of transmission-receiver-processor assemblies, the digital bridging subassembly, and the supervisory assembly are modular and independently removable and replaceable.

Clause 31. The PAR system of any one of clauses 29-30, comprising a plurality of the array panel assemblies.

Clause 32. The PAR system of any one of clauses 29-31, wherein the at least one array panel assembly comprises a plurality of pairs of transmission-receiver-processor assemblies and a plurality of pairs of antenna panels.

Clause 33. The PAR system of any one of clauses 29-32, wherein the at least one array panel assembly comprises eight antenna panels, eight transmission-receiver-processor assemblies, four digital bridging assemblies, and one supervisory assembly.

Clause 34. The PAR system of clause 33, comprising a plurality of the array panel assemblies.

Clause 35. The PAR system of any one of clauses 1-34, wherein the at least one array panel assembly further comprises:
(a) a network switch coupled to the plurality of pairs of transmission-receiver-processor assemblies;
(d) a single network switch cable coupling the backend assembly to the network switch;
(b) a single synchronization cable coupling the backend assembly to the supervisory assembly;
(c) a single supervisory assembly network cable coupling the backend assembly to the supervisory assembly; and
(e) a plurality of synchronization and control cables, wherein the digital bridging subassembly is coupled to the supervisory assembly by one of the plurality of synchronization and control cables.

Clause 36. A phased array radar (PAR) system comprising:
(1) at least one array panel assembly comprising:
   (a) a pair of antenna panels, wherein each of the antenna panels comprises a plurality of dual polarization radiating elements and a plurality of antenna ports, wherein each of the antenna panels is passive, wherein each of the dual polarization radiating elements comprises a horizontal (H) component and a vertical (V) component, wherein each H component and each V component is operably connected to a corresponding antenna port, and wherein the antenna ports are passive;
   (b) a pair of transmission-receiver-processor assemblies each corresponding to one of the antenna panels and connected to the plurality of antenna ports of the corresponding antenna panel, wherein each of the transmission-receiver-processor assemblies is configured to:
      (i) maintain complete functionality when disconnected from the antenna ports of the corresponding antenna panel, rotated 180°, and reconnected to the antenna ports of the corresponding antenna panel;
      (ii) transmit independent transmission signals to the antenna ports of the corresponding antenna panel;
      (iii) receive independent reception signals from the antenna ports of the corresponding antenna panel; and
      (iv) process and sample the independent reception signals;
   (c) a passive power backplane configured to provide power to the pair of transmission-receiver-processor assemblies;
   (d) a supervisory assembly configured to:
      (1) receive a high-voltage, low-current power;
      (2) convert the high-voltage, low-current power into a low-voltage, high-current power;
      (3) distribute the low-voltage, high-current power to the passive power backplane for providing high-current power to the pair of transmission-receiver-processor assemblies;
      (4) supervise the pair of transmission-receiver-processor assemblies; and
      (5) distribute synchronization signals, control signals, and supervisory signals;
   (e) a digital bridging subassembly electrically connected to the supervisory assembly and the pair of transmission-receiver-processor assemblies, wherein the digital bridging subassembly is configured to:
      (1) receive the synchronization signals, the control signals, and the supervisory signals from the supervisory assembly; and
      (2) distribute the synchronization signals, the control signals, and the supervisory signals to the pair of transmission-receiver-processor assemblies; and
   (f) an array frame upon which the pair of antenna panels, the pair of transmission-receiver-processor assemblies, the supervisory assembly, and the digital bridging subassembly are mounted, wherein the array frame is configured to distribute a cooling fluid for cooling the pair of transmission-receiver-processor assemblies and the supervisory assembly.

Clause 37. The PAR system of clause 36, further comprising:
a controller configured to operate the plurality of dual polarization radiating elements of each of the pair of antenna panels via the pair of transmission-receiver-processor assemblies; and
a backend assembly comprising a destination for processed data from the pair of transmission-receiver-processor assemblies.

Clause 38. The PAR system of clause 36 or 37, wherein each of the transmission-receiver-processor assemblies comprises:
(1) a first radio frequency (RF) board/digital board pair which is operably connected to the H components; and
(2) a second RF board/digital board pair which is operably connected to the V components, wherein each RF board of the first RF board/digital board pair and the second RF board/digital board pair is responsible for conversion between RF analog signals and digital signals, wherein each digital board of the first RF board/digital board pair and the second RF board/digital board pair is responsible for digital signal processing, and wherein the first RF board/digital board pair is physically separated from the second RF board/digital board pair such that parasitic couplings between the first RF board/digital board pair and the second RF board/digital board pair are minimized; and
(3) a heat transfer plate comprising a first side, and a second side opposite the first side, and configured to remove heat from and separate the first RF board/digital board pair and the second RF board/digital board pair, wherein the first RF board/digital board pair is attached to the first side, and the second RF board/digital board pair is attached to the second side.

Clause 39. A method of operating a digital phased array radar (PAR) system, the method comprising:
(a) providing a PAR system comprising:
   (1) at least one array panel assembly comprising:
      (i) at least one antenna panel comprising:
         (a) a plurality of dual-polarization radiating elements; and
         (b) a plurality of antenna ports operably connected to the plurality of dual-polarization radiating elements;
      (ii) at least one transmission-receiver-processor assembly connected to the plurality of antenna ports;
      (iii) a supervisory assembly configured to:
         (a) distribute a high-current power to the at least one transmission-receiver-processor assembly;
         (b) supervise the at least one transmission-receiver-processor assembly; and
         (c) distribute synchronization signals, control signals, and supervisory signals to the at least one transmission-receiver-processor assembly; and
      (iv) an array frame upon which the at least one antenna panel, the at least one transmission-receiver-processor assembly, and the supervisory assembly are mounted, wherein the array frame is configured to distribute a cooling fluid for cooling the at least one transmission-receiver-processor assembly and the supervisory assembly;
   (2) a backend assembly comprising a destination for processed data from the at least one transmission-receiver-processor assembly; and
   (3) a timing device;
(b) implementing a power sequence causing the at least one transmission-receiver-processor assembly and the supervisory assembly to be fully configured to operate;
(c) using the timing device to synchronize the supervisory assembly and the at least one transmission-receiver-processor assembly, thereby placing the PAR system in an initial synchronized state;
(d) performing a mutual coupling scan in the initial synchronized state to obtain current calibration data;
(e) comparing the current calibration data to a baseline calibrated alignment state;
(f) applying a correction factor to the current calibration data to achieve the baseline calibrated alignment state, causing the at least one transmission-receiver-processor assembly and the supervisory assembly to achieve a fully configured operational state;
(g) conducting, while in the fully configured operational state, a radar scan, thereby obtaining transmission data and reception data; and
(h) using the transmission-receiver-processor assembly to process the transmission data and the reception data via to obtain processed radar data.

Clause 40. The method of clause 39, further comprising displaying the processed radar data on a screen or a monitor.

Clause 41. The method of clause 39 or 40, wherein implementing the power sequence comprises causing the backend assembly and the supervisory assembly to power on and boot up so that the supervisory assembly causes the transmission-receiver-processor assembly to power on and boot up.

Clause 42. The method of any one of clauses 39-41, further comprising controlling, by a controller of the PAR system, the backend assembly and the supervisory assembly.

Clause 43. The method of any one of clauses 39-42, further comprising obtaining the baseline calibrated alignment state by:
obtaining a scanner comprising an RF probe and an RF transceiver;
obtaining a scanner controller;
using the scanner controller to transmit to the at least one transmission-receiver-processor assembly an instruction to perform an initial alignment calibration whereby initial alignment calibration data are obtained;
transmitting the initial alignment calibration data from the transmission-receiver-processor assembly to the scanner controller;
using the scanner controller and the initial alignment calibration data to determine element alignment weights for the plurality of radiating elements; and
transmitting the element alignment weights from the scanner controller to the at least one transmission-receiver-processor assembly.

Clause 44. The method of clause 43, further comprising:
locally saving, by the at least one transmission-receiver-processor assembly, the element alignment weights; and calculating the baseline calibrated alignment state using the element alignment weights.

Clause 45. The method of clause 43 or 44, wherein the scanner is a near-field scanner comprising an x-y positioner.

Clause 46. The method of clause 43 or 44, wherein the scanner is a far-field scanner.

Clause 47. A method implemented by a radar system, the method comprising:
using a clock generator to generate a reference clock signal;
distributing the reference clock signal to a first synchronization point via a synchronization board;
distributing the reference clock signal to a second synchronization point via the synchronization board;
using the first synchronization point to generate a first synchronization signal based on the reference clock signal;
transmitting the first synchronization signal to the synchronization board via the first synchronization point;
using the synchronization board to obtain a first master synchronization signal by combining the first synchronization signal with first optional synchronization sources which have been instructed not to transmit;
using the synchronization board to distribute the first master synchronization signal to the first synchronization point and to the second synchronization point;
obtaining a first counter that is based on the reference clock signal of the first synchronization point;
obtaining a second counter that is based on the reference clock signal of the second synchronization point;
using the first synchronization point to reset the first counter based on the first master synchronization signal to obtain a first reset counter; and
using the second synchronization point to reset the second counter based on the first master synchronization signal to obtain a second reset counter.

Clause 48. The method of clause 47, further comprising:
receiving, by the clock generator, a Global Positioning System (GPS) disciplined oscillator (DO) signal from a GPS module; and
generating, by the clock generator, the reference clock signal based on the GPS DO signal.

Clause 49. The method of clause 48, wherein the GPS DO signal comprises a first frequency of about 10 megahertz (MHz), wherein the reference clock signal comprises a second frequency of about 25 MHz, and wherein a transmission-receiver-processor assembly of the radar system comprises an internal clock comprising a third frequency in a range of about 25 MHz to about 200 MHz.

Clause 50. The method of any one of clauses 48-49, wherein the clock generator is in a backend assembly of the radar system, and wherein the synchronization board and the GPS module are in a synchronization subassembly of the backend assembly.

Clause 51. The method of any one of clauses 47-50, further comprising:
distributing via the synchronization board the reference clock signal to the first synchronization point through a first cable;
distributing via the synchronization board the reference clock signal to the second synchronization point through a second cable;
transmitting via the first synchronization point the first synchronization signal to the synchronization board through the first cable;
distributing, via the synchronization board the first master synchronization signal to the first synchronization point and though the first cable; and
distributing via the synchronization board the first master synchronization signal to the second synchronization point and though the second cable.

Clause 52. The method of clause 51, wherein the first cable and the second cable are substantially similar to each other and are phase-matched.

Clause 53. The method of clause 51 or 52, wherein the first cable and the second cable are of a substantially similar type and produce a substantially similar latency.

Clause 54. The method of any one of clauses 47-53, further comprising generating, via the first synchronization point, the first synchronization signal in response to an instruction from a controller of the radar system, wherein the instruction designates only the first synchronization point as a synchronization master.

Clause 55. The method of any one of clauses 47-54, wherein combining the first synchronization signal with the first optional synchronization sources comprises using OR logic gates.

Clause 56. The method of any one of clauses 47-55, wherein the first synchronization point is a first supervisory assembly of the radar system or a first host card of the radar system, and wherein the second synchronization point is a second supervisory assembly of the radar system or a second host card of the radar system.

Clause 57. The method of clause 56, further comprising:
distributing the first master synchronization signal to a first transmission-receiver-processor assembly of the radar system via the first supervisory assembly; and
distributing the first master synchronization signal to a second transmission-receiver-processor assembly of the radar system via the first supervisory assembly.

Clause 58. The method of clause 57, further comprising:
distributing the first master synchronization signal to a first plurality of chips in the first transmission-receiver-processor assembly; and
distributing the first master synchronization signal to a second plurality of chips in the second transmission-receiver-processor assembly.

Clause 59. The method of clause 58, wherein the first plurality of chips and the second plurality of chips are field-programmable gate arrays (FPGAs).

Clause 60. The method of any one of clauses 47-59, further comprising:
resetting a third counter of the first transmission-receiver-processor assembly based on the first master synchronization signal to obtain a third reset counter; and
resetting a fourth counter of the second transmission-receiver-processor assembly based on the first master synchronization signal to obtain a fourth reset counter.

Clause 61. The method of clause 60, further comprising:
transmitting a transmission instruction to the first transmission-receiver-processor assembly and to the second transmission-receiver-processor assembly via the first supervisory assembly;
transmitting a first transmission signal at a first time based on the third reset counter via the first transmission-receiver-processor assembly in response to the transmission instruction; and
transmitting a second transmission signal at a second time based on the fourth reset counter via the second transmission-receiver-processor assembly in response to the transmission instruction.

Clause 62. The method of clause 61, further comprising executing, by the first transmission-receiver-processor assembly and by the second transmission-receiver-processor assembly, the transmission instruction without handshakes with other components of the radar system.

Clause 63. The method of any one of clauses 47-62, further comprising:
using the second synchronization point to generate a second synchronization signal based on the reference clock signal;
transmitting the second synchronization signal to the synchronization board via the second synchronization point;
obtaining a second master synchronization signal by using the synchronization board to combine the second synchronization signal with second optional synchronization sources which have been instructed not to transmit;
distributing the second master synchronization signal to the first synchronization point via the synchronization board;
distributing the second master synchronization signal to the second synchronization point via the synchronization board;
using the first synchronization point to reset the first reset counter based on the second master synchronization signal to obtain a third reset counter; and
using the second synchronization point to reset the second reset counter based on the second master synchronization signal to obtain a fourth reset counter.

Clause 64. A method of testing a component for use in a radar system, the method comprising:

(1) obtaining a first component, wherein the first component comprises a first transmission-receiver-processor assembly, and wherein the first transmission-receiver-processor assembly comprises:
(a) a support plate;
(b) at least one first radio frequency (RF) board/digital board pair which is attachable to and detachable from a first plurality of antenna ports operably connected to a first plurality of dual-polarization radiating element components; and
(c) at least one second RF board/digital board pair which is attachable to and detachable from a second plurality of antenna ports operably connected to a second plurality of dual-polarization radiating element components, wherein first circuitry of the at least one first RF board/digital board pair and second circuitry of the at least one second RF board/digital board pair are substantially identical, wherein the first circuitry and the second circuitry enable conversion between RF analog signals and digital signals and enables digital signal processing, wherein the at least one first RF board/digital board pair and the at least one second RF board/digital board pair are attached to opposite surfaces of the support plate, wherein the at least one first RF board/digital board pair is physically separated from the at least one second RF board/digital board pair by the support plate, wherein the first circuitry is isolated from the second circuitry such that parasitic couplings between the at least one first RF board/digital board pair and the at least one second RF board/digital board pair are substantially minimized, and wherein the first transmission-receiver-processor assembly is configured to:
   (i) transmit independent transmission signals to the first plurality of antenna ports and the second plurality of antenna ports;
   (ii) receive independent reception signals from the first plurality of antenna ports and the second plurality of antenna ports; and
   (iii) process and sample the independent reception signals;
(2) testing the first component to confirm the first component is properly functioning;
(3) measuring a test parameter of the first transmission-receiver-processor assembly while the first transmission-receiver-processor assembly is properly functioning, thereby obtaining a baseline value of the test parameter;
(4) obtaining a second component, wherein the second component comprises a second transmission-receiver-processor assembly that is substantially identical to the first transmission-receiver-processor assembly;
(5) performing a test on the second component by passing a signal through a first path of the second transmission-receiver-processor assembly, then through a feedback panel external to the first component and the second component, then through a second path of the second transmission-receiver-processor assembly;
(6) measuring the test parameter in the second transmission-receiver-processor assembly as the signal is passed through the second path, thereby obtaining a test value of the test parameter from the second transmission-receiver-processor assembly;
(7) comparing the test value to a predetermined range of acceptable test values about the baseline value; and
(8) determining that the second component is faulty when the test value falls outside of the predetermined range and determining that the second component is operational when the test value falls within the predetermined range.

Clause 65. The method of clause 64, wherein the first plurality of radiating element components implement a horizontal (H) polarization and the second plurality of radiating element components implement a vertical (V) polarization.

Clause 66. The method of clause 64, wherein the first plurality of radiating element components implement a vertical (V) polarization and the second plurality of radiating element components implement a horizontal (H) polarization.

Clause 67. The method of any one of clauses 64-66, wherein the first path and the second path are the same.

Clause 68. The method of any one of clauses 64-67, wherein the first path and/or the second path is through a transceiver, a mid-layer, and a radio frontend (RFE) of the second transmission-receiver-processor assembly.

Clause 69. The method of any one of clauses 64-68, wherein the test is selected from the group consisting of a high-power transmit test, a low-power transmit test, a high-gain receive test, and a low-gain receive test.

Clause 70. The method of any one of clauses 64-69, further comprising performing the test automatically.

Clause 71. The method of any one of clauses 64-70, further comprising performing the test while the radar system is operating.

Clause 72. The method of any one of clauses 64-71, further comprising removing the second component from the radar system when the second component is faulty.

Clause 73. The method of any one of clauses 64-72, further comprising replacing the second component with a replacement component while the radar system is operating.

Clause 74. A radar system comprising:
an array panel assembly comprising:
   (1) an array frame;
   (2) at least one antenna panel comprising:
      (a) a plurality of dual-polarization radiating elements wherein each of the dual polarization radiating elements comprises a horizontal (H) component and a vertical (V) component,
      (b) a first set of antenna ports which are connected to the H components, and
      (c) a second set of antenna ports which are connected to the V components;
   (3) at least one transmission-receiver-processor assembly that is electrically and mechanically symmetric such that it can engage the array frame and engage the first and second sets of antenna ports in either a first orientation or a second orientation and still maintain complete functionality, wherein the at least one transmission-receiver-processor assembly comprises:
      (a) a support plate;
      (b) a first radio frequency (RF) board/digital board pair comprising first circuitry, and
      (c) a second RF board/digital board pair comprising second circuitry,
   and wherein
   (1) in a first orientation of the at least one transmission-receiver-processor assembly, the first RF board/digital board pair is connectable to the first set of antenna ports and the second RF board/digital board pair is connectable to the second set of antenna ports, and in a second orientation of the at least one transmission-receiver-processor assembly, the first RF board/digital board pair is connectable to the second set of antenna ports and the second RF board/digital board pair is connectable to the first set of antenna ports,
   (2) the first circuitry and the second circuitry enable conversion between RF analog signals and digital signals and enable digital signal processing, wherein the first RF board/digital board pair and the second RF board/digital board pair are attached to opposite surfaces of the support plate, wherein the first RF board/digital board pair is physically separated from the second RF board/digital board pair by the support plate, wherein the first circuitry is isolated from the second circuitry such that parasitic couplings between the first RF board/digital board pair and the second RF board/digital board pair are substantially minimized, and wherein the at least one transmission-receiver-processor assembly is configured to:
      (i) transmit independent transmission signals to the antenna ports;
      (ii) receive independent reception signals from the antenna ports; and
      (iii) process and sample the independent reception signals, and
   (3) the at least one transmission-receiver-processor assembly maintains complete functionality in the first orientation and in the second orientation.

1.-38. (canceled)

39. A method of operating a digital phased array radar (PAR) system, the method comprising:
(a) providing a PAR system comprising:
(1) at least one array panel assembly comprising:
(i) at least one antenna panel comprising:
(a) a plurality of dual-polarization radiating elements; and
(b) a plurality of antenna ports operably connected to the plurality of dual-polarization radiating elements;
(ii) at least one transmission-receiver-processor assembly connected to the plurality of antenna ports;
(iii) a supervisory assembly configured to:
(a) distribute a high-current power to the at least one transmission-receiver-processor assembly;
(b) supervise the at least one transmission-receiver-processor assembly; and
(c) distribute synchronization signals, control signals, and supervisory signals to the at least one transmission-receiver-processor assembly; and
(iv) an array frame upon which the at least one antenna panel, the at least one transmission-receiver-processor assembly, and the supervisory assembly are mounted, wherein the array frame is configured to distribute a cooling fluid for cooling the at least one transmission-receiver-processor assembly and the supervisory assembly;
(2) a backend assembly comprising a destination for processed data from the at least one transmission-receiver-processor assembly; and
(3) a timing device;
(b) implementing a power sequence causing the at least one transmission-receiver-processor assembly and the supervisory assembly to be fully configured to operate;
(c) using the timing device to synchronize the supervisory assembly and the at least one transmission-receiver-processor assembly, thereby placing the PAR system in an initial synchronized state;
(d) performing a mutual coupling scan in the initial synchronized state to obtain current calibration data;
(e) comparing the current calibration data to a baseline calibrated alignment state;
(f) applying a correction factor to the current calibration data to achieve the baseline calibrated alignment state, causing the at least one transmission-receiver-processor assembly and the supervisory assembly to achieve a fully configured operational state;
(g) conducting, while in the fully configured operational state, a radar scan, thereby obtaining transmission data and reception data; and
(h) using the transmission-receiver-processor assembly to process the transmission data and the reception data via to obtain processed radar data.

40. The method of claim 39, further comprising displaying the processed radar data on a screen or a monitor.

41. The method of claim 39, wherein implementing the power sequence comprises causing the backend assembly and the supervisory assembly to power on and boot up so that the supervisory assembly causes the transmission-receiver-processor assembly to power on and boot up.

42. (canceled)

43. The method of claim 39, obtaining the baseline calibrated alignment state by:
obtaining a scanner comprising an RF probe and an RF transceiver;
obtaining a scanner controller;
using the scanner controller to transmit to the at least one transmission-receiver-processor assembly an instruction to perform an initial alignment calibration whereby initial alignment calibration data are obtained;
transmitting the initial alignment calibration data from the transmission-receiver-processor assembly to the scanner controller;
using the scanner controller and the initial alignment calibration data to determine element alignment weights for the plurality of dual-polarization radiating elements; and
transmitting the element alignment weights from the scanner controller to the at least one transmission-receiver-processor assembly.

44. The method of claim 43, further comprising:
locally saving, by the at least one transmission-receiver-processor assembly, the element alignment weights; and
calculating the baseline calibrated alignment state using the element alignment weights.

45.-46. (canceled)

47. A method implemented by a radar system, the method comprising:
using a clock generator to generate a reference clock signal;
distributing the reference clock signal to a first synchronization point via a synchronization board;
distributing the reference clock signal to a second synchronization point via the synchronization board;
using the first synchronization point to generate a first synchronization signal based on the reference clock signal;
transmitting the first synchronization signal to the synchronization board via the first synchronization point;
using the synchronization board to obtain a first master synchronization signal by combining the first synchronization signal with first optional synchronization sources which have been instructed not to transmit;
using the synchronization board to distribute the first master synchronization signal to the first synchronization point and to the second synchronization point;
obtaining a first counter that is based on the reference clock signal of the first synchronization point;
obtaining a second counter that is based on the reference clock signal of the second synchronization point;
using the first synchronization point to reset the first counter based on the first master synchronization signal to obtain a first reset counter; and
using the second synchronization point to reset the second counter based on the first master synchronization signal to obtain a second reset counter.

48. The method of claim 47, further comprising:
receiving, by the clock generator, a Global Positioning System (GPS) disciplined oscillator (DO) signal from a GPS module; and
generating, by the clock generator, the reference clock signal based on the GPS DO signal.

49. The method of claim 48, wherein the GPS DO signal comprises a first frequency of about 10 megahertz (MHz), wherein the reference clock signal comprises a second frequency of about 25 MHz, and wherein a transmission-receiver-processor assembly of the radar system comprises an internal clock comprising a third frequency in a range of about 25 MHz to about 200 MHz.

50. The method of claim 48, wherein the clock generator is in a backend assembly of the radar system, and wherein the synchronization board and the GPS module are in a synchronization subassembly of the backend assembly.

51. The method of claim 47, further comprising:
distributing via the synchronization board the reference clock signal to the first synchronization point through a first cable;
distributing via the synchronization board the reference clock signal to the second synchronization point through a second cable;
transmitting via the first synchronization point the first synchronization signal to the synchronization board through the first cable;
distributing, via the synchronization board the first master synchronization signal to the first synchronization point and though the first cable; and
distributing via the synchronization board the first master synchronization signal to the second synchronization point and though the second cable.

52. The method of claim 51, wherein the first cable and the second cable are substantially similar to each other and are phase-matched.

53. (canceled)

54. The method of claim 47, further comprising generating, via the first synchronization point, the first synchronization signal in response to an instruction from a controller of the radar system, wherein the instruction designates only the first synchronization point as a synchronization master.

55. (canceled)

56. The method of claim 47, wherein the first synchronization point is a first supervisory assembly of the radar system or a first host card of the radar system, and wherein the second synchronization point is a second supervisory assembly of the radar system or a second host card of the radar system.

57. The method of claim 56, further comprising:
distributing the first master synchronization signal to a first transmission-receiver-processor assembly of the radar system via the first supervisory assembly; and
distributing the first master synchronization signal to a second transmission-receiver-processor assembly of the radar system via the first supervisory assembly.

58. The method of claim 57, further comprising:
distributing the first master synchronization signal to a first plurality of chips in the first transmission-receiver-processor assembly; and
distributing the first master synchronization signal to a second plurality of chips in the second transmission-receiver-processor assembly.

59. The method of claim 58, wherein the first plurality of chips and the second plurality of chips are field-programmable gate arrays (FPGAs).

60. The method of claim 57, further comprising:
resetting a third counter of the first transmission-receiver-processor assembly based on the first master synchronization signal to obtain a third reset counter; and
resetting a fourth counter of the second transmission-receiver-processor assembly based on the first master synchronization signal to obtain a fourth reset counter.

61. The method of claim 60, further comprising:
transmitting a transmission instruction to the first transmission-receiver-processor assembly and to the second transmission-receiver-processor assembly via the first supervisory assembly;
transmitting a first transmission signal at a first time based on the third reset counter via the first transmission-receiver-processor assembly in response to the transmission instruction; and
transmitting a second transmission signal at a second time based on the fourth reset counter via the second transmission-receiver-processor assembly in response to the transmission instruction.

62. The method of claim 61, further comprising executing, by the first transmission-receiver-processor assembly and by the second transmission-receiver-processor assembly, the transmission instruction without handshakes with other components of the radar system.

63. The method of claim 47, further comprising:
using the second synchronization point to generate a second synchronization signal based on the reference clock signal;
transmitting the second synchronization signal to the synchronization board via the second synchronization point;
obtaining a second master synchronization signal by using the synchronization board to combine the second synchronization signal with second optional synchronization sources which have been instructed not to transmit;
distributing the second master synchronization signal to the first synchronization point via the synchronization board;
distributing the second master synchronization signal to the second synchronization point via the synchronization board;
using the first synchronization point to reset the first reset counter based on the second master synchronization signal to obtain a third reset counter; and
using the second synchronization point to reset the second reset counter based on the second master synchronization signal to obtain a fourth reset counter.

64.-74. (canceled)
